(19) United States
(12) Patent Application Publication
(10) Pub. No.: US 2025/0151058 A1
(43) Pub. Date: May 8, 2025

(54) METHOD AND APPARATUS FOR SOUNDING REFERENCE SIGNAL TRANSMISSION IN WIRELESS COMMUNICATION SYSTEMS

(71) Applicant: Samsung Electronics Co., Ltd., Suwon-si (KR)

(72) Inventors: Seongmok LIM, Suwon-si (KR); Youngrok JANG, Suwon-si (KR); Hyoungju JI, Suwon-si (KR); Ameha Tsegaye ABEBE, Suwon-si (KR); Kyungjun CHOI, Suwon-si (KR)

(21) Appl. No.: 18/936,472

(22) Filed: Nov. 4, 2024

(30) Foreign Application Priority Data
Nov. 2, 2023 (KR) 10-2023-0149991

(51) Int. Cl. H04W 72/1273; H04L 5/00

(52) U.S. Cl. CPC H04W 72/1273; H04L 5/001; H04L 5/005

(57) ABSTRACT

The disclosure relates to a 5^{th} generation (5G) or 6^{th} generation (6G) communication system for supporting a higher data transmission rate. The disclosure relates to operations of a user equipment (UE) and base station in a wireless communication system. A method performed by a UE in a communication system are provided. The method includes transmitting, to a base station, capability information associated with simultaneous sounding reference signal (SRS) carrier switching, receiving, from the base station, downlink control information (DCI) formats, wherein the DCI formats schedule SRSs for SRS carrier switching in component carrier (CCs), wherein the SRSs are overlap in time based on the capability information indicating a support of the simultaneous SRS carrier switching, and transmitting, to the base station, at least one SRS among the scheduled SRSs for SRS carrier switching.

### CROSS-REFERENCE TO RELATED APPLICATION(S)

This application is based on and claims priority under 35 U.S.C. § 119 (a) of a Korean patent application number 10-2023-0149991, filed on Nov. 2, 2023, in the Korean Intellectual Property Office, the disclosure of which is incorporated by reference herein in its entirety.

### BACKGROUND

### 1. Field

The disclosure relates to operations of a user equipment (UE) and base station in a wireless communication system. More particularly, the disclosure relates to a method for transmitting a sounding reference signal in a wireless communication system and an apparatus capable of performing the same.

### 2. Description of Related Art

5^{th} generation (5G) mobile communication technologies define broad frequency bands such that high transmission rates and new services are possible, and can be implemented not only in “Sub 6 GHz” bands, such as 3.5 GHz, but also in “Above 6 GHz” bands referred to as millimeter wave (mmWave) including 28 GHz and 39 GHz. In addition, it has been considered to implement 6^{th} generation (6G) mobile communication technologies, which is referred to as Beyond 5G systems, in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra-reliable low-latency communications (URLLC), and massive machine-type communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of band-width part (BWP), new channel coding methods, such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR) UE power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, drone communication, and the like.

Furthermore, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas and large scale antennas, metamaterial-based lenses and antennas for improving coverage of terahertz band signals, high-dimensional space multiplexing technology using orbital angular momentum (OAM), and reconfigurable intelligent surface (RIS), but also full duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an apparatus and method capable of effectively providing a service in a mobile communication system.

Additional aspects will be set forth in part in the description which follows and, in part, will be apparent from the description, or may be learned by practice of the presented embodiments.

In accordance with an aspect of the disclosure, a method performed by a user equipment (UE) in a communication system is provided. The method includes transmitting, to a base station, capability information associated with simultaneous sounding reference signal (SRS) carrier switching, receiving, from the base station, downlink control information (DCI) formats, wherein the DCI formats schedule SRSs for SRS carrier switching in component carrier (CCs), wherein the SRSs are overlap in time based on the capability information indicating a support of the simultaneous SRS carrier switching, and transmitting, to the base station, at least one SRS among the scheduled SRSs for SRS carrier switching.

In accordance with another aspect of the disclosure, a method performed by a base station in a communication system is provided. The method includes receiving, from a user equipment (UE), capability information associated with simultaneous sounding reference signal (SRS) carrier switching, transmitting, to the UE, downlink control information (DCI) formats, wherein the DCI formats schedule SRSs for SRS carrier switching in component carrier (CCs), wherein the SRSs are overlap in time based on the capability information indicating a support of the simultaneous SRS carrier switching, and receiving, from the UE, at least one SRS among the scheduled SRSs for SRS carrier switching.

In accordance with another aspect of the disclosure, a user equipment (UE) in a communication system is provided. The UE includes a transceiver, and at least one processor configured to transmit, to a base station, capability information associated with simultaneous sounding reference signal (SRS) carrier switching, receive, from the base station, downlink control information (DCI) formats, wherein the DCI formats schedule SRSs for SRS carrier switching in component carrier (CCs), wherein the SRSs are overlap in time based on the capability information indicating a support of the simultaneous SRS carrier switching, and transmit, to the base station, at least one SRS among the scheduled SRSs for SRS carrier switching.

In accordance with another aspect of the disclosure, a base station in a communication system is provided. The base station includes a transceiver, and at least one processor configured to receive, from a user equipment (UE), capability information associated with simultaneous sounding reference signal (SRS) carrier switching, transmit, to the UE, downlink control information (DCI) formats, wherein the DCI formats schedule SRSs for SRS carrier switching in component carrier (CCs), wherein the SRSs are overlap in time based on the capability information indicating a support of the simultaneous SRS carrier switching, and receive, from the UE, at least one SRS among the scheduled SRSs for SRS carrier switching.

The disclosed embodiment is intended to provide a device and method capable of effectively providing a service in a mobile communication system.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a basic structure of a time-frequency domain of a wireless communication system according to an embodiment of the disclosure;

FIG. 2 is a diagram illustrating a structure of a frame, a subframe, and a slot in a wireless communication system according to an embodiment of the disclosure;

FIG. 3 is a diagram illustrating bandwidth part configuration in a wireless communication system according to an embodiment of the disclosure;

FIG. 4 is a diagram illustrating a wireless protocol structure between a UE and a base station in single cell, carrier aggregation, and dual connectivity situations in a wireless communication system according to an embodiment of the disclosure;

FIG. 5 is a diagram illustrating a base station beam assignment according to a transmission configuration indicator (TCI) state configuration in a wireless communication system according to an embodiment of the disclosure;

FIG. 6 is a diagram illustrating a beam application time which may be considered in a case that a unified TCI scheme is used in a wireless communication system according to an embodiment of the disclosure;

FIG. 7 is a diagram illustrating medium access control (MAC)-control element (CE) structure for activation and indication of a joint TCI state or a separate downlink (DL) or uplink (UL) TCI state in a wireless communication system according to an embodiment of the disclosure;

FIG. 8 is a diagram illustrating frequency domain resource allocation of a physical downlink shared channel (PDSCH) or physical uplink shared channel (PUSCH) in a wireless communication system according to an embodiment of the disclosure;

FIG. 9 is a diagram illustrating a virtual resource block (VRB)-physical resource block (PRB) interleaving scheme of PDSCH in frequency domain resource allocation (FDRA) type-1 resource allocation according to an embodiment of the disclosure;

FIG. 10 is a diagram illustrating time domain resource allocation of a PDSCH in a wireless communication system according to an embodiment of the disclosure;

FIG. 11 is a diagram illustrating an SRS antenna switching operation according to an embodiment of the disclosure;

FIG. 12 is a diagram illustrating SRS carrier switching according to an embodiment of the disclosure;

FIG. 13 illustrates aperiodic SRS carrier switching scheduling according to an embodiment of the disclosure;

FIG. 14 is a diagram illustrating aperiodic SRS switching scheduled for a same time resource according to an embodiment of the disclosure;

FIG. 15 is a diagram illustrating a process for tuning an RF chain and transmitting an SRS in a case of transmitting a plurality of SRS carrier switchings simultaneously in intra-band carrier aggregation (CA) according to an embodiment of the disclosure;

FIG. 16 is a diagram illustrating a process for tuning an RF chain and transmitting an SRS in a case of transmitting a plurality of SRS carrier switchings simultaneously in inter-band CA according to an embodiment of the disclosure;

FIG. 17 illustrates a plurality of scheduled SRS carrier switchings according to an embodiment of the disclosure;

FIG. 18 is a diagram illustrating a structure of a UE in a wireless communication system according to an embodiment of the disclosure; and

FIG. 19 is a diagram illustrating a structure of a base station in a wireless communication system according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The terms which will be described below are terms defined based on the functions in the disclosure, and may be different according to users, intentions of the operators, or customs. Therefore, the definitions of the terms should be made based on the contents throughout the specification.

Hereinafter, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing communication functions. In the disclosure, a downlink (DL) refers to a radio link through which a base station transmits a signal to a UE, and an uplink (UL) refers to a radio link through which a UE transmits a signal to a base station. Furthermore, hereinafter, long term evolution (LTE) or LTE advanced (LTE-A) systems may be described by way of example, but the embodiments of the disclosure may also be applied to other communication systems having similar technical backgrounds or channel types. Examples of such communication systems may include 5^{th} generation mobile communication technologies (5G, new radio, and NR) developed beyond LTE-A, and hereinafter, the 5G may be the concept that covers the exiting LTE, LTE-A, or other similar services. In addition, based on determinations by those skilled in the art, the embodiments of the disclosure may also be applied to other communication systems through some modifications without significantly departing from the scope of the disclosure.

Herein, it will be understood that each block of the flowchart illustrations, and combinations of blocks in the flowchart illustrations, may be performed by computer program instructions. These computer program instructions may be loaded onto a processor of a general purpose computer, special purpose computer, or other programmable data processing apparatus to produce a machine, such that the instructions, which perform through the processor of the computer or other programmable data processing apparatus, create means for performing the functions specified in the flowchart block(s). These computer program instructions may also be stored in a computer usable or computer-readable memory that may direct a computer or other programmable data processing apparatus to function in a particular manner, such that the instructions stored in the computer usable or computer-readable memory produce an article of manufacture including instruction means that perform the function specified in the flowchart block(s). The computer program instructions may also be loaded onto a computer or other programmable data processing apparatus to cause a series of operational steps to be performed on the computer or other programmable data processing apparatus to produce a computer executed process such that the instructions that perform on the computer or other programmable data processing apparatus provide steps for executing the functions specified in the flowchart block(s).

Further, each block may represent a module, segment, or portion of code, which includes one or more executable instructions for executing the specified logical function(s). It should also be noted that in some alternative implementations, the functions noted in the blocks may occur out of the order. For example, two blocks shown in succession may in fact be performed substantially concurrently or the blocks may sometimes be performed in the reverse order, depending upon the functionality involved.

As used in embodiments of the disclosure, the ‘˜unit’ refers to a software element or a hardware element, such as a field programmable gate array (FPGA) or an application specific integrated circuit (ASIC), which performs a predetermined function. However, the ‘˜unit’ does not always have a meaning limited to software or hardware. The ‘˜unit’ may be constructed either to be stored in an addressable storage medium or to execute one or more processors. Therefore, the ‘˜unit’ includes, for example, software elements, object-oriented software elements, components, such as class elements and task elements, processes, functions, properties, procedures, sub-routines, segments of a program code, drivers, firmware, micro-codes, circuits, data, database, data structures, tables, arrays, and parameters. The components and functions provided by the ‘˜unit’ may be either combined into a smaller number of components and a ‘˜unit’, or divided into additional components and a ‘˜unit’. Moreover, the components and ‘˜units’ may be implemented to reproduce one or more CPUs within a device or a security multimedia card. Further, in the embodiments of the disclosure, the ‘^{˜}unit’ may include one or more processors.

A wireless communication system has developed into a broadband wireless communication system that provides a high-speed and high-quality packet data service according to communication standards, such as high speed packet access (HSPA) of 3GPP, LTE {long term evolution or evolved universal terrestrial radio access (E-UTRA)}, LTE-Advanced (LTE-A), LTE-Pro, high rate packet data (HRPD) of 3GPP2, ultra mobile broadband (UMB), and IEEE 802.16e, beyond the initially provided voice-based service.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link through which a user equipment (UE) (or a mobile station (MS)) transmits data or control signals to a base station (BS) (eNode B), and the downlink refers to a radio link through which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra reliability low latency communication (URLLC), and the like.

eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink from the perspective of a single base station. Furthermore, the 5G communication system must provide an increased user-perceived data rate of the UE, as well as the maximum data rate. In order to satisfy such requirements, transmission/reception technologies including a further enhanced multi input multi output (MIMO) transmission technique are required to be improved. In addition, while LTE transmits signals using a transmission bandwidth up to 20 MHz in a band of 2 GHz, 5G communication systems can satisfy the data transmission rate required for the 5G communication systems by using a frequency bandwidth more than 20 MHz in the frequency band of 3 to 6 GHz or 6 GHz or more.

At the same time, mMTC is being considered to support application services, such as the Internet of things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km2) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be constituted to be inexpensive, and may require a very long battery lifetime, such as 10 to 15 years because it is difficult to frequently replace the battery of the UE.

Lastly, URLLC, which is a cellular-based mission-critical wireless communication service, may be considered for services used for remote control for robots or machines, industrial automation, unmanned aerial vehicles, remote health care, emergency alert, and the like. Thus, URLLC must provide communication with ultra-low latency and ultra-high reliability. For example, a service supporting URLLC must satisfy an air interface latency of less than 0.5 ms, and requires a packet error rate of 10-5 or less at the same time. Therefore, for the services supporting URLLC, a 5G system must provide a transmit time interval (TTI) shorter than those of other services, and also may require a design for assigning a large number of resources in a frequency band in order to secure reliability of a communication link.

The three 5G services, that is, eMBB, URLLC, and mMTC, may be multiplexed and transmitted in a single system. In this case, different transmission/reception techniques and transmission/reception parameters may be used between services in order to satisfy different requirements of the respective services. It is apparent that 5G is not limited to the above-described three services.

Hereinafter, a/b can be understood as at least one of a and b.

### NR Time-Frequency Resource

Hereinafter, the frame structure of a 5G system will be described with reference to the accompanying drawings.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

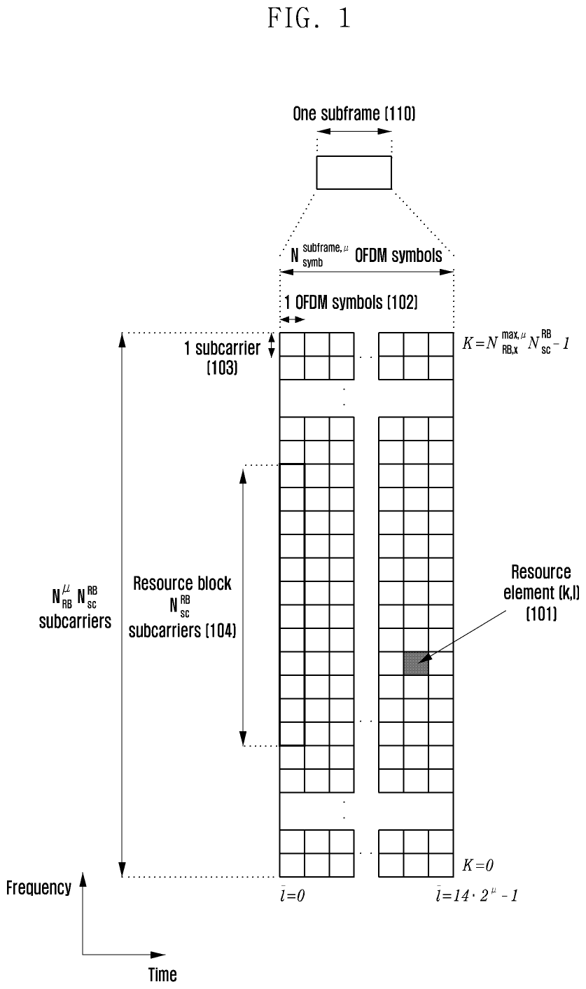

FIG. 1 is a diagram illustrating a basic structure of a time-frequency domain, which is a radio resource domain used to transmit data or control channels in a 5G system according to an embodiment of the disclosure.

Referring to FIG. 1, the horizontal domain denotes a time domain, and the vertical domain denotes a frequency domain. The basic unit of resources in the time and frequency domains is a resource element (RE) 101, which may be defined as one OFDM symbol 102 along the time domain and one subcarrier 103 along the frequency domain. In the frequency domain, N_{SC}^{RB}. (for example, 12) consecutive REs may constitute one resource block (RB) 104. In the time domain, one subframe 110 may include a plurality of OFDM symbols 102. For example, the length of one subframe may be 1 ms.

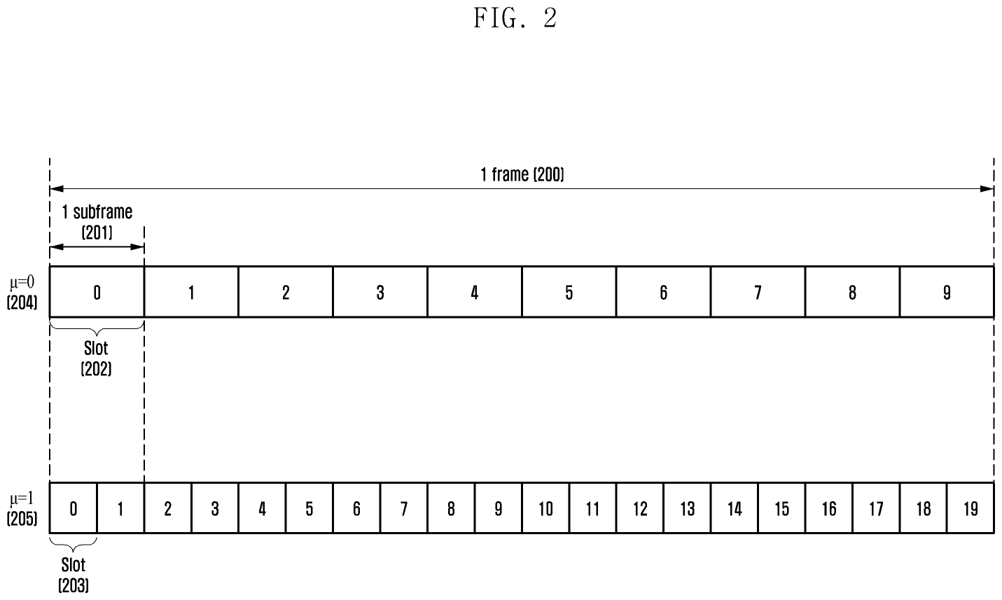

FIG. 2 is a diagram illustrating a structure of a frame, subframe, and slot in a wireless communication system according to an embodiment of the disclosure.

Referring to FIG. 2, an example of a structure of a frame 200, a subframe 201, and a slot 202 is illustrated in FIG. 2. One frame 200 may be defined as 10 ms. One subframe 201 may be defined as 1 ms. Therefore, one frame 200 may include a total of ten subframes 201. One slot 202 or 203 may be defined as 14 OFDM symbols (that is, the number of symbols per one slot N_{symb}^{slot}=14). One subframe 201 may be constituted with one slot or a plurality of slots 202 and 203. The number of slots 202 and 203 per one subframe 201 may differ depending on configuration values u 204 and 205 regarding the subcarrier spacing. The example in FIG. 2 illustrates a case in which the subcarrier spacing configuration value is μ=0 204, and a case in which μ=1 205. In the case of μ=0 204, one subframe 201 may be constituted with one slot 202. In the case of μ=1 205, one subframe 201 may be constituted with two slots 203. For example, the number of slots per one subframe Nₛₗₒₜ^{subframe,μ} may differ depending on the subcarrier spacing configuration value μ, and the number of slots per one frame Nₛₗₒₜ^{frame,μ} may differ accordingly. Nₛₗₒₜ^{subframe,μ} and Nₛₗₒₜ^{frame,μ} slot may be defined according to each subcarrier spacing configuration μ as in Table 1 below:

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### Bandwidth Part (BWP)

Next, bandwidth part (BWP) configuration in a 5G communication system will be described with reference to the accompanying drawings.

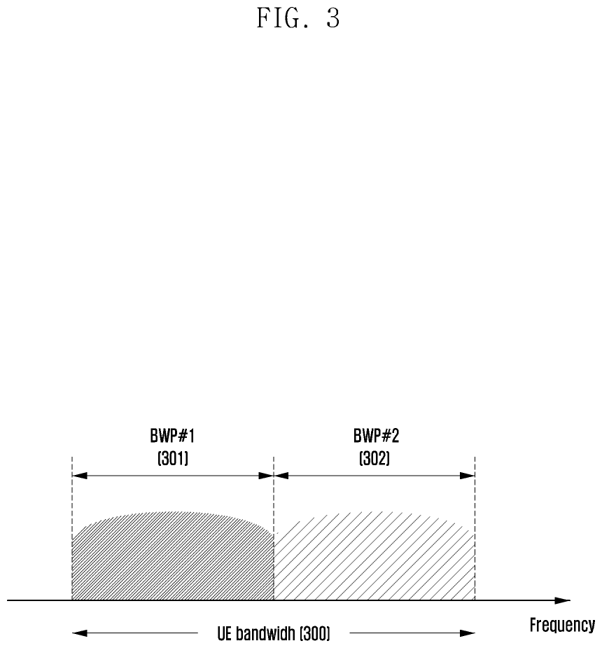

FIG. 3 is a diagram illustrating bandwidth part configuration in a wireless communication system according to an embodiment of the disclosure.

FIG. 3 illustrates a UE bandwidth 300 is configured to include two bandwidth parts, that is bandwidth part #1 (BWP #1) 301 and bandwidth part #2 (BWP #2) 302. A base station may configure one or a plurality of bandwidth parts for a UE, and may configure the following pieces of information of Table 2 with regard to each bandwidth part.

TABLE 2

| | |
|---|---|
| BWP ::= | SEQUENCE { |
| bwp-Id | BWP-Id, |
| (Bandwidth part identifier) | |
| locationAndBandwidth | INTEGER (1..65536), |
| (Bandwidth part location) | |
| subcarrierSpacing | ENUMERATED {n0, n1, n2, n3, n4, n5}, |
| (Subcarrier spacing) | |
| cyclicPrefix | ENUMERATED { extended } |
| (Cyclic prefix) | |
| } | |

It is apparent that the pieces of information configured for the UE is not limited to the above example, and various parameters related to the bandwidth part may be configured for the UE, in addition to the configuration information in Table 2. The above pieces of configuration information may be transferred from the base station to the UE through higher layer signaling, for example, radio resource control (RRC) signaling. Among one or a plurality of bandwidth parts configured for the UE, at least one bandwidth part may be activated. Whether or not to activate the configured bandwidth part may be semi-statically transferred from the base station to the UE through RRC signaling, or dynamically transferred through DCI.

According to an embodiment of the disclosure, the UE, prior to RRC connection, may be configured to an initial BWP for initial access by the base station through a master information block (MIB). To be more specific, the UE may receive configuration information regarding a control resource set (CORESET) and a search space through which a physical downlink control channel (PDCCH) for receiving system information (which may correspond to remaining system information (RMSI) or system information block 1 (SIB1)) necessary for initial access through the MIB in the initial access stage may be transmitted. Each of the control resource set and the search space configured by the MIB may be considered as identity (ID) 0. The base station may notify the UE of configuration information, such as frequency allocation information regarding control resource set #0, time allocation information, and numerology, through the MIB. In addition, the base station may notify the UE of configuration information regarding the monitoring cycle and occasion regarding control resource set #0, that is, configuration information regarding control resource set #0, through the MIB. The UE may consider that a frequency domain configured by control resource set #0 acquired from the MIB is an initial bandwidth part for initial access. In this case, the ID of the initial bandwidth part may be considered as 0.

The bandwidth part-related configuration supported by 5G may be used for various purposes.

According to some embodiments of the disclosure, in the case that the bandwidth supported by the UE is smaller than the system bandwidth, this may be supported through the bandwidth part configuration. For example, the base station may configure the frequency location (configuration information 2) of the bandwidth part for the UE such that the UE can transmit/receive data at a specific frequency location within the system bandwidth.

In addition, according to an embodiment of the disclosure, the base station may configure a plurality of bandwidth parts for the UE for the purpose of supporting different numerologies. For example, in order to support a data transmission/reception using both a subcarrier spacing of 15 kHz and a subcarrier spacing of 30 kHz for the UE, two bandwidth parts may be configured as subcarrier spacings of 15 kHz and 30 kHz, respectively. Different bandwidth parts may be subjected to frequency division multiplexing (FDM), and in the case that data is to be transmitted/received at a specific subcarrier spacing, the bandwidth part configured as the corresponding subcarrier spacing may be activated.

In addition, according to some embodiments of the disclosure, the base station may configure bandwidth parts having different sizes of bandwidths for the UE for the purpose of reducing power consumption of the UE. For example, in the case that the UE supports a substantially large bandwidth, for example, 100 MHZ, and always transmits/receives data with the corresponding bandwidth, a substantially large amount of power consumption may occur. More particularly, it may be substantially inefficient from the viewpoint of power consumption to unnecessarily monitor the downlink control channel with a large bandwidth of 100 MHz in the situation of traffic absence. For the purpose of reducing power consumption of the UE, the base station may configure a bandwidth part of a relatively small bandwidth, for example, a bandwidth part of 20 MHz, for the UE. The UE may perform a monitoring operation in the 20 MHz bandwidth part in the situation of traffic absence, and may transmit/receive data with the 100 MHz bandwidth part as indicated by the base station in the case that data has occurred.

In the method for configuring a bandwidth part, before being RRC-connected, the UE may receive configuration information regarding the initial bandwidth part through the MIB in the initial access stage. To be more specific, the UE may be configured to a control resource set (i.e., CORESET) for a downlink control channel through which DCI for scheduling a system information block (SIB) from the MIB of a physical broadcast channel (PBCH) may be transmitted. The bandwidth of the control resource set configured by the MIB may be considered as the initial bandwidth part, and the UE may receive, through the configured initial bandwidth part, a physical downlink shared channel (PDSCH) through which a SIB is transmitted. The initial bandwidth part may be used not only for the purpose of receiving the SIB, but also for other system information (OSI), paging, and/or random access.

### Change of Bandwidth Part (BWP)

In the case that a UE is configured to one or more bandwidth parts, the base station may indicate to the UE to change (or switch, transition) the bandwidth parts by using a bandwidth part indicator field inside DCI. As an example, in the case that the currently activated bandwidth part of the UE is bandwidth part slot #1 301 in FIG. 3, the base station may indicate bandwidth part #2 302 with a bandwidth part indicator inside DCI, and the UE may perform changing of the bandwidth part to bandwidth part #2 302 indicated by the bandwidth part indicator inside the received DCI.

As described above, DCI-based bandwidth part changing may be indicated by DCI for scheduling a PDSCH or a PUSCH, and the UE, upon receiving a bandwidth part change request, needs to be able to receive or transmit the PDSCH or PUSCH scheduled by the corresponding DCI in the changed bandwidth part with no problem. To this end, a requirement regarding the delay time (T_{BWP}) required during a bandwidth part change are specified standards, and may be defined, for example, as in Table 3 below.

TABLE 3

| | |
|---|---|
| | BWP switch delay |
| NR Slot | T_{BWP} (slots) |

| μ | length (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note 1}:
Depends on UE capability.
Note 2:
If the BWP switch involves changing of SCS, the BWP switch delay is determined by the larger one between the SCS before BWP switch and the SCS after BWP switch.

The requirement regarding the bandwidth part change delay time supports type 1 or type 2, depending on the capability of the UE. The UE may report the supportable bandwidth part delay time type to the base station.

According to the above-described requirement regarding the bandwidth part change delay time, in the case that the UE has received DCI including a bandwidth part change indicator in slot n, the UE may complete a change to the new bandwidth part indicated by the bandwidth part change indicator at a timepoint not later than slot n+T_{BWP}, and may transmit/receive a data channel scheduled by the corresponding DCI in the newly changed bandwidth part. In case that the base station intends to schedule a data channel with the new bandwidth part, the base station may determine time domain resource allocation regarding the data channel, based on the UE's bandwidth part change delay time T_{BWP}. For example, when scheduling a data channel with the new bandwidth part, the base station may schedule the corresponding data channel after the bandwidth part change delay time, in the method for determining time domain resource allocation regarding the data channel. Accordingly, the UE may not expect that the DCI that indicates a bandwidth part change indicates a slot offset value K0 or K2 smaller than the bandwidth part change delay time T_{BWP}.

If the UE has received DCI (for example, DCI format 1_1 or 0_1) indicating a bandwidth part change, the UE may perform no transmission or reception during a time interval from the third symbol of the slot used to receive a PDCCH including the corresponding DCI to the start point of the slot indicated by a slot offset value K0 or K2, which is indicated by a time domain resource allocation indicator field within the corresponding DCI.

For example, if the UE has received DCI indicating a bandwidth part change in slot n, and the slot offset value indicated by the corresponding DCI is K, the UE may perform no transmission or reception from the third symbol of slot n to the symbol before slot n+K (that is, the last symbol of slot n+K−1).

### Related to CA/Dual Connectivity (DC)

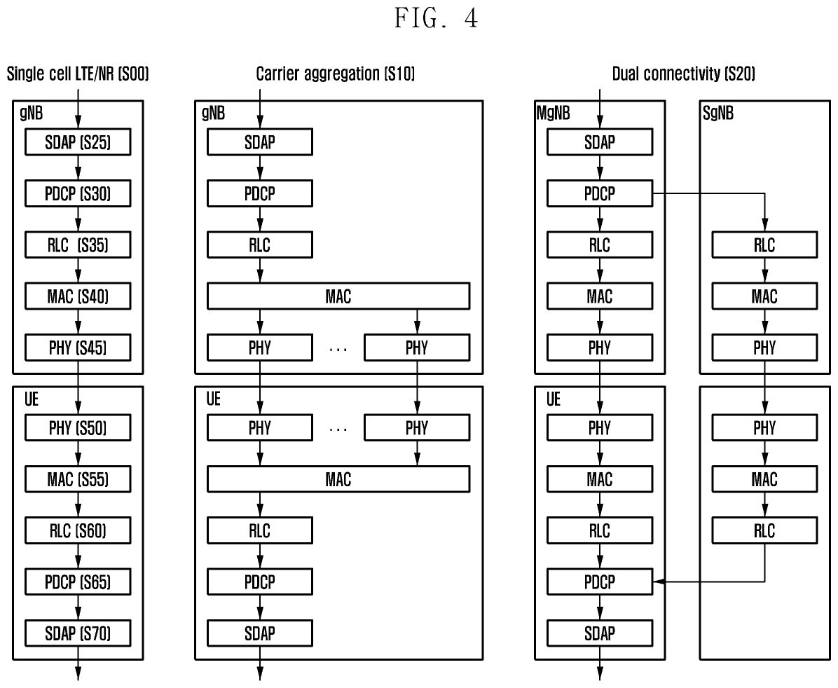

FIG. 4 is a diagram illustrating radio protocol structures of a base station and a UE in single cell, carrier aggregation, and dual connectivity situations according to an embodiment of the disclosure.

Referring to FIG. 4, a radio protocol of a next-generation wireless communication system includes an NR service data adaptation protocol (SDAP) S25 or S70, an NR packet data convergence protocol (PDCP) S30 or S65, an NR radio link control (RLC) S35 or S60, and an NR medium access control (MAC) S40 or S55 in each of a UE and an NR base station.

The main functions of the NR SDAP S25 or S70 may include some of the following functions.
Transfer function of user data (transfer of user plane data)
Mapping function between a quality of service (QOS) flow and a data bearer for uplink and downlink (mapping between a QoS flow and a data radio bearer (DRB) for both DL and UL)
Marking function of a QoS flow ID for uplink and downlink (marking QoS flow ID in both DL and UL packets)
Mapping function of a reflective QoS flow to a data bearer with respect to UL SDAP protocol data units (PDUs) (reflective QoS flow to DRB mapping for the UL SDAP PDUs).

For the SDAP layer entity, whether to use a header of the SDAP layer entity, or whether to use a function of the SDAP layer entity may be configured for the UE through an RRC message for each PDCP layer entity, each bearer, or each logical channel. In case that an SDAP header is configured, the SDAP layer entity may indicate the UE to update or reconfigure mapping information relating to a QoS flow and data bearer for uplink and downlink through a non-access stratum (NAS) QOS reflective configuration one-bit indicator (NAS reflective QoS) and an As QOS reflective configuration one-bit indicator (AS reflective QoS) of the SDAP header. The SDAP header may include QoS flow ID information indicating a QoS. The QoS information may be used as data processing priority, scheduling information, or the like, for smoothly supporting the service.

The main functions of the NR PDCP S30 or S65 may include some of the following functions.
Header compression and decompression functions (Header compression and decompression: robust header compression (ROHC) only)
Transfer function of user data (transfer of user data)
In-sequence delivery function (in-sequence delivery of upper layer PDUs)
Out-of-sequence delivery function (out-of-sequence delivery of upper layer PDUs)
Reordering function (PDCP PDU reordering for reception)
Duplicate detection function (duplicate detection of lower layer service data units (SDUs))
Retransmission function (retransmission of PDCP SDUs)
Ciphering and deciphering functions (ciphering and deciphering)
Timer-based SDU discard function (timer-based SDU discard in uplink.)

The reordering function of the NR PDCP entity may refer to a function of reordering PDCP PDUs received from a lower layer in an order based on PDCP sequence numbers (SNs), and may include a function of delivering data to a higher layer according to a rearranged order. Alternatively, the reordering of the NR PDCP entity may include a function of directly delivering data without considering order, a function of rearranging order to record lost PDCP PDUs, a function of reporting the state of lost PDCP PDUs to a transmission side, and a function of requesting retransmission of lost PDCP PDUs.

The main functions of the NR RLC S35 or S60 may include some of the following functions.
Data transfer function (transfer of upper layer PDUs)
In-sequence delivery function (in-sequence delivery of upper layer PDUs)
Out-of-sequence delivery function (out-of-sequence delivery of upper layer PDUs)
Automatic repeat request (ARQ) function (error correction through ARQ)
Concatenation, segmentation and reassembly functions (concatenation, segmentation and reassembly of RLC SDUs)
Re-segmentation function (re-segmentation of RLC data PDUs)
Reordering function (reordering of RLC data PDUs)
Duplicate detection function (duplicate detection)
Error detection function (protocol error detection)
RLC SDU discard function (RLC SDU discard)
RLC re-establishment function (RLC re-establishment)

The in-sequence delivery function of the NR RLC entity may refer to a function of delivering RLC SDUs received from a lower layer to a higher layer in sequence. The in-sequence delivery of the NR RLC entity may include a function of, in the case that one original RLC SDU is divided into several RLC SDUs and then the RLC SDUs are received, reassembling the several RLC SDUs and delivering the reassembled RLC SDUs, a function of rearranging received RLC PDUs with reference to RLC sequence numbers (SNs) or PDCP sequence numbers (SNs), a function of rearranging order to record lost RLC PDUs, a function of reporting the state of lost RLC PDUs to a transmission side, and a function of requesting retransmission of lost RLC PDUs. The in-sequence delivery function of the NR RLC entity may include a function of, in the case that there is a lost RLC SDU, sequentially delivering only RLC SDUs before the lost RLC SDU to a higher layer, or a function of, although there is a lost RLC SDU, if a predetermined timer has expired, sequentially delivering, to a higher layer, all the RLC SDUs received before the timer is started. Alternatively, the in-sequence delivery function of the NR RLC entity may include a function of, although there is a lost RLC SDU, if a predetermined timer has expired, sequentially delivering all the RLC SDUs received up to the current, to a higher layer. Alternatively, the in-sequence delivery function of the NR RLC entity may process RLC PDUs in a reception order (an order in which the RLC PDUs have arrived, regardless of an order based on sequence numbers) and then deliver the processed RLC PDUs to a PDCP entity regardless of order (out-of-sequence delivery). In a case of segments, the NR RLC entity may receive segments stored in a buffer or to be received in the future, reconfigure the segments to be one whole RLC PDU, then process the RLC PDU, and deliver the processed RLC PDU to a PDCP entity. The NR RLC layer may not include a concatenation function, and the concatenation function may be performed in an NR MAC layer or replaced with a multiplexing function of an NR MAC layer.

The out-of-sequence delivery function of the NR RLC entity may refer to a function of immediately delivering RLC SDUs received from a lower layer, to a higher layer regardless of the order thereof, and may include a function of, in the case that one original RLC SDU is divided into several RLC SDUs and then the RLC SDUs are received, reassembling the several RLC SDUs and delivering the reassembled RLC SDUs, and a function of storing an RLC SN or PDCP SN of received RLC PDUs and arranging order to record lost RLC PDUs.

The NR MAC S40 or S55 may be connected to several NR RLC layer entities constituted in a single UE, and the main functions of the NR MAC may include some of the following functions.
Mapping function (Mapping between logical channels and transport channels)
Multiplexing and demultiplexing functions (multiplexing/demultiplexing of MAC SDUs)
Scheduling information reporting function (scheduling information reporting)
Hybrid automatic repeat request (HARQ) function (error correction through HARQ)
Priority handling function between logical channels (priority handling between logical channels of one UE)
Priority handling function between UEs (priority handling between UEs by means of dynamic scheduling)
Multimedia broadcast/multicast service (MBMS) service identification function (MBMS service identification)
Transport format selection function (transport format selection)
Padding function (padding)

An NR physical (PHY) layer S45 or S50 may perform channel coding and modulation of higher layer data to make the data into orthogonal frequency-division multiplexing (OFDM) symbols and transmit the OFDM symbols through a wireless channel, or may perform demodulation and channel decoding of OFDM symbols received through a wireless channel, and then deliver the OFDM symbols to a higher layer.

A detailed structure of a wireless protocol structure may be variously changed according to a carrier (or cell) operation scheme. For example, in a case where a base station transmits data to a UE, based on a single carrier (or cell), the base station and UE use a protocol structure having a single structure on each layer as shown in S00. On the contrary, in case that the base station transmits data to the UE, based on carrier aggregation (CA) using multiple carriers at a single TRP, the base station and UE use a protocol structure having a single structure up to RLC, but multiplexing a PHY layer through a MAC layer as shown in S10. As another example, in case that the base station transmits data to the UE, based on dual connectivity (DC) using multiple carriers at multiple TRPs, the base station and UE use a protocol structure having a single structure up to RLC, but multiplexing a PHY layer through a MAC layer as shown in S20.

### Quasi Co-Location (QCL), TCI State

One or more different antenna ports (or one or more channels, signals, and a combination thereof are substitutable therefor, but are collectively referred to as different antenna ports for convenience of explanation in the following description of the disclosure) may be associated with each other in a wireless communication system by a quasi co-location (QCL) configuration as in Table 4 below. A TCI state is to notify of a QCL relation between a PDCCH (or PDCCH demodulation reference signal (DMRS)) and a different RS or channel. Certain reference antenna port A (reference RS #A) and another target antenna port B (target RS #B) being QCLed to each other implies that a UE is allowed to apply all or some of large-scale channel parameters estimated in antenna port A to channel measurement in antenna port B. QCL may need to associate different parameters according to situations including 1) time tracking affected by average delay and delay spread, 2) frequency tracking affected by Doppler shift and Doppler spread, 3) radio resource management (RRM) affected by average gain, and 4) beam management (BM) affected by spatial parameter. Accordingly, NR supports four types of QCL relations as shown in Table 4 below.

TABLE 4

| QCL type | Large-scale characteristics |
|---|---|
| A | Doppler shift, Doppler spread, |
| | average delay, delay spread |
| B | Doppler shift, Doppler spread |
| C | Doppler shift, average delay |
| D | Spatial Rx parameter |

The spatial RX parameter may indicate some or all of various parameters including angle of arrival (AoA), power angular spectrum (PAS) of AoA, angle of departure (AoD), PAS of AoD, transmit/receive channel correlation, transmit/receive beamforming, and spatial channel correlation.

The QCL relations are configurable for the UE through an RRC parameter TCI-State and QCL-Info as shown in Table 9 below. With reference to Table 5, the base station may configure one or more TCI states for the UE to notify of a maximum of two types of QCL relations (qcl-Type1 and qcl-Type2) for an RS with reference to an ID of the TCI state, that is, a target RS. In this case, each piece of QCL information (QCL-Info) included in each TCI state may include a serving cell index and BWP index of a reference RS and the type and ID of a reference RS indicated by a corresponding piece of QCL information, and a QCL type described in Table 4 above.

TABLE 5

| | |
|---|---|
| TCI-State ::= | SEQUENCE { |
| tci-StateId | TCI-StateId, |

(ID of corresponding TCI state)

| | |
|---|---|
| qcl-Type1 | QCL-Info, |

(QCL information of first reference RS of RS (target RS) with reference to
corresponding TCI state ID)

| | | |
|---|---|---|
| qcl-Type2 | QCL-Info | OPTIONAL, -- |

```
Need R
  (QCL information of second reference RS of RS (target RS) with reference to
corresponding TCI state ID)
  ...
}
```

| QCL-Info ::= | SEQUENCE { | |
|---|---|---|
| cell | ServCellIndex | OPTIONAL, -- Need |

R
(Serving cell index of reference RS indicated by corresponding QCL
information)

| | | |
|---|---|---|
| bwp-Id | BWP-Id | OPTIONAL, -- |

Cond CSI-RS-Indicated
(BWP index of reference RS indicated by corresponding QCL information)

| | |
|---|---|
| referenceSignal | CHOICE { |
| csi-rs | NZP-CSI-RS-ResourceId, |
| ssb | SSB-Index |

```
    (One of CSI-RS ID and SSB ID indicated by QCL information)
  },
```

| | |
|---|---|
| qcl-Type | ENUMERATED {typeA, typeB, typeC, |

typeD},
...
}

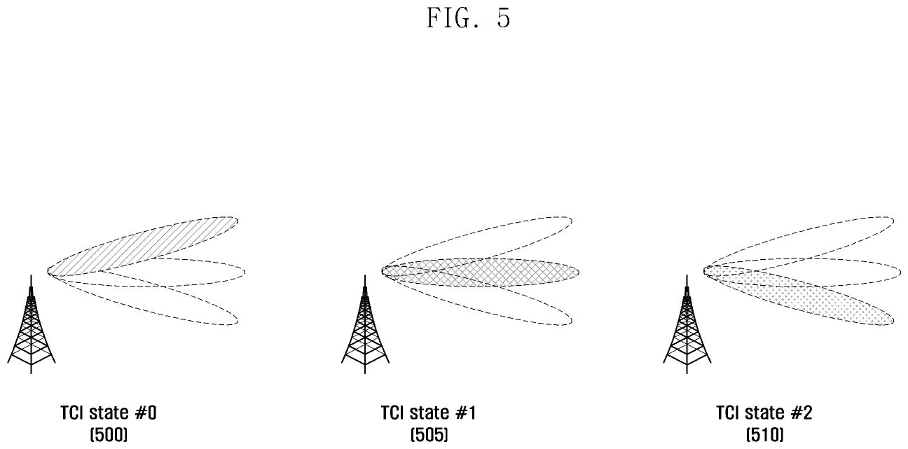

FIG. 5 is a diagram illustrating base station beam allocation according to a TCI state configuration according to an embodiment of the disclosure.

Referring to FIG. 5, a base station may transfer, to the UE, information on N different beams through N different TCI states. For example, as in FIG. 5, in the case of N=3, the base station may allow qcl-Type 2 parameters included in three TCI states 500, 505, and 510 to be associated with CSI-RSs or SSBs corresponding to different beams and to be configured as QCL type D, so as to notify that antenna ports with reference to the different TCI states 500, 505, or 510 are associated with different spatial Rx parameters, that is, different beams.

Table 6 to Table 10 below show valid TCI state configurations according to the type of a target antenna port.

Table 6 shows a TCI state configuration that is valid in the case that a target antenna port is a CSI-RS for tracking (e.g., TRS). The TRS may refer to an NZP CSI-RS, among CSI-RSs, for which a repetition parameter is not configured and trs-Info is configured as true. Configuration #3 in Table 10 may be used for aperiodic TRSs.

TCI state configuration that is valid in the case that a target antenna port is a CSI-RS for tracking (TRS).

TABLE 6

| Valid | | | | |
|---|---|---|---|---|
| TCI state | | | DL RS 2 (if | qcl-Type2 (if |
| Configuration | DL RS 1 | qcl-Type1 | configured) | configured) |
| 1 | SSB | QCL-TypeC | SSB | QCL-TypeD |
| 2 | SSB | QCL-TypeC | CSI-RS | QCL-TypeD |
| | | | (BM) | |
| 3 | TRS | QCL-TypeA | TRS | QCL-TypeD |
| | (periodic) | | (same as | |
| | | | DL RS 1) | |

Table 7 shows a TCI state configuration that is valid in the case that a target antenna port is a CSI-RS for CSI. The CSI-RS for CSI may refer to an NZP CSI-RS, among CSI-RSs, for which a parameter indicating repetition (e.g., repetition parameter) is not configured and trs-Info is also not configured as true.

TCI state configuration that is valid in the case that a target antenna port is a CSI-RS for CSI.

TABLE 7

| Valid | | | | |
|---|---|---|---|---|
| TCI state | | | DL RS 2 (if | qcl-Type2 (if |
| Configuration | DL RS 1 | qcl-Type1 | configured) | configured) |
| 1 | TRS | QCL-TypeA | SSB | QCL-TypeD |
| 2 | TRS | QCL-TypeA | CSI-RS | QCL-TypeD |
| | | | for BM | |
| 3 | TRS | QCL-TypeA | TRS | QCL-TypeD |
| | | | (same as | |
| | | | DL RS 1) | |
| 4 | TRS | QCL-TypeB | | |

Table 8 shows a TCI state configuration that is valid in the case that a target antenna port is a CSI-RS for beam management (BM) (This is the same as a CSI-RS for L1 RSRP reporting). The CSI-RS for BM may refer to an NZP CSI-RS, among CSI-RSs, for which a repetition parameter is configured and has a value of On or Off and trs-Info is not configured as true.

TCI state configuration that is valid in the case that a target antenna port is a CSI-RS for BM (for L1 RSRP reporting).

TABLE 8

| Valid | | | | |
|---|---|---|---|---|
| TCI state | | | DL RS 2 (if | qcl-Type2 (if |
| Configuration | DL RS 1 | qcl-Type1 | configured) | configured) |
| 1 | TRS | QCL-TypeA | TRS | QCL-TypeD |
| | | | (same as | |
| | | | DL RS 1) | |
| 2 | TRS | QCL-TypeA | CSI-RS | QCL-TypeD |
| | | | (BM) | |
| 3 | SS/PBCH | QCL-TypeC | SS/PBCH | QCL-TypeD |
| | Block | | Block | |

Table 9 shows a TCI state configuration that is valid in the case that a target antenna port is a PDCCH DMRS.

TCI state configuration that is valid in the case that a target antenna port is a PDCCH DMRS.

TABLE 9

| Valid | | | | |
|---|---|---|---|---|
| TCI state | | | DL RS 2 (if | qcl-Type2 (if |
| Configuration | DL RS 1 | qcl-Type1 | configured) | configured) |
| 1 | TRS | QCL-TypeA | TRS | QCL-TypeD |
| | | | (same as | |
| | | | DL RS 1) | |
| 2 | TRS | QCL-TypeA | CSI-RS | QCL-TypeD |
| | | | (BM) | |
| 3 | CSI-RS | QCL-TypeA | CSI-RS | QCL-TypeD |
| | (CSI) | | (same as | |
| | | | DL RS 1) | |

Table 10 shows a TCI state configuration that is valid in the case that a target antenna port is a PDSCH DMRS.

TCI state configuration that is valid in the case that a target antenna port is a PDSCH DMRS.

TABLE 7

| Valid | | | DL | |
|---|---|---|---|---|
| TCI state | DL | | RS 2 (if | qcl-Type2 (if |
| Configuration | RS 1 | qcl-Type1 | configured) | configured) |
| 1 | TRS | QCL-TypeA | TRS | QCL-TypeD |
| 2 | TRS | QCL-TypeA | CSI-RS | QCL-TypeD |
| | | | (BM) | |
| 3 | CSI-RS | QCL-TypeA | CSI-RS | QCL-TypeD |
| | (CSI) | | (CSI) | |

In a representative QCL configuration method according to Table 6 to Table 10 above, a target antenna port and reference antenna port of each stage are configured to be “SSB”→“TRS”→“CSI-RS for CSI, CSI-RS for BM, PDCCH DMRS, or PDSCH DMRS” and are operated. Through this, a reception operation of the UE may be assisted by associating statistical characteristics measurable by an SSB and a TRS with respective antenna ports.

### Unified TCI State

Hereinafter, a single TCI state indication and activation method based on a unified TCI scheme is described. The unified TCI scheme may refer to a scheme of integrally managing transmission and reception beam management schemes through a TCI state, the transmission and reception beam management schemes having been classified as a TCI state scheme used in downlink reception of a UE and a spatial relation info scheme used in uplink transmission in Rel-15 and 16 of the related art. Therefore, in case that a UE receives an indication from a base station, based on the unified TCI scheme, the UE may perform beam management even for uplink transmission by using a TCI state. If the higher layer signaling TCI-State having the higher layer signaling tci-stateId-r17 is configured for the UE by the base station, the UE may perform an operation based on the unified TCI scheme by using the corresponding TCI-State. The TCI-State may exist in two types of a joint TCI state or a separate TCI state.

A first type is a joint TCI state, and all TCI states to be applied to uplink transmission and downlink reception may be indicated to the UE by the base station through one TCI-State. If the UE is indicated with joint TCI state-based TCI-state, the UE may be indicated with a parameter to be used in downlink channel estimation by using an RS corresponding to qcl-Type1 in the corresponding joint TCI state-based TCI-state, and a parameter to be used as a downlink reception beam or reception filter by using an RS corresponding to qcl-Type2. If the UE is indicated with a joint TCI state-based TCI-state, the UE may be indicated with a parameter to be used as an uplink transmission beam or transmission filter by using an RS corresponding to qcl-Type2 in the corresponding joint DL/UL TCI state-based TCI-state. In this case, in the case that the UE is indicated with the joint TCI state, the UE may apply the same beam to uplink transmission and downlink reception.

A second type is a separate TCI state, and a UL TCI state to be applied to uplink transmission and a DL TCI state to be applied to downlink reception may be individually indicated to the UE by the base station. If the UE is indicated with a UL TCI state, the UE may be indicated with a parameter to be used as an uplink transmission beam or transmission filter by using a reference RS or a source RS configured in the corresponding UL TCI state. If the UE is indicated with a DL TCI state, the UE may be indicated with a parameter to be used in downlink channel estimation by using an RS corresponding to qcl-Type 1 in the corresponding DL TCI state, and a parameter to be used as a downlink reception beam or reception filter by using an RS corresponding to qcl-Type2.

If the UE is indicated with a DL TCI state and a UL TCI state, the UE may be indicated with a parameter to be used as an uplink transmission beam or transmission filter by using a reference RS or a source RS configured in the corresponding UL TCI state, a parameter to be used in downlink channel estimation by using an RS corresponding to qcl-Type1 configured in the corresponding DL TCI state, and a parameter to be used as a downlink reception beam or reception filter by using an RS corresponding to qcl-Type2. In the case, in the case that the reference RSs or source RSs configured in the DL TCI state and UL TCI state indicated to the UE are different from each other, the UE may apply individual beams to uplink transmission and downlink reception, based on the DL TCI state and UL TCI state indicated to the UE.

A maximum of 128 of joint TCI state may be configured to the UE by the base station through higher layer signaling by each specific bandwidth part in a specific cell. Among the separate TCI states, the DL TCI state may be configured to a maximum of 64 or 128 through higher layer signaling for each specific bandwidth part within a specific cell based on UE capability reporting, and the DL TCI state of the separate TCI states and joint TCI state may use the same higher layer signaling structure. For example, if 128 joint TCI states are configured and 64 DL TCI states of separate TCI states are configured, the 64 DL TCI states may be included in the 128 joint TCI states.

Among the separate TCI states, the UL TCI state may be configured to a maximum of 32 or 64 through higher layer signaling for each specific bandwidth part within a specific cell based on UE capability reporting. Similar to the relation between the DL TCI state of the separate TCI state and the joint TCI state, the UL TCI state of the separate TCI state and the joint TCI state may also use the same higher layer signaling structure. The UL TCI state of the separate TCI may use a higher layer signaling structure different from that of the joint TCI state and the DL TCI state of the separate TCI state.

As described above, using different or identical higher layer signaling structures may be defined in a specification. Using different or identical higher layer signaling structures may be determined through another higher layer signaling that is configured by the base station, based on the UE capability report including information on a usage scheme which the UE is able to support among two types of usage schemes.

The UE may receive a transmission/reception beam-related indication in a unified TCI scheme by using one scheme among the joint TCI state and separate TCI state configured by the base station. Whether to use one of the joint TCI state and the separate TCI state may be configured for the UE by the base station through higher layer signaling.

The UE may receive a transmission/reception beam-related indication through higher layer signaling by using one scheme selected from among the joint TCI state and the separate TCI state, and in this case, the transmission/reception beam-related indication method of the base station may be classified as two methods including a MAC-CE-based indication method and a MAC-CE-based activation and DCI-based indication method.

In case that the UE receives a transmission/reception beam-related indication through higher layer signaling by using a joint TCI state scheme, the UE may receive a MAC-CE indicating a joint TCI state from the base station to perform a transmission/reception beam application operation, and the base station may schedule reception of a PDSCH including the corresponding MAC-CE to the UE through a PDCCH. If a MAC-CE includes one joint TCI state, the UE may determine an uplink transmission beam or transmission filter and a downlink reception beam or reception filter by using the indicated joint TCI state after 3 ms from transmission of a PUCCH including HARQ-ACK information indicating whether reception of a PDSCH including the corresponding MAC-CE is successful. If a MAC-CE includes two or more joint TCI states, the UE may identify that the plurality of joint TCI states indicated by the MAC-CE correspond to respective codepoints of a TCI state field of DCI format 1_1 or 1_2 after 3 ms from transmission of a PUCCH including HARQ-ACK information indicating whether reception of a PDSCH including the corresponding MAC-CE is successful, and may activate the indicated joint TCI states. Thereafter, the UE may receive DCI format 1_1 or 1_2 to apply one joint TCI state indicated by a TCI state field in the corresponding DCI to uplink transmission and downlink reception beams. In this case, DCI format 1_1 or 1_2 may include downlink data channel scheduling information (with DL assignment) or not include same (without DL assignment).

In case that the UE receives a transmission/reception beam-related indication through higher layer signaling by using a separate TCI state scheme, the UE may receive a MAC-CE indicating a separate TCI state from the base station to perform a transmission/reception beam application operation. The base station may schedule reception of a PDSCH including the corresponding MAC-CE to the UE through a PDCCH. If a MAC-CE includes one separate TCI state set, the UE may determine an uplink transmission beam or transmission filter and a downlink reception beam or reception filter by using separate TCI states included in the indicated separate TCI state set after 3 ms from transmission of a PUCCH including HARQ-ACK information indicating whether reception of a corresponding PDSCH is successful. In this case, the separate TCI state set may refer to single or a plurality of separate TCI states which one codepoint of a TCI state field in DCI format 1_1 or 1_2 is able to have. One separate TCI state set may include one DL TCI state, include one UL TCI state, or include one DL TCI state and one UL TCI state. If a MAC-CE includes two or more separate TCI state sets, the UE may identify that the plurality of separate TCI state sets indicated by the MAC-CE correspond to respective codepoints of a TCI state field of DCI format 1_1 or 1_2 after 3 ms from transmission of a PUCCH including HARQ-ACK information indicating whether reception of the corresponding PDSCH is successful, and may activate the indicated separate TCI state sets. In this case, each codepoint of the TCI state field of DCI format 1_1 or 1_2 may indicate one DL TCI state, indicate one UL TCI state, or indicate one DL TCI state and one UL TCI state. The UE may receive DCI format 1_1 or 1_2 to apply a separate TCI state set indicated by a TCI state field in the corresponding DCI to uplink transmission and downlink reception beams. In this case, DCI format 1_1 or 1_2 may include downlink data channel scheduling information (with DL assignment) or not include same (without DL assignment).

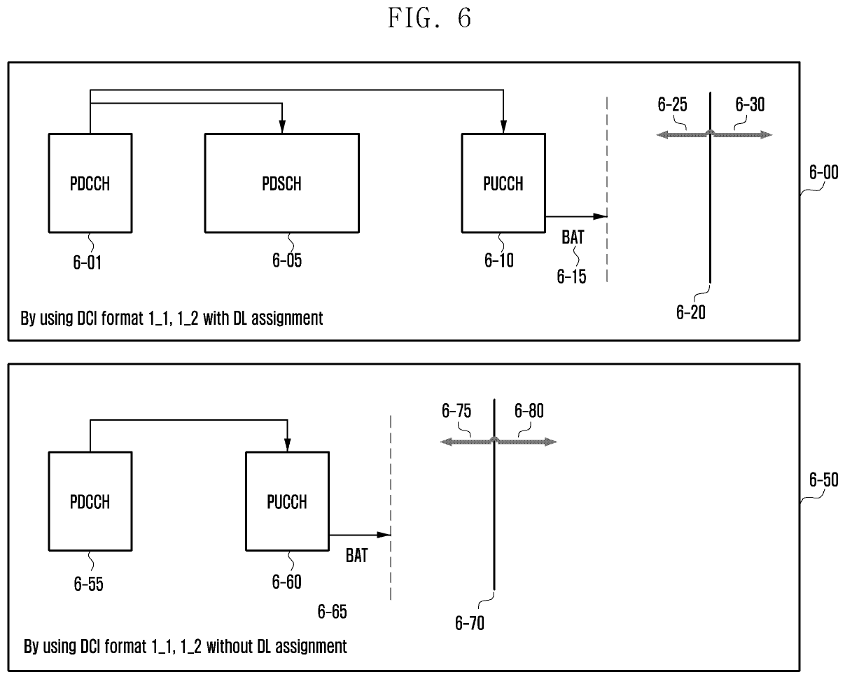

FIG. 6 is a diagram illustrating a beam application time which may be considered in a case that a unified TCI scheme is used in a wireless communication system according to an embodiment of the disclosure.

Referring to FIG. 6, as described above, a UE may receive, from a base station, DCI format 1_1 or 1_2 including downlink data channel scheduling information (with DL assignment) or not including downlink data channel scheduling information (without DL assignment), and may apply one joint TCI state or one separate TCI state set indicated by a TCI state field in the corresponding DCI to uplink transmission and downlink reception beams.

DCI format 1_1 or 1_2 with DL assignment 6-00: In the case the UE receives, from the base station, DCI format 1_1 or 1_2 including downlink data channel scheduling information 6-01 so that one joint TCI state or one separate TCI state set based on a unified TCI scheme is indicated, the UE may receive a PDSCH scheduled based on the received DCI 6-05, and transmit a PUCCH including a HARQ-ACK indicating whether reception of the DCI and PDSCH is successful 6-10. In this case, the HARQ-ACK may include whether reception is successful, for both the DCI and the PDSCH, in the case that the UE fails to receive at least one of the DCI and the PDSCH, the UE may transmit a NACK, and in the case that the UE succeeds in receive both of them, the UE may transmit an ACK.

DCI format 1_1 or 1_2 without DL assignment 6-50: In the case that the UE receives, from the base station, DCI format 1_1 or 1_2 not including downlink data channel scheduling information 6-55 so that one joint TCI state or one separate TCI state set based on a unified TCI scheme is indicated, the UE may assume at least one combination of the following items for the corresponding DCI.

A cyclic redundancy check (CRC) scrambled using a carrier selection radio network temporary identifier (CS-RNTI) is included.

The values of all bits assigned to all fields used as redundancy version (RV) fields are 1.

The values of all bits assigned to all fields used as modulation and coding scheme (MCS) fields are 1.

The values of all bits assigned to all fields used as new data indication (NDI) fields are 0.

In a case of frequency domain resource allocation (FDRA) type 0, the values of all bits assigned to an FDRA field are 0, in a case of FDRA type 1, the values of all bits assigned to an FDRA field are 1, and in a case of an FDRA scheme being dynamicSwitch, the values of all bits assigned to an FDRA field are 0.

The UE may transmit a PUCCH including a HARQ-ACK indicating whether DCI format 1_1 or 1_2 is successfully received assuming the above-described matters 6-60.

With respect to both DCI format 1_1 or 1_2 with DL assignment 6-00 and without DL assignment 6-50, if a new TCI state indicated through DCI 6-01 or 6-55 is the same as a TCI state having been previously indicated and thus having been being applied to uplink transmission and downlink reception beams, the UE may maintain the previously applied TCI state. If the new TCI state is different from the previously indicated TCI state, the UE may determine, as a time point for application of the joint TCI state or separate TCI state set, which is indicatable by a TCI state field included in the DCI, a time point 6-30 or 6-80 after the first slot 6-20 or 6-70 after passage of a time interval as long as a beam application time (BAT) 6-15 or 6-65 after PUCCH transmission. The UE may use the previously indicated TCI-state at a time point 6-25 or 6-75 before the corresponding slot 6-20 or 6-70.

With respect to both DCI format 1_1 or 1_2 with DL assignment 6-00 and without DL assignment 6-50, the BAT is a particular number of OFDM symbols, and may be configured through higher layer signaling, based on UE capability report information. Numerologies of the BAT and the first slot after the BAT may be determined based on the smallest numerology among all cells to which a joint TCI state or separate TCI state set indicated through DCI is applied.

The UE may apply one joint TCI state indicated through a MAC-CE or DCI to reception for control resource sets connected to all UE-specific search spaces, apply the joint TCI state to reception of a PDSCH and transmission of a PUSCH, the PDSCH and the PUSCH being scheduled by a PDCCH transmitted in the corresponding control resource sets, and apply the joint TCH state to transmission of all PUCCH resources.

In the case that one separate TCI state set indicated through a MAC-CE or DCI includes one DL TCI state, the UE may apply the one separate TCI state set to reception for control resource sets connected to all UE-specific search spaces, and apply the one separate TCI state set to reception of a PDSCH scheduled by a PDCCH transmitted in the control resource sets. The UE may apply a previously indicated UL TCI state to all PUSCH and PUCCH resources.

In the case that one separate TCI state set indicated through a MAC-CE or DCI includes one UL TCI state, the UE may apply the UL TCI state to all PUSCH and PUCCH resources. The UE may apply a previously indicated DL TCI state to reception for control resource sets connected to all UE-specific search spaces, and to reception of a PDSCH scheduled by a PDCCH transmitted in the corresponding control resource sets.

In the case that one separate TCI state set indicated through a MAC-CE or DCI includes one DL TCI state and one UL TCI state, the UE may apply the DL TCI state to reception for control resource sets connected to all UE-specific search spaces, and to reception of a PDSCH scheduled by a PDCCH transmitted in the control resource sets. The UE may apply the UL TCI state to all PUSCH and PUCCH resources.

### Unified TCI State MAC-CE

Hereinafter, a single TCI state indication and activation method based on a unified TCI scheme is described. A PDSCH including a MAC-CE described below may be scheduled to a UE by a base station, and the UE may interpret each codepoint of a TCI state field in DCI format 1_1 or 1_2, based on information in the MAC-CE received from the base station, after 3 slots from transmission of a HARQ-ACK for the corresponding PDSCH to the base station. For example, the UE may activate each entry of the MAC-CE received from the base station in each codepoint of the TCI state field in DCI format 1_1 or 1_2.

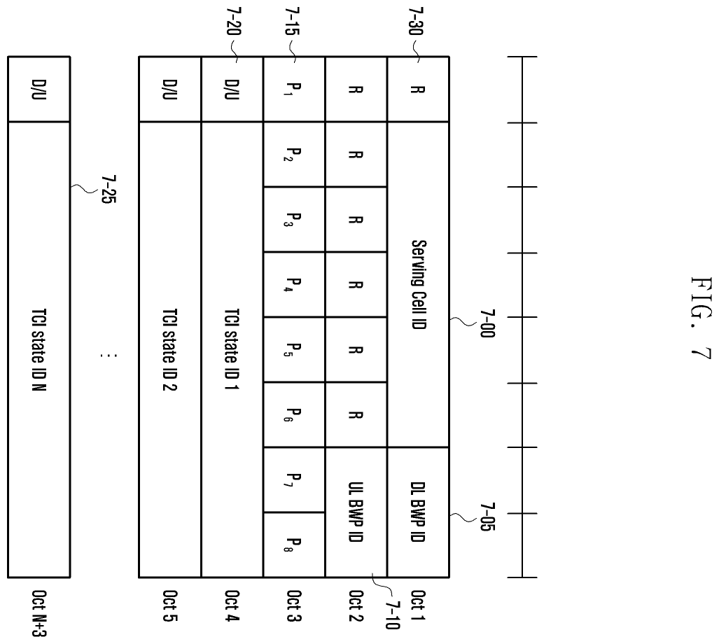

FIG. 7 is a diagram illustrating a MAC-CE structure for activation and indication of a joint TCI state or a separate DL or UL TCI state in a wireless communication system according to an embodiment of the disclosure. Each field in the corresponding MAC-CE structure may have the following meaning.

Referring to FIG. 7, serving cell ID 7-00: This field may indicate whether a corresponding MAC-CE is to be applied to which serving cell. The length of this field may be 5 bits. If a serving cell indicated by this field may be included in one or more of the higher layer signalings, simultaneousU-TCI-UpdateList1, simultaneousU-TCI-UpdateList2, simultaneousU-TCI-UpdateList3, and simultaneousU-TCI-UpdateList4, the corresponding MAC-CE may be applied to all serving cells included in one or more lists among simultaneousU-TCI-UpdateList1, simultaneousU-TCI-UpdateList2, simultaneousU-TCI-UpdateList3, and simultaneousU-TCI-UpdateList4, in which the serving cell indicated by the field is included.

DL BWP ID 7-05: This field may indicate whether the corresponding MAC-CE is to be applied to which DL BWP, and the meanings of each codepoints in this field may correspond to each codepoint of a bandwidth part indicator in DCI. The length of this field may be 2 bits.

UL BWP ID 7-10: This field may indicate whether the corresponding MAC-CE is to be applied to which UL BWP, and the meanings of each codepoint in this field may correspond to each codepoint of a bandwidth part indicator in DCI. The length of this field may be 2 bits.

Pᵢ 7-15: This field may indicate whether each codepoint of a TCI state field in DCI format 1_1 or 1_2 has a plurality of TCI states or one TCI state. If a value of Pᵢ is 1, this indicates that a corresponding i-th codepoint has a plurality of TCI states, and may imply that the corresponding codepoint may include a separate DL TCI state and a separate UL TCI state. If a value of Pᵢ is 0, this indicates that a corresponding i-th codepoint has a single TCI state, and may imply that the corresponding codepoint may include one of a joint TCI state, a separate DL TCI state, and a separate UL TCI state.

D/U 7-20: This field may indicate whether a TCI state ID field in the same octet is a joint TCI state, a separate DL TCI state, or a separate UL TCI state. If this field is 1, the TCI state ID field in the same octet may be a joint TCI state or a separate DL TCI state. If this field is 0, the TCI state ID field in the same octet may be a separate UL TCI state.

TCI state ID 7-25: This field may indicate a TCI state identifiable by the higher layer signaling TCI-StateID. In the case that the D/U field is configured to be 1, this field may be used to represent TCI-StateID expressible by 7 bits. In the case that the D/U field is configured to be 0, a most significant bit (MSB) of this field may be considered as a reserved bit, and the remaining 6 bits may be used to represent the higher layer signaling UL-TCIState-ID. The number of maximumly activatable TCI states may be 8 in a case of joint TCI states, and may be 16 in a case of separate DL or UL TCI states.

R 7-30: This indicates a reserved bit and may be configured to be 0.

With respect to the MAC-CE structure of FIG. 7 described above, the UE may include, in the MAC-CE structure, a third octet including P₁, P₂, . . . , P₈ fields in FIG. 7 regardless of unifiedTCI-StateType-r17 in MIMOparam-r17 in the higher layer signaling ServingCellConfig being configured to be joint or separate. In this case, the UE may perform TCI state activation by using a fixed MAC-CE structure regardless of higher layer signaling configured by a base station. As another example, with respect to the MAC-CE structure of FIG. 7 described above, the UE may omit the third octet including P₁, P₂, . . . , P₈ fields, within FIG. 7, in case that unifiedTCI-StateType-r17 in MIMOparam-r17 in the higher layer signaling ServingCellConfig is configured to be joint. In this case, the UE may save the payload of the corresponding MAC-CE by a maximum of 8 bits according to higher layer signaling configured by the base station. In addition, all D/U fields positioned on the first bits in octets starting from a fourth octet in FIG. 7 may be considered as R fields, and all the corresponding R fields may be configured as 0 bits.

### PDCCH: DCI Related

Next, downlink control information (DCI) in a 5G system will be described below.

In a 5G system, scheduling information on uplink data (or physical uplink data channel (physical uplink shared channel, PUSCH)) or downlink data (or physical downlink data channel (physical downlink shared channel, PDSCH)) is transferred from a base station to a UE through DCI. The UE may monitor a fallback DCI format and a non-fallback DCI format for a PUSCH or PDSCH. The fallback DCI format may be constituted with a fixed field pre-defined between the base station and the UE, and the non-fallback DCI format may include a configurable field.

DCI may undergo a channel coding and modulation process, and then be transmitted through a physical downlink control channel (PDCCH) that is a physical downlink control channel. A cyclic redundancy check (CRC) may be attached to a DCI message payload, and the CRC may be scrambled by a radio network temporary identifier (RNTI) corresponding to the identity of the UE. Different RNTIs may be used according to the purpose of a DCI message, for example, UE-specific data transmission, a power control command, a random access response, or the like. For example, an RNTI is not explicitly transmitted, and is transmitted after being included in a CRC calculation process. If the UE receives a DCI message transmitted on a PDCCH, the UE may identify a CRC by using an assigned RNTI, and if a CRC identification result is correct, the UE may identify that the corresponding message has been transmitted to the UE.

For example, DCI scheduling a PDSCH for system information (SI) may be scrambled by a SI-RNTI. DCI scheduling a PDSCH for a random access response (RAR) message may be scrambled by an RA-RNTI. DCI scheduling a PDSCH for a paging message may be scrambled by a P-RNTI. DCI notifying of a slot format indicator (SFI) may be scrambled by an SFI-RNTI. DCI notifying of a transmit power control (TPC) may be scrambled by a TPC-RNTI. DCI scheduling a UE-specific PDSCH or PUSCH may be scrambled by a cell RNTI (C-RNTI).

DCI format 0_0 may be used as fallback DCI scheduling a PUSCH, and in this case, a CRC may be scrambled by a C-RNTI. DCI format 0_0 having a CRC scrambled by a cell radio network temporary identifier (C-RNTI) may include, for example, the pieces of information in Table 11 below.

TABLE 8

| - | Identifier for DCI formats (DCI format identifier) - [1] bit |
|---|---|
| - | Frequency domain resource assignment (frequency domain resource |
| assignment) -[┌log₂( N_{RB}^{UL,BWP}(N_{RB}^{UL,BWP} + 1)/2)┐] bits | |
| - | Time domain resource assignment (time domain resource assignment) |
| - X bits | |
| - | Frequency hopping flag (frequency hopping flag) - 1 bit. |
| - | Modulation and coding scheme (modulation and coding scheme) - 5 |
| bits | |
| - | New data indicator (new data indicator) - 1 bit |
| - | Redundancy version (redundancy version) - 2 bits |
| - | HARQ process number (HARQ process number) - 4 bits |
| - | TPC command for scheduled PUSCH (transmit power control (TPC) |
| command for scheduled PUSCH - [2] bits | |
| - | UL/SUL indicator (Uplink (UL)/supplementary UL (SUL) indicator |

) - 0 or 1 bit

DCI format 0_1 may be used as non-fallback DCI scheduling a PUSCH, and in this case, a CRC may be scrambled by a C-RNTI. DCI format 0_1 having a CRC scrambled by a C-RNTI may include, for example, the pieces of information shown in Table 12 below.

```
TABLE 9
  Carrier indicator (Carrier indicator)-0 or 3 bits
  UL/SUL indicator-0 or 1 bit
  Identifier for DCI formats-[1] bits
  Bandwidth part indicator (bandwidth part indicator)-0, 1 or 2 bits
  Frequency domain resource assignment
    For resource allocation type 0(For resource allocation type 0),
    ┌N_{RB}^{UL,BWP}/P┐bits
    For resource allocation type 1 (For resource allocation type 1),
    ┌log₂ (N_{RB}^{UL,BWP}(N_{RB}^{UL,BWP} + 1)/2┐bits
  Time domain resource assignment-1, 2, 3, or 4 bits
  VRB-to-PRB mapping (virtual resource block-to-physical resource block
mapping)-0 or 1 bit, only for resource allocation type 1.
    0 bit if only resource allocation type 0 is configured;
    1 bit otherwise.
  Frequency hopping flag-0 or 1 bit, only for resource allocation type 1.
    0 bit if only resource allocation type 0 is configured;
    1 bit otherwise.
  Modulation and coding scheme-5 bits
  New data indicator-1 bit
  Redundancy version-2 bits
  HARQ process number-4 bits
  1^{st} downlink assignment index (1^{st} downlink assignment index)-1 or 2 bits
    1 bit for semi-static HARQ-ACK codebook(for semi-static
    HARQ-ACK codebook);
    2 bits for dynamic HARQ-ACK codebook with single HARQ-
    ACK codebook (for dynamic HARQ-ACK codebook with
    single HARQ-ACK codebook).
  2^{nd} downlink assignment index (2^{nd} downlink assignment index)-0 or 2 bits
    2 bits for dynamic HARQ-ACK codebook with two HARQ-
    ACK sub-codebooks (for dynamic HARQ-ACK codebook with
    two HARQ-ACK sub-codebooks);
    0 bit otherwise.
  TPC command for scheduled PUSCH-2 bits
  SRS resource indicator (SRS resource indicator)-
$⌈ {log}_{2} ( {\sum }_{k = 1}^{{L}_{max} \sum } ( \begin{matrix}{N}_{SRS} \\ k\end{matrix} ) ) ⌉ or ⌈ {log}_{2} ( {N}_{SRS} ) ⌉ bits$
    $⌈ {log}_{2} ( {\sum }_{k = 1}^{{L}_{max} \sum } ( \begin{matrix}{N}_{SRS} \\ k\end{matrix} ) ) ⌉ bits for non - codebook based PUSCH$
    transmission(for non-codebook based PUSCH transmission);
    ┌log₂ (N_{SRS})] bits for codebook based PUSCH transmission(for
    codebook based PUSCH transmission).
  Precoding information and number of layers (precoding information and number
of layers)-up to 6 bits
  Antenna ports (Antenna ports)-up to 5 bits
  SRS request (SRS request)-2 bits
  CSI request (CSI request)-0, 1, 2, 3, 4, 5, or 6 bits
  CBG transmission information (CBG(code block group) transmission
information)-0, 2, 4, 6, or 8 bits
  PTRS-DMRS association (PTRS-DMRS association)-0 or 2 bits.
  beta_offset indicator (beta_offset indicator)-0 or 2 bits
  DMRS sequence initialization (DMRS sequence initialization)-0 or 1 bit
```

DCI format 1_0 may be used as fallback DCI scheduling a PDSCH, and in this case, a CRC may be scrambled by a C-RNTI. DCI format 1_0 having a CRC scrambled by a C-RNTI may include, for example, the pieces of information shown in Table 13 below.

TABLE 10

| | |
|---|---|
| - | Identifier for DCI formats - [1] bit |
| - | Frequency domain resource assignment - [┌log₂( N_{RB}^{DL,BWP}(N_{RB}^{DL,BWP} + |

1)/2)┐] bits

| | |
|---|---|
| - | Time domain resource assignment - X bits |
| - | VRB-to-PRB mapping - 1 bit. |
| - | Modulation and coding scheme - 5 bits |
| - | New data indicator - 1 bit |
| - | Redundancy version - 2 bits |
| - | HARQ process number - 4 bits |
| - | Downlink assignment index - 2 bits |
| - | TPC command for scheduled PUCCH - [2] bits |
| - | PUCCH resource indicator (PUCCH (physical uplink control channel) |

resource indicator- 3 bits

| | |
|---|---|
| - | PDSCH-to-HARQ feedback timing indicator (PDSCH-to-HARQ |

feedback timing indicator)- [3] bits

DCI format 1_1 may be used as non-fallback DCI scheduling a PDSCH, and in this case, a CRC may be scrambled by a C-RNTI. DCI format 1_1 having a CRC scrambled by a C-RNTI may include, for example, the pieces of information shown in Table 14 below.

TABLE 11

| - | Carrier indicator - 0 or 3 bits | |
|---|---|---|
| - | Identifier for DCI formats - [1] bits | |
| - | Bandwidth part indicator - 0, 1 or 2 bits | |
| - | Frequency domain resource assignment | |
| | • | For resource allocation type 0, ┌N_{RB}^{DL,BWP}/P┐bits |
| | • | For resource allocation type 1, [┌log₂( N_{RB}^{DL,BWP}(N_{RB}^{DL,BWP} + |
| | | 1)/2)┐ bits |
| - | Time domain resource assignment -1, 2, 3, or 4 bits | |
| - | VRB-to-PRB mapping - 0 or 1 bit, only for resource allocation type 1. | |
| | • | 0 bit if only resource allocation type 0 is configured; |
| | • | 1 bit otherwise. |

| | |
|---|---|
| - | PRB bundling size indicator (PRB bundling size indicator) - 0 or 1 bit |
| - | Rate matching indicator (Rate matching indicator) - 0, 1, or 2 bits |
| - | ZP CSI-RS trigger (ZP CSI-RS trigger) - 0, 1, or 2 bits |

For transport block 1(For transport block 1):

| | |
|---|---|
| - | Modulation and coding scheme - 5 bits |
| - | New data indicator - 1 bit |
| - | Redundancy version - 2 bits |

For transport block 2(For transport block 2):

| | |
|---|---|
| - | Modulation and coding scheme - 5 bits |
| - | New data indicator - 1 bit |
| - | Redundancy version - 2 bits |
| - | HARQ process number - 4 bits |
| - | Downlink assignment index - 0 or 2 or 4 bits |
| - | TPC command for scheduled PUCCH - 2 bits |
| - | PUCCH resource indicator - 3 bits |
| - | PDSCH-to-HARQ_feedback timing indicator - 3 bits |
| - | Antenna ports - 4, 5 or 6 bits |
| - | Transmission configuration indication (transmission configuration |

indication)- 0 or 3 bits

| | |
|---|---|
| - | SRS request - 2 bits |
| - | CBG transmission information - 0, 2, 4, 6, or 8 bits |
| - | CBG flushing out information (CBG flushing out information) - 0 or 1 |

bit

| | |
|---|---|
| - | DMRS sequence initialization - 1 bit |

### PDSCH/PUSCH: Related to Frequency Resource Allocation

Next, frequency domain resource assignment (FDRA) for physical downlink shared channel (PDSCH) and physical uplink shared channel (PUSCH) in an NR will be described.

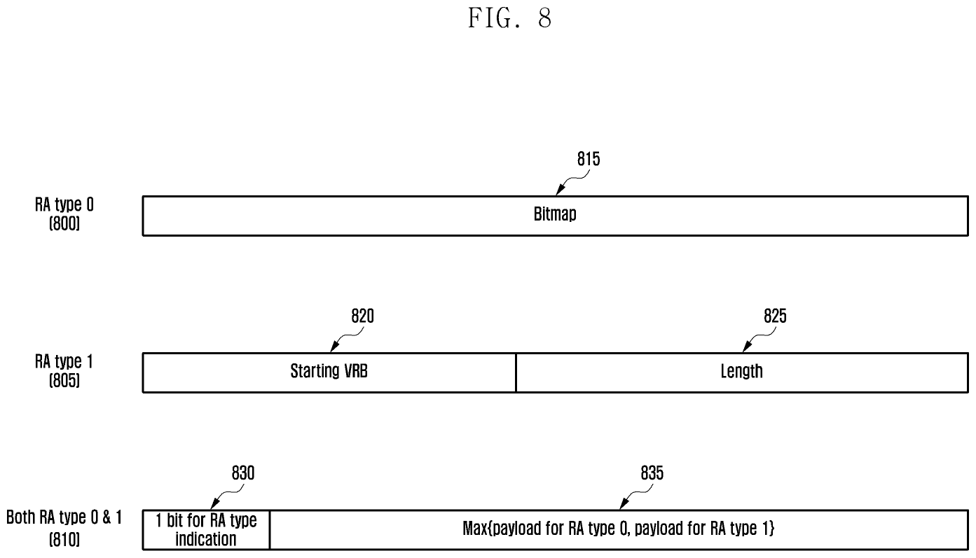

FIG. 8 is a diagram illustrating frequency domain resource allocation of a PDSCH or PUSCH in a wireless communication system according to an embodiment of the disclosure.

Referring to FIG. 8, it is a diagram illustrating three frequency domain resource allocation methods including FDRA type 0 800, FDRA type 1 805, and a dynamic switch 810 configurable through a higher layer in an NR wireless communication system.

With reference to FIG. 8, in case that a UE is configured, through higher layer signaling, to use only FDRA type 0 800, partial downlink control information (DCI) scheduling a PDSCH or PUSCH to the corresponding UE may include a bitmap constituted with N_{RBG} bits. A condition therefor will be described later. In this case, N_{RBG} may refer to the number of resource block groups (RBGs) determined as shown in Table 15 below according to the higher layer parameter rbg-Size and a BWP size allocated by a BWP indicator. Data is transmitted on an RBG marked with 1 according to a bitmap.

TABLE 12

| Bandwidth | | |
|---|---|---|
| Part Size | Configuration 1 | Configuration 2 |
| 1-36 | 2 | 4 |
| 37-72 | 4 | 8 |
| 73-144 | 8 | 16 |
| 145-275 | 16 | 16 |

The size of the frequency resource in the bandwidth part may be defined as the number of RBs included in the bandwidth part. More specifically, in the case that the UE is indicated to allocate FDRA type-0 resources, the length of the FDRA field of the DCI received by the UE is identical to the number of RBGs (N_{RBG}) in the bandwidth part, and it is N_{RBG}=┌(N_{BWP}^{size}+(N_{BWP}^{start} mod P))/P┐. Here, the first RBG in the bandwidth part includes RBG₀^{size}=P−N_{BWP}^{size} mod P RBs, and the last RBG in the bandwidth part includes the number of RBs, RBG_{size}^{last}=(N_{BWP}^{start}+N_{BWP}^{size}) mod P, if (N_{BWP}^{start}+N_{BWP}^{size}) mod P>0, and otherwise it includes the number of RBs, RBG_{size}^{last}=P. The remaining RBGs in the bandwidth part include P RBs. Here, P is the number of nominal RBG determined according to Table 15 above.

In case that the UE is configured to use only FDRA type 1 through higher layer signaling 805, the DCI that allocates PDSCH or PUSCH to the UE includes frequency domain resource allocation information (FDRA) including [log₂ (N_{RB}^{BWP}*(N_{RB}^{BWP}+1)/2] bits. Here, N_{RB}^{BWP} is the number of RBs included in the bandwidth part. Through this, the base station may configure the starting VRB 820 and the length of frequency domain resources 825 allocated sequentially therefrom.

If the UE is not configured to higher layer signaling vrb-ToPRB-Interleaver, the UE may associate the resources allocated to the VRB to the PRB without interleaving. In case that the UE is configured to the higher layer signaling vrb-ToPRB-Interleaver, the corresponding higher layer signaling has a value of 2 or 4, and this value may be a unit of a plurality of RBs that perform interleaving. For example, RB bundles of 2 or 4 units may be used for interleaving.

In the case that the UE is configured to the i-th BWP starting from the N_{BWP,i}^{start} location and including N_{BWP,i}^{size} RBs in length, and the vrb-ToPRB-Interleaver is configured to Lᵢ, the UE may divide the i-^{th} BWP into the number of RB bundles, N_{bundle}=┌(N_{BWP,i}^{size}+(N_{BWP,i}^{start} mod Lᵢ))/Lᵢ┐, and each RB bundle may be including Lᵢ RBs.

In the i-^{th} BWP, the first RB bundle may be including the number of RBs, Lᵢ-(N_{BWP,i}^{size} mod Lᵢ).

In the i-^{th} BWP, the last RB bundle may be including the number of RBs, (N_{BWP,i}^{start}+N; N_{BWP,i}^{size}) mod Lᵢ in case that the value of (N_{BWP,i}^{start}+N_{BWP,i}^{size}) mod Lᵢ is greater than 0, and otherwise, it may be composed Lᵢ RBs.

In the i-^{th} BWP, the remaining RB bundles may be including Lᵢ RBs.

In this case, the VRB may be associated to the PRB according to the following method.

The last VRB bundle may be associated to the last PRB bundle.

The j-^{th} (j=0, 1, . . . , N_{bundle}−2) VRB bundle may be associated to the f(j)-^{th} PRB bundle, and f(j) can be expressed as in Equation 1 below.

$$f ( j ) = rC + c \qquad Equation 1$$

$$j = cR + r$$

$$r = 0 , 1 , ... , R - 1$$

$$c = 0 , 1 , ... , C - 1$$

$$R = 2$$

$$C = ⌊ {N}_{bundle} / R ⌋$$

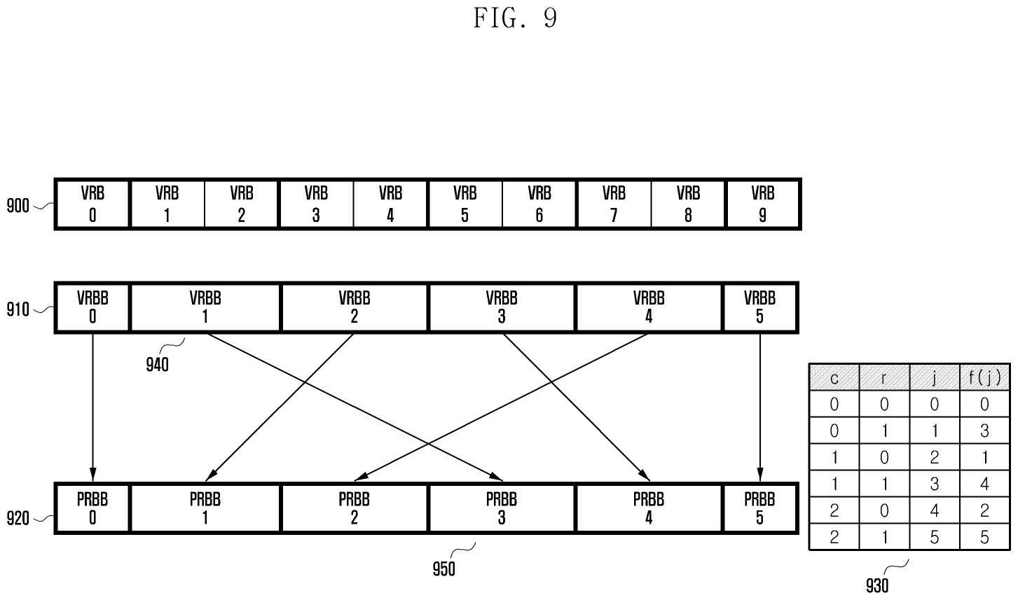

FIG. 9 is a diagram illustrating a VRB-PRB interleaving scheme of PDSCH in FDRA type-1 resource allocation according to an embodiment of the disclosure.

Referring to FIG. 9, a case 910 where the first and the last VRB bundles in a BWP 900 including 10 RBs are including 1 VRB is illustrated. Accordingly, the number of VRB bundles, N_{bundle}, may be 6, and may be calculated as C=[N_{bundle}/R]=3 by the above Equation 1. Accordingly, since the j-th VRB bundle may be associated with the f(j)-^{th} PRB bundle by the above Equation 1, the association from a VRB bundle to a PRB bundle may be performed as in a reference numeral 920 through the result 930 calculated by the above Equation 1. For example, VRB bundle 1 940 may be associated to PRB bundle 3 950.

In case that the UE is configured to use both FDRA type-0 resource allocation and FDRA type-1 resource allocation through higher layer signaling, some DCIs that allocate PDSCH/PUSCH to the corresponding UE include frequency domain resource allocation information constituted with bits of a larger value 835 among payload 815 for configuring FDRA type-0 resource allocation and payload 820, 825 for configuring FDRA type-1 resource allocation. The conditions for this will be described later. In this case, one bit 830 may be added to the first part (MSB) of the frequency domain resource allocation information in the DCI, and in case that the corresponding bit has a value of ‘0’, it may indicate that FDRA type-0 resource allocation is used, and in case that the corresponding bit has a value of ‘1’, it may indicate that FDRA type-1 resource allocation is used.

In case that the UE is configured to the FDRA type-2 resource allocation method through higher layer signaling, the UE may be indicated by the base station about the FDRA type-2 resource allocation method according to the following method.

The UE may be indicated by the base station of the RB allocation information, which is a set of M interlace indices.

The interlace index m∈{0, 1, . . . , M−1} may be constituted with common RBs {m, M+m, 2M+m, 3M+m, . . . }, and M may be defined as in Table 16.

TABLE 13

| μ | M |
|---|---|
| 0 | 10 |
| 1 | 5 |

The relationship between RB n_{IRB,m}^{μ}∈{0, 1, . . . } in interlace m and bandwidth part i and the common RB n_{CRB}^{μ} may be defined as follows.

$${n}_{CRB}^{μ} = {Mn}_{IRB , m}^{μ} + {N}_{BWP , i}^{start , μ} + ( ( m - {N}_{BWP , i}^{start , μ} ) mod M )$$

where N_{BWP,i}^{start,μ} is the common resource block where bandwidth part starts relative to common resource block 0. u is subcarrier spacing index.

When a subcarrier spacing is 15 kHz (u=0), RB allocation information for an interlace set may be notified from the base station to the UE with m0+1 indices. In addition, the resource allocation field may be constituted with a resource individuation value (RIV). When the resource individuation value is 0≤RIV<M (M+1)/2, l=0, 1, ⋅ ⋅ ⋅ L−1, it can be constituted with a start interlace m0 and the number of consecutive interlaces L (L≥1), and its values are as follows.

$$if ( L - 1 ) \leq ⌊ M / 2 ⌋ then$$

$$RIV = M ( L - 1 ) + {m}_{0}$$

$$else$$

$$RIV = M ( M - L + 1 ) + ( M - 1 - {m}_{0} )$$

When the resource individuation value is RIV≥M (M+1)/2, the resource individuation value is constituted with a start interlace index m0 and 1 values, and may be constituted as shown in Table 17.

TABLE 14

| RIV − M(M + 1)/2 | m0 | l |
|---|---|---|
| 0 | 0 | {0, 5} |
| 1 | 0 | {0, 1, 5, 6} |
| 2 | 1 | {0, 5} |
| 3 | 1 | {0, 1, 2, 3, 5, 6, 7, 8} |
| 4 | 2 | {0, 5} |
| 5 | 2 | {0, 1, 2, 5, 6, 7} |
| 6 | 3 | {0, 5} |
| 7 | 4 | {0, 5} |

When the subcarrier spacing is 30 kHz (u=1), RB allocation information may be notified from the base station to the UE in the form of a bitmap indicating interlaces allocated to the UE. The size of the bitmap is M, and each bit of the bitmap corresponds to an interlace. The order of the interlace bitmap may be mapped from MSB to LSB, from interlace index 0 to interlace index M−1.

In addition, for 15 kHz and 30 kHz, the least significant bit (LSB) of the FDRA field,

$$Y = ⌈ log 2 \frac{{N}_{RB - set}^{BWP} ( {N}_{RB - set}^{BWP} + 1 )}{2} ⌉ ,$$

may mean a continuous RB set of the PUSCH scheduled with DCI format 0_1. The Y bit may be constituted with a resource indication value (RIVRBset). In 0≤RIV_{RBset}<N_{RB-set}^{BWP}(N_{RB-set}^{BWP}+1)/2, l=0, 1, . . . . L_{RBset}−1, the RIVRBset value may be determined by the starting RB set (RBset_{START}) and the number of consecutive RB sets (L_{RBset} (L_{RBset}≥1)). The RIVRBset value may be defined as follows.

$$if ( {L}_{RBset} - 1 ) \leq ⌊ {N}_{RB - set}^{BWP} / 2 ⌋ then$$

$${RIV}_{RBset} = {N}_{RB - set}^{BWP} ( {L}_{RBset} - 1 ) + {RBset}_{START}$$

$$else$$

$${RIV}_{RBset} = {N}_{RB - set}^{BWP} ( {N}_{RB - set}^{BWP} - {L}_{RBset} + 1 ) + ( {N}_{RB - set}^{BWP} - 1 - {RBset}_{START} )$$

N_{RB-set}^{BWP} means the number of RB sets included in the bandwidth part, and may be determined by the number of guard gaps (or bands) within the carrier configured by higher signaling (or preconfigured).

### PDSCH/PUSCH: Related to Time Resource Allocation

Hereinafter, a time domain resource allocation method for a data channel in a next generation mobile communication system (5G or NR system) is described.

A base station may configure, for a UE, a table relating to time domain resource allocation information for a downlink data channel (PDSCH) and an uplink data channel (PUSCH) through higher layer signaling (e.g., RRC signaling). A table configured by a maximum of 16 entries (maxNrofDL-Allocations=16) may be configured for a PDSCH, and a table configured by a maximum of 16 entries (maxNrofUL-Allocations=16) may be configured for a PUSCH. In an embodiment of the disclosure, time domain resource allocation information may include a PDCCH-to-PDSCH slot timing (which corresponds to a time interval expressed in a unit of slots between a time point at which a PDCCH is received and a time point at which a PDSCH scheduled by the received PDCCH is transmitted, and may be represented by K0), a PDCCH-to-PUSCH slot timing (which corresponds to a time interval expressed in a unit of slots between a time point at which a PDCCH is received and a time point at which a PUSCH scheduled by the received PDCCH is transmitted, and may be represented by K2), information on a start symbol location and length which a PDSCH or PUSCH is scheduled in a slot, a PDSCH or PUSCH mapping type, and the like. For example, information as shown in Table 18 or Table 19 below may be transmitted from a base station to a UE.

TABLE 15
PDSCH-TimeDomainResourceAllocationList information element

PDSCH-TimeDomainResourceAllocationList ::= SEQUENCE
(SIZE(1..maxNrofDL-Allocations)) OF PDSCH-TimeDomainResourceAllocation
PDSCH-TimeDomainResourceAllocation ::= SEQUENCE {

| | |
|---|---|
| k0 | INTEGER(0..32) |

OPTIONAL, -- Need S

| | |
|---|---|
| mappingType | ENUMERATED {typeA, typeB}, |
| startSymbolAndLength | INTEGER (0..127) |

}

TABLE 16
PUSCH-TimeDomainResourceAllocation information element

PUSCH-TimeDomainResourceAllocationList ::= SEQUENCE
(SIZE(1..maxNrofUL-Allocations)) OF PUSCH-TimeDomainResourceAllocation
PUSCH-TimeDomainResourceAllocation ::= SEQUENCE {

| | |
|---|---|
| k2 | INTEGER(0..32) OPTIONAL, -- Need S |
| mappingType | ENUMERATED {typeA, typeB}, |
| startSymbolAndLength | INTEGER (0..127) |

}

The base station may notify the UE of one of the entries of the above table relating to time domain resource allocation information through L1 signaling (e.g., DCI) (for example, it may be indicated by a “time domain resource allocation” field in DCI). The UE may acquire time domain resource allocation information for a PDSCH or PUSCH, based on the DCI received from the base station.

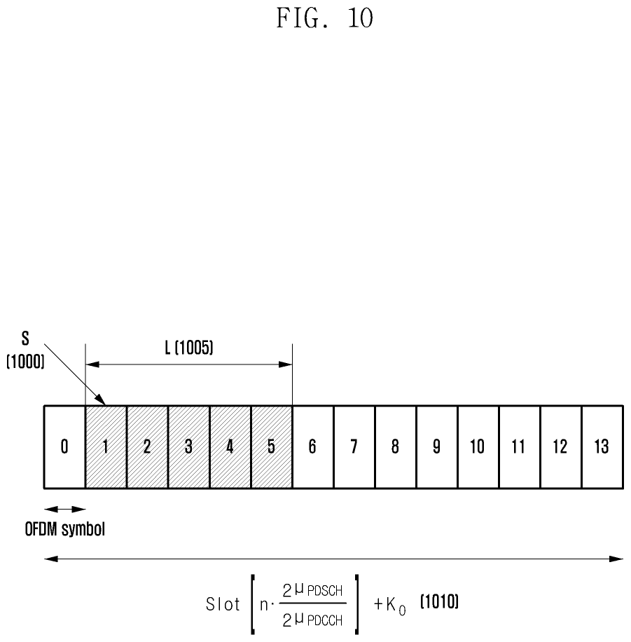

FIG. 10 is a diagram illustrating time domain resource allocation of a PDSCH in a wireless communication system according to an embodiment of the disclosure.

Referring to FIG. 10, a base station may indicate a time domain location of a PDSCH resource, based on a subcarrier spacing (SCS) (μ_{PDSCH}, μ_{PDCCH}) and a scheduling offset (K0) value 1010 of a data channel and a control channel configured using a higher layer, and a start location 1000 and length 1005 of OFDM symbols in one slot dynamically indicated through DCI.

### PUCCH: Relating to Transmission

In an NR system, a UE may transmit control information (UCI) to a base station through a PUCCH. The control information may include at least one of HARQ-ACK indicating whether or not demodulation/decoding for a transport block (TB) received by the UE through a PDSCH is successful, a scheduling request (SR) for requesting resource allocation from the PUSCH base station by the UE for uplink data transmission, or channel state information (CSI) that is information for channel state reporting of the UE.

PUCCH resources may be mainly classified into a long PUCCH and a short PUCCH according to a length of an assigned symbol. In the NR system, a long PUCCH has a length of 4 symbols or more in a slot, and a short PUCCH has a length of 2 symbols or fewer in a slot.

To describe long PUCCH further, the long PUCCH may be used for the purpose of improving uplink cell coverage, and thus may be transmitted in a DFT-S-OFDM scheme, which is a single carrier transmission, rather than OFDM transmission. The long PUCCH supports transmission formats, such as PUCCH format 1, PUCCH format 3, and PUCCH format 4, depending on the number of supportable control information bits and whether UE multiplexing through Pre-DFT orthogonal cover code (OCC) support at a previous stage of IFFT is supported.

PUCCH format 1 is a DFT-S-OFDM-based long PUCCH format capable of supporting control information of up to 2 bits, and uses a frequency resource of 1 RB. The control information may be constituted with each of or a combination of HARQ-ACK and SR. In PUCCH format 1, an OFDM symbol including demodulation reference signal (DMRS), which is a demodulation reference signal (or reference signal) and an OFDM symbol including UCI are constituted in a repetitive manner.

For example, in case that the number of transmission symbols of PUCCH format 1 is 8 symbols, PUCCH format 1 may be constituted with, starting from a first start symbol of the 8 symbols, a DMRS symbol, a UCI symbol, a DMRS symbol, a UCI symbol, a DMRS symbol, a UCI symbol, a DMRS symbol, and a UCI symbol in sequence. A DMRS symbol may be spread using an orthogonal code (or orthogonal sequence or spreading code, wᵢ(m)) on the time domain to a sequence corresponding to a length of 1 RB on the frequency domain within one OFDM symbol, and may be transmitted after IFFT is performed.

For a UCI symbol, the UE may generate d(0) by BPSK-modulating 1-bit control information and quadrature phase shift keying (QPSK)-modulating 2-bit control information, multiply generated d(0) by a sequence corresponding to the length of 1 RB on the frequency domain so as to perform scrambling, perform spreading using the orthogonal code (or orthogonal sequence or spreading code, wᵢ(m)) on the time domain to the scrambled sequence, perform IFFT, and then perform transmission.

The UE may generate the sequence, based on a configured ID and a group hopping or sequence hopping configuration received through higher layer signaling from the base station, and generate a sequence corresponding to a length of 1 RB by cyclic shifting the generated sequence with an initial cyclic shift (CS) value configured through a higher signal.

wᵢ(m) is determined as in

$${w}_{i} ( m ) = {e}^{\frac{j 2 πϕ ( m )}{{N}_{SF}}}$$

if a length (NSF) of a spreading code is given, which is particularly shown below in Table 20. i indicates an index of the spreading code itself, and m indicates indexes of elements of the spreading code. Here, numbers within [ ] in Table 20 refer to φ(m), and in case that a length of the spreading code is 2 and an index of the configured spreading code is i=0, spreading code wᵢ(m) becomes

$${w}_{i} ( 0 ) = {e}^{j 2 π \cdot 0 / {N}_{SF}} = 1 , {w}_{i} ( 1 ) = {e}^{j 2 π \cdot 0 / {N}_{SF}} = 1 ,$$

so that wᵢ(m)=[1 1].

TABLE 17

| | φ(m) | | | | | | |
|---|---|---|---|---|---|---|---|
| N_{SF} | i = 0 | i = 1 | i = 2 | i = 3 | i = 4 | i = 5 | i = 6 |
| 1 | [0] | — | — | — | — | — | — |
| 2 | [0 0] | [0 1] | — | — | — | — | — |
| 3 | [0 0 0] | [0 1 2] | [0 2 1] | — | — | — | — |
| 4 | [0 0 0 0] | [0 2 0 2] | [0 0 2 2] | [0 2 2 0] | — | — | — |
| 5 | [0 0 0 0 0] | [0 1 2 3 4] | [0 2 4 1 3] | [0 3 1 4 2] | [0 4 3 2 1] | — | — |
| 6 | [0 0 0 0 0 0] | [0 1 2 3 4 5] | [0 2 4 0 2 4] | [0 3 0 3 0 3] | [0 4 2 0 4 2] | [0 5 4 3 2 1] | — |
| 7 | [0 0 0 0 0 0 0] | [0 1 2 3 4 5 6] | [0 2 4 6 1 3 5] | [0 3 6 2 5 1 4] | [0 4 1 5 2 6 3] | [0 5 3 1 6 4 2] | [0 6 5 4 3 2 1] |

Next, PUCCH format 3 is a DFT-S-OFDM-based long PUCCH format capable of supporting control information exceeding 2 bits, and the number of used RBs is configurable through a higher layer. The control information may include each of or a combination of HARQ-ACK, SR, and CSI. In PUCCH format 3, a DMRS symbol location is shown below in Table 21 according to whether an additional DMRS symbol is configured and whether frequency hopping is configured within a slot.

TABLE 18

| | DMRS location within PUCCH format ¾ transmission | | | |
|---|---|---|---|---|
| | Additional DMRS | | Additional DMRS | |
| PUCCH | not configured | | configured | |
| format ¾ | Frequency | Frequency | Frequency | Frequency |
| transmission | hopping not | hopping | hopping not | hopping |
| length | configured | configured | configured | configured |
| 4 | 1 | 0, 2 | 1 | 0, 2 |

| | | |
|---|---|---|
| 5 | 0, 3 | 0, 3 |
| 6 | 1, 4 | 1, 4 |
| 7 | 1, 4 | 1, 4 |
| 8 | 1, 5 | 1, 5 |
| 9 | 1, 6 | 1, 6 |
| 10 | 2, 7 | 1, 3, 6, 8 |
| 11 | 2, 7 | 1, 3, 6, 9 |
| 12 | 2, 8 | 1, 4, 7, 10 |
| 13 | 2, 9 | 1, 4, 7, 11 |
| 14 | 3, 10 | 1, 5, 8, 12 |

In case that the number of transmission symbols of PUCCH format 3 is 8 symbols, starting with a first start symbol being 0 among the 8 symbols, DMRSs are transmitted through the first and fifth symbols. Table 21 is applied in the same manner as a DMRS symbol location of PUCCH format 4.

Next, PUCCH format 4 is a DFT-S-OFDM-based long PUCCH format capable of supporting control information exceeding 2 bits, and uses a frequency resource of 1 RB. The control information may be constituted with each of or a combination of HARQ-ACK, SR, and CSI. A difference between PUCCH format 4 and PUCCH format 3 is that, for PUCCH format 4, PUCCH format 4 of multiple UEs may be multiplexed within one RB. Multiplexing of PUCCH format 4 of a plurality of UEs is possible through application of Pre-DFT orthogonal cover code (OCC) to control information at a previous stage of IFFT. However, the number of transmittable control information symbols of one UE decreases according to the number of multiplexed UEs. The number of multiplexable UEs, that is, the number of different available OCCs, may be 2 or 4, and the number of OCCs and the OCC index to be applied may be configured through a higher layer.

Next, the short PUCCH will be described. The short PUCCH may be transmitted in both a downlink centric slot and an uplink centric slot and, in general, the short PUCCH may be transmitted at a last symbol of a slot or an OFDM symbol at the end (e.g., the last OFDM symbol, a second OFDM symbol from the last, or last 2 OFDM symbols at the end). It is apparent that transmission of the short PUCCH at a random position in the slot is also possible. And, the short PUCCH may be transmitted using one OFDM symbol or two OFDM symbols. The short PUCCH may be used to shorten a delay time compared to a long PUCCH when uplink cell coverage is good, and may be transmitted in a CP-OFDM scheme.

The short PUCCH may support transmission formats, such as PUCCH format 0 and PUCCH format 2, according to the number of supportable control information bits. First, PUCCH format 0 is a short PUCCH format capable of supporting control information of up to 2 bits, and uses a frequency resource of 1 RB. The control information may be constituted with each of or a combination of HARQ-ACK and SR. PUCCH format 0 has a structure of transmitting no DMRS and transmitting only a sequence mapped to 12 subcarriers in the frequency domain within one OFDM symbol. The UE may generate a sequence, based on a configured ID and a group hopping or sequence hopping configured by the base station through a higher signal, cyclic-shifts the generated sequence by using a final CS value acquired by adding a different CS value to an indicated initial cyclic shift (CS) value depending on ACK or NACK, and maps the cyclic-shifted sequence to 12 subcarriers, so as to perform transmission.

For example, for HARQ-ACK of 1 bit, as shown below in Table 22, if ACK, the UE may generate the final CS by adding 6 to the initial CS value, and if NACK, the UE may generate the final CS by adding 0 to the initial CS. The CS value of 0 for NACK and the CS value of 6 for ACK are defined in the standard, and the UE may generate PUCCH format 0 according to the value defined in the standard so as to transmit 1-bit HARQ-ACK.

TABLE 19

| 1-bit | | |
|---|---|---|
| HARQ-ACK | NACK | ACK |
| Final CS | (Initial CS + 0) | (Initial CS + 6) |
| | mod 12 = | mod 12 |
| | Initical CS | |

For example, in case that HARQ-ACK is 2 bits, as shown below in Table 23, the UE adds 0 to the initial CS value for (NACK, NACK), adds 3 to the initial CS value for (NACK, ACK), adds 6 to the initial CS value for (ACK, ACK), and adds 9 to the initial CS value for (ACK, NACK). The CS value of 0 for (NACK, NACK), the CS value of 3 for (NACK, ACK), the CS value of 6 for (ACK, ACK), and the CS value of 9 for (ACK, NACK) are defined in the standard, and the UE may generate PUCCH format 0 according to the value defined in the standard so as to transmit a 2-bit HARQ-ACK. In case that the final CS value exceeds 12 due to the CS value added to the initial CS value according to ACK or NACK, since a sequence length is 12, modulo 12 may be applied to the final CS value.

TABLE 20

| 2-bit | NACK, | NACK, | ACK, | ACK, |
|---|---|---|---|---|
| HARQ-ACK | NACK | ACK | ACK | NACK |
| Final CS | (Initial | (Initial | (Initial | (Initial |
| | CS + 0) | CS + 3) | CS + 6) | CS + 9) |
| | mod 12 = | mod 12 | mod 12 | mod 12 |
| | Initial CS | | | |

Next, PUCCH format 2 is a short PUCCH format supporting control information exceeding 2 bits, and the number of used RBs may be configured through a higher layer. The control information may be constituted with each of or a combination of HARQ-ACK, SR, and CSI. When an index of a first subcarrier is #0, in PUCCH format 2, locations of subcarriers in which a DMRS is transmitted may be fixed to subcarriers having indexes of #1, #4, #7, and #10 within one OFDM symbol. The control information may be mapped to subcarriers remaining after excluding the subcarriers, in which the DMRS is located, through modulation after channel coding.

In summary, values configurable for the aforementioned respective PUCCH formats and ranges of the values may be organized as shown below in Table 24. In case that no value needs to be configured, it is denoted as N.A.

TABLE 21

| | | PUCCH | PUCCH | PUCCH | PUCCH | PUCCH |
|---|---|---|---|---|---|---|
| | | Format 0 | Format 1 | Format 2 | Format 3 | Format 4 |
| Starting | Configurability | ✓ | ✓ | ✓ | ✓ | ✓ |
| symbol | Value range | 0-13 | 0-10 | 0-13 | 0-10 | 0-10 |
| Number of | Configurability | ✓ | ✓ | ✓ | ✓ | ✓ |
| symbols | Value range | 1, 2 | 4-14 | 1, 2 | 4-14 | 4-14 |
| in a slot | | | | | | |
| Index for | Configurability | ✓ | ✓ | ✓ | ✓ | ✓ |
| identifying | Value range | 0-274 | 0-274 | 0-274 | 0-274 | 0-274 |
| starting PRB | | | | | | |
| Number | Configurability | N.A. | N.A. | ✓ | ✓ | N.A. |
| of PRBs | Value range | N.A. | N.A. | 1-16 | 1-6, 8-10, | N.A. |
| | | (Default is 1) | (Default is 1) | | 12, 15, 16 | (Default is 1) |
| Enabling | Configurability | ✓ | ✓ | ✓ | ✓ | ✓ |
| frequency | Value range | On/Off (only | On/Off | On/Off (only | On/off | On/Off |
| hopping | | for 2 symbol) | | for 2 symbol) | | |
| (intra-slot) | | | | | | |
| Freq.cy resource | Configurability | ✓ | ✓ | ✓ | ✓ | ✓ |
| of 2^{nd} hop if | Value range | 0-274 | 0-274 | 0-274 | 0-274 | 0-274 |
| intra-slot | | | | | | |
| frequency | | | | | | |
| hopping is | | | | | | |
| enabled | | | | | | |
| Index of initial | Configurability | ✓ | ✓ | N.A. | N.A. | N.A. |
| cyclic shift | Value range | 0-11 | 0-11 | N.A. | N.A. | N.A. |
| Index of | Configurability | N.A. | ✓ | N.A. | N.A. | N.A. |
| time-domain | Value range | N.A. | 0-6 | N.A. | N.A. | N.A. |
| OCC | | | | | | |
| Length of | Configurability | N.A. | N.A. | N.A. | N.A. | ✓ |
| Pre-DFT OCC | Value range | N.A. | N.A. | N.A. | N.A. | 2, 4 |
| Index of | Configurability | N.A. | N.A. | N.A. | N.A. | ✓ |
| Pre-DFT OCC | Value range | N.A. | N.A. | N.A. | N.A. | 0, 1, 2, 3 |

Meanwhile, in order to improve uplink coverage, multi-slot repetition may be supported for PUCCH formats 1, 3, and 4, and PUCCH repetition may be configured for each PUCCH format. The UE may repeatedly transmit a PUCCH including UCI as many times as the number of slots configured through nrofSlots that is higher layer signaling. For the repeated PUCCH transmission, PUCCH transmission in each slot may be performed using the same number of consecutive symbols, and the number of the corresponding consecutive symbols may be configured through nrofSymbols in PUCCH-format 1, PUCCH-format 3, or PUCCH-format 4, which is higher layer signaling. For the repeated PUCCH transmission, PUCCH transmission in each slot may be performed using the same start symbol, and the corresponding start symbol may be configured through startingSymbolIndex in PUCCH-format 1, PUCCH-format 3, or PUCCH-format 4, which is higher layer signaling. For the repeated PUCCH transmission, a single PUCCH-spatialRelationInfo may be configured for a single PUCCH resource. For the repeated PUCCH transmission, if the UE is configured to perform frequency hopping in PUCCH transmission in different slots, the UE may perform frequency hopping in units of slots. In addition, if the UE is configured to perform frequency hopping in PUCCH transmission in different slots, the UE may start, in an even-numbered slot, the PUCCH transmission from a first PRB index configured through startingPRB that is higher layer signaling, and the UE may start, in an odd-numbered slot, the PUCCH transmission from a second PRB index configured through secondHopPRB that is higher layer signaling. Additionally, if the UE is configured to perform frequency hopping in PUCCH transmission in different slots, an index of a slot indicated to the UE for first PUCCH transmission is 0, and during the configured total number of repeated PUCCH transmissions, a value of the number of repeated PUCCH transmissions may be increased in each slot regardless of performance of the PUCCH transmission. If the UE is configured to perform frequency hopping in PUCCH transmission in different slots, the UE does not expect configuration of frequency hopping within the slot during PUCCH transmission. If the UE is not configured to perform frequency hopping in PUCCH transmission in different slots, but is configured with frequency hopping within a slot, a first PRB index and second PRB index are applied equally in the slot. If the number of UL symbols available for PUCCH transmission is less than nrofSymbols configured through higher layer signaling, the UE may not transmit a PUCCH. Even if the UE fails to transmit a PUCCH in a certain slot during repeated PUCCH transmission, the UE may increase the number of repeated PUCCH transmissions.

In NR Release 17, the number of slots repeatedly transmitted for each PUCCH resource may be configured through the higher layer signaling pucch-RepetitionNrofSlots-r17 in PUCCH-ResourceExt, which is an extension of PUCCH-Resource, which is the higher layer signaling for PUCCH resources. In case that the corresponding higher layer signaling pucch-RepetitionNrofSlots-r17 is configured, the corresponding PUCCH resource is scheduled, and the higher layer signaling nrofSlots is also configured, the UE determines the number of slots in which the corresponding PUCCH resource is repeatedly transmitted through pucch-RepetitionNrofSlots-r17 and ignores the higher layer signaling nrofSlots.

### PUSCH: Related to Transmission Scheme

Next, a scheduling scheme of PUSCH transmission will be described. PUSCH transmission may be dynamically scheduled by a UL grant in DCI or may be operated by configured grant Type 1 or Type 2. Dynamic scheduling indication for PUSCH transmission is possible by DCI format 0_0 or 0_1.

For configured grant Type 1 PUSCH transmission, the UL grant in DCI may not be received, and configuration may be performed semi-statically through reception of configuredGrantConfig including rrc-ConfiguredUplinkGrant shown in Table 25 through higher signaling. Configured grant Type 2 PUSCH transmission may be semi-persistently scheduled by the UL grant in DCI after reception of configuredGrantConfig that does not include rrc-ConfiguredUplinkGrant of Table 25 through higher signaling. In case that PUSCH transmission is operated by the configured grant, parameters applied to PUSCH transmission are applied through configuredGrantConfig that is higher signaling shown below in Table 25, except for dataScramblingIdentityPUSCH, txConfig, codebookSubset, maxRank, and scaling of UCI-OnPUSCH provided through pusch-Config that is higher signaling shown in Table 26. If the UE is provided with transformPrecoder in configuredGrantConfig that is higher signaling in Table 25, the UE applies tp-pi2BPSK in pusch-Config of Table 26 to PUSCH transmission operated by the configured grant.

TABLE 22

| | |
|---|---|
| ConfiguredGrantConfig ::= | SEQUENCE { |
| frequencyHopping | ENUMERATED {intraSlot, interSlot} |
| OPTIONAL, -- Need S, | |
| cg-DMRS-Configuration | DMRS-UplinkConfig, |
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| uci-OnPUSCH | SetupRelease { CG-UCI-OnPUSCH } |

OPTIONAL, -- Need M

| | |
|---|---|
| resourceAllocation | ENUMERATED { resourceAllocationType0, |

resourceAllocationType1, dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |
| transformPrecoder | ENUMERATED {enabled, disabled} |

OPTIONAL, -- Need S

| | |
|---|---|
| nrofHARQ-Processes | INTEGER(1..16), |
| repK | ENUMERATED {n1, n2, n4, n8}, |
| repK-RV | ENUMERATED {s1-0231, s2-0303, s3-0000} |

OPTIONAL, -- Need R

| | |
|---|---|
| periodicity | ENUMERATED { |
| | sym2, sym7, sym1x14, sym2x14, sym4x14, sym5x14, |

sym8x14, sym10x14, sym16x14, sym20x14,

sym32x14, sym40x14, sym64x14, sym80x14, sym128x14,

sym160x14, sym256x14, sym320x14, sym512x14,

sym640x14, sym1024x14, sym1280x14, sym2560x14,

sym5120x14,

sym6, sym1x12, sym2x12, sym4x12, sym5x12, sym8x12,

sym10x12, sym16x12, sym20x12, sym32x12,

sym40x12, sym64x12, sym80x12, sym128x12,

sym160x12, sym256x12, sym320x12, sym512x12, sym640x12,

sym1280x12, sym2560x12

},

| | |
|---|---|
| configuredGrantTimer | INTEGER (1..64) |

OPTIONAL, -- Need R

| | |
|---|---|
| rrc-ConfiguredUplinkGrant | SEQUENCE { |
| timeDomainOffset | INTEGER (0..5119), |
| timeDomainAllocation | INTEGER (0..15), |
| frequencyDomainAllocation | BIT STRING (SIZE(18)), |
| antennaPort | INTEGER (0..31), |
| dmrs-SeqInitialization | INTEGER (0..1) |

OPTIONAL, -- Need R

| | |
|---|---|
| precodingAndNumberOfLayers | INTEGER (0..63), |
| srs-ResourceIndicator | INTEGER (0..15) |

OPTIONAL, -- Need R

| mcsAndTBS | INTEGER (0..31), | |
|---|---|---|
| frequencyHoppingOffset | INTEGER (1.. | |
| maxNrofPhysicalResourceBlocks-1) | | OPTIONAL, -- Need R |

| | |
|---|---|
| pathlossReferenceIndex | INTEGER (0..maxNrofPUSCH- |

PathlossReferenceRSs-1),
...

| | |
|---|---|
| } | OPTIONAL, -- |

Need R
...
}

Next, PUSCH transmission method will be described. A DMRS antenna port for PUSCH transmission is the same as an antenna port for SRS transmission. PUSCH transmission may conform to each of a codebook-based transmission method and a non-codebook-based transmission method, depending on whether a value of txConfig in pusch-Config of Table 26, which is higher signaling, corresponds to ‘codebook’ or ‘nonCodebook’.

As described above, PUSCH transmission may be dynamically scheduled through DCI format 0_0 or 0_1, and may be semi-statically configured by a configured grant. If the UE is indicated with scheduling for PUSCH transmission through DCI format 0_0, the UE performs beam configuration for PUSCH transmission by using pucch-spatialRelationInfoID corresponding to a UE-specific PUCCH resource which corresponds to a minimum ID within an activated uplink BWP in a serving cell. In this case, the PUSCH transmission is based on a single antenna port. The UE does not expect scheduling for PUSCH transmission through DCI format 0_0, within a BWP in which a PUCCH resource including pucch-spatialRelationInfo is not configured. If the UE is not configured with txConfig in pusch-Config of Table 26, the UE does not expect to be scheduled through DCI format 0_1.

TABLE 23

| | |
|---|---|
| PUSCH-Config ::= | SEQUENCE { |
| dataScramblingIdentityPUSCH | INTEGER (0..1023) |

OPTIONAL, -- Need S

| | |
|---|---|
| txConfig | ENUMERATED {codebook, nonCodebook} |

OPTIONAL, -- Need S

| dmrs-UplinkForPUSCH-MappingTypeA | | SetupRelease { DMRS- |
|---|---|---|
| UplinkConfig } | OPTIONAL, -- Need M | |
| dmrs-UplinkForPUSCH-MappingTypeB | | SetupRelease { DMRS- |

| | |
|---|---|
| UplinkConfig } | OPTIONAL, -- Need M |
| pusch-PowerControl | PUSCH-PowerControl |

OPTIONAL, -- Need M

| | |
|---|---|
| frequencyHopping | ENUMERATED {intraSlot, interSlot} |

OPTIONAL, -- Need S

| frequencyHoppingOffsetLists | SEQUENCE (SIZE (1..4)) OF INTEGER (1.. | |
|---|---|---|
| maxNrofPhysicalResourceBlocks-1) | | |
| | | OPTIONAL, -- |

Need M

| | |
|---|---|
| resourceAllocation | ENUMERATED { resourceAllocationType0, |

resourceAllocationType1, dynamicSwitch},

| pusch-TimeDomainAllocationList | SetupRelease { PUSCH- | |
|---|---|---|
| TimeDomainResourceAllocationList } | | OPTIONAL, -- Need M |

| | |
|---|---|
| pusch-AggregationFactor | ENUMERATED { n2, n4, n8 } |

OPTIONAL, -- Need S

| | |
|---|---|
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| transformPrecoder | ENUMERATED {enabled, disabled} |

OPTIONAL, -- Need S

| | |
|---|---|
| codebookSubset | ENUMERATED |

{fullyAndPartialAndNonCoherent, partialAndNonCoherent,nonCoherent}

| | |
|---|---|
| codebookBased | OPTIONAL, -- Cond |

| | |
|---|---|
| maxRank | INTEGER (1..4) |

OPTIONAL, -- Cond codebookBased

| | |
|---|---|
| rbg-Size | ENUMERATED { config2} |

OPTIONAL, -- Need S

| | |
|---|---|
| uci-OnPUSCH | SetupRelease { UCI-OnPUSCH} |

OPTIONAL, -- Need M

| | |
|---|---|
| tp-pi2BPSK | ENUMERATED {enabled} |

OPTIONAL, -- Need S
...
}

Next, codebook-based PUSCH transmission will be described.

Codebook-based PUSCH transmission may be dynamically scheduled through DCI format 0_0 or 0_1 and may operate semi-statically by a configured grant. If a codebook-based PUSCH is dynamically scheduled by DCI format 0_1 or is configured semi-statically by a configured grant, the UE determines a precoder for PUSCH transmission, based on an SRS resource indicator (SRI), a transmission precoding matrix indicator (TPMI), and a transmission rank (the number of PUSCH transmission layers).

In this case, the SRI may be given to the UE through an SRS resource indicator field, in DCI or may be configured through srs-ResourceIndicator that is higher signaling. The UE may be configured, during codebook-based PUSCH transmission, with at least one SRS resource and configured with up to two SRS resources. In case that the UE is provided with the SRI through DCI, for an SRS resource indicated by the corresponding SRI, an SRS resource corresponding to the SRI may be referenced from among SRS resources transmitted before a PDCCH including the corresponding SRI. In addition, the TPMI and transmission rank may be given through a field of precoding information and number of layers, in DCI or may be configured through precodingAndNumberOfLayers that is higher signaling. The TPMI is used to indicate a precoder applied to PUSCH transmission. If the UE is configured with one SRS resource, the TPMI is used to indicate a precoder to be applied in the configured one SRS resource. If the UE is configured with a plurality of SRS resources, the TPMI is used to indicate a precoder to be applied in the SRS resource indicated through the SRI.

A precoder to be used for PUSCH transmission is selected from an UL codebook having the same number of antenna ports as a value of nrofSRS-Ports in SRS-Config that is higher signaling. In codebook-based PUSCH transmission, the UE determines a codebook subset, based on codebookSubset in pusch-Config, which is higher signaling, and the TPMI. codebookSubset in pusch-Config that is higher signaling may be configured to be one of ‘fullyAndPartialAndNonCoherent’, ‘partialAndNonCoherent’, and ‘nonCoherent’, based on UE capability reported to the base station by the UE. If the UE has reported ‘partialAndNonCoherent’ as UE capability, the UE does not expect that a value of codebookSubset that is higher signaling is configured to be ‘fullyAndPartialAndNonCoherent’. In addition, if the UE has reported ‘nonCoherent’ as UE capability, the UE does not expect the value of codebookSubset, which is higher h signaling, to be configured to either ‘fullyAndPartialAndNonCoherent’ or ‘partialAndNonCoherent’. In case that nrofSRS-Ports in SRS-ResourceSet that is higher signaling indicates two SRS antenna ports, the UE does not expect that the value of codebookSubset that is higher signaling is configured to be ‘partialAndNonCoherent’.

The UE may be configured with one SRS resource set, in which a value of usage in SRS-ResourceSet that is higher signaling is configured to be ‘codebook’, and one SRS resource in the corresponding SRS resource set may be indicated through the SRI. If multiple SRS resources are configured in the SRS resource set in which the value of usage in SRS-ResourceSet that is higher signaling is configured to be ‘codebook’, the UE expects that the value of nrofSRS-Ports in SRS-Resource that is higher signaling is configured to be the same for all SRS resources.

The UE transmits one or a plurality of SRS resources included in the SRS resource set, in which the value of usage is configured to be ‘codebook’, to the base station according to higher signaling, and the base station selects one of the SRS resources transmitted by the UE and indicates the UE to perform PUSCH transmission using transmission beam information of the corresponding SRS resource. In this case, in codebook-based PUSCH transmission, the SRI is used as information for selecting of an index of one SRS resource and is included in the DCI. Additionally, the base station includes, in the DCI, information indicating the rank and TPMI to be used for PUSCH transmission by the UE. The UE uses the SRS resource indicated by the SRI to perform PUSCH transmission by applying the precoder indicated by the TPMI and the rank, which has been indicated based on a transmission beam of the corresponding SRS resource.

Next, non-codebook-based PUSCH transmission will be described. Non-codebook-based PUSCH transmission may be dynamically scheduled through DCI format 0_0 or 0_1 and may operate semi-statically by a configured grant. In case that at least one SRS resource is configured in an SRS resource set, in which the value of usage in SRS-ResourceSet that is higher signaling is configured to be ‘nonCodebook’, the UE may be scheduled for non-codebook-based PUSCH transmission through DCI format 0_1.

For the SRS resource set in which the value of usage in SRS-ResourceSet that is higher signaling is configured to be ‘nonCodebook’, the UE may be configured with one associated non-zero power (NZP) CSI-RS resource. The UE may perform calculation on a precoder for SRS transmission through measurement for the NZP CSI-RS resource associated with the SRS resource set. If a difference between a last reception symbol of an aperiodic NZP CSI-RS resource associated with the SRS resource set and a first symbol of aperiodic SRS transmission in the UE is less than 42 symbols, the UE does not expect information on the precoder for SRS transmission to be updated.

If a value of resourceType in SRS-ResourceSet that is higher signaling is configured to be ‘aperiodic’, the associated NZP CSI-RS may be indicated through a field, SRS request, in DCI format 0_1 or 1_1. In this case, if the associated NZP CSI-RS resource is an aperiodic NZP CSI-RS resource, the presence of the associated NZP CSI-RS in case that a value of the field, SRS request, in DCI format 0_1 or 1_1 is not ‘00’ is indicated. In this case, the corresponding DCI should indicate neither a cross carrier nor cross BWP scheduling. In addition, if the value of SRS request indicates the presence of the NZP CSI-RS, the corresponding NZP CSI-RS is located at a slot in which a PDCCH including the SRS request field has been transmitted. In this case, TCI states configured in scheduled subcarriers are not configured to be QCL-TypeD.

If a periodic or semi-persistent SRS resource set is configured, the associated NZP CSI-RS may be indicated through associated CSI-RS in SRS-ResourceSet that is higher signaling. For non-codebook-based transmission, the UE does not expect that spatialRelationInfo, which is higher signaling for the SRS resource, and associatedCSI-RS in SRS-ResourceSet that is higher signaling are configured together.

In case that a plurality of SRS resources are configured, the UE may determine the precoder and transmission rank to be applied to PUSCH transmission, based on the SRI indicated by the base station. In this case, the SRI may be indicated through the field, SRS resource indicator, in DCI or may be configured through srs-ResourceIndicator that is higher signaling. As with the aforementioned codebook-based PUSCH transmission, in case that the UE is provided with the SRI through the DCI, the SRS resource indicated by the corresponding SRI refers to an SRS resource corresponding to the SRI from among SRS resources transmitted before the PDCCH including the corresponding SRI. The UE may use one or a plurality of SRS resources for SRS transmission, and the maximum number of SRS resources simultaneously transmittable in the same symbol within one SRS resource set may be determined by UE capability reported to the base station by the UE. In this case, the SRS resources that the UE simultaneously transmits occupy the same RB. The UE configures one SRS port for each SRS resource. Only one SRS resource set, in which the value of usage in SRS-ResourceSet that is higher signaling is configured to be ‘nonCodebook’, may be configured, and up to 4 SRS resources for the non-codebook-based PUSCH transmission may be configured.

The base station transmits one NZP CSI-RS associated to the SRS resource set to the UE, and the UE calculates, based on a result of measurement during reception of the NZP CSI-RS, the precoder to be used during transmission of one or a plurality of SRS resources in the corresponding SRS resource set. The UE applies the calculated precoder when transmitting, to the base station, one or a plurality of SRS resources in the SRS resource set in which usage is configured to be ‘nonCodebook’, and the base station may select one or a plurality of SRS resources from among the received one or a plurality of SRS resources. In this case, in non-codebook-based PUSCH transmission, the SRI indicates an index capable of expressing one SRS resource or a combination of the plurality of SRS resources, and the SRI may be included in the DCI. In this case, the number of SRS resources indicated by the SRI transmitted by the base station may be the number of PUSCH transmission layers, and the UE may transmit the PUSCH by applying, to each layer, the precoder applied to SRS resource transmission.

### Related to SRS

Next, an uplink channel estimation method using the sounding reference signal (SRS) transmission of a UE will be described. A base station may configure at least one SRS configuration for each uplink BWP in order to transfer configuration information for SRS transmission to the UE, and may configure at least one SRS resource set for each SRS configuration. For example, the base station and UE may transmit and receive the following higher signaling information to transfer information on the SRS resource set.
srs-ResourceSetId: an index of SRS resource set
srs-ResourceIdList: SRS resource indexes referenced in SRS resource set
resourceType: A time domain transmission configuration of an SRS resource referenced in the SRS resource set, which may be configured to one of ‘periodic’, ‘semi-persistent’, and ‘aperiodic’. In case of being configured to ‘periodic’ or ‘semi-persistent’, associated CSI-RS information may be provided according to a usage of the SRS resource set. In case of being configured to ‘aperiodic’, an aperiodic SRS resource trigger list and slot offset information may be provided, and associated CSI-RS information may be provided according to a usage of the SRS resource set.
usage: A configuration of a usage of the SRS resource referenced in the SRS resource set, which may be configured to one of ‘beamManagement’, ‘codebook’, ‘nonCodebook’, and ‘antennaSwitching’.
alpha, p0, pathlossReferenceRS, srs-PowerControlAdjustmentStates: A parameter configuration for adjusting transmission power of the SRS resource referenced in the SRS resource set is provided.

The UE may understand that the SRS resource included in SRS resource indexes referenced in the SRS resource set follows information configured in the SRS resource set.

In addition, the base station and UE may transmit and receive higher layer signaling information in order to transfer individual configuration information of an SRS resource. For example, the individual configuration information of the SRS resource may include time-frequency domain mapping information in a slot of the SRS resource, and the time-frequency domain mapping information may include information on frequency hopping between slots or in a slot of the SRS resource. In addition, the individual configuration information of the SRS resource may include a time domain transmission configuration of the SRS resource, and may be configured to one of ‘periodic’, ‘semi-persistent’, and ‘aperiodic’. This may be limited to have the same time domain transmission configuration as an SRS resource set including the SRS resource. In case that the time domain transmission configuration of the SRS resource is configured to ‘periodic’ or ‘semi-persistent’, a transmission period and slot offset of the SRS resource (e.g., periodicityAndOffset) may be additionally included in the time domain transmission configuration.

The base station may activate, deactivate, or trigger SRS transmission to the UE through higher layer signaling including RRC signaling or MAC CE signaling, or L1 signaling (e.g., DCI). For example, the base station may activate or deactivate periodic SRS transmission through higher layer signaling to the UE. The base station may indicate to activate an SRS resource set in which resourceType is configured to periodic through higher layer signaling, and the UE may transmit an SRS resource referenced in the activated SRS resource set. Time-frequency domain resource mapping in a slot of the transmitted SRS resource follows resource mapping information configured in the SRS resource, and slot mapping including a transmission period and slot offset follows periodicity AndOffset configured in the SRS resource. In addition, a spatial domain transmission filter applied to the transmitted SRS resource may refer to spatial relation info configured in the SRS resource, or may refer to associated CSI-RS information configured in the SRS resource set including the SRS resource. The UE may transmit the SRS resource in an activated uplink BWP for the activated periodic SRS resource through higher layer signaling.

For example, the base station may activate or deactivate semi-persistent SRS transmission through higher layer signaling to the UE. The base station may indicate to activate an SRS resource set through MAC CE signaling, and the UE may transmit an SRS resource referenced in the activated SRS resource set. The SRS resource set activated through MAC CE signaling may be limited to an SRS resource set in which resourceType is configured to semi-persistent. Time-frequency domain resource mapping in a slot of the transmitted SRS resource follows resource mapping information configured in the SRS resource, and slot mapping including a transmission period and slot offset follows periodicity AndOffset configured in the SRS resource. In addition, a spatial domain transmission filter applied to the transmitted SRS resource may refer to spatial relation info configured in the SRS resource, or may refer to associated CSI-RS information configured in the SRS resource set including the SRS resource. In case that the spatial relation info is configured in the SRS resource, the spatial relation info may not be followed and the spatial domain transmission filter may be determined by with reference to configuration information of the spatial relation info transmitted through MAC CE signaling for activating semi-persistent SRS transmission. The UE may transmit the SRS resource in an activated uplink BWP for the activated semi-persistent SRS resource through higher layer signaling.

For example, the base station may trigger aperiodic SRS transmission through DCI to the UE. The base station may indicate one of aperiodic SRS resource triggers (aperiodicSRS-ResourceTrigger) through an SRS request field of the DCI. The UE may understand that an SRS resource set including the aperiodic SRS resource trigger indicated through the DCI is triggered in an aperiodic SRS resource trigger list, in configuration information of the SRS resource set. The UE may transmit an SRS resource referenced in the triggered SRS resource set. Time-frequency domain resource mapping in a slot of the transmitted SRS resource follows resource mapping information configured in the SRS resource. In addition, slot mapping of the transmitted SRS resource may be determined through a slot offset between a PDCCH including the DCI and the SRS resource, and may refer to value(s) included in a slot offset set configured in the SRS resource set. More particularly, the slot offset between the PDCCH including the DCI and the SRS resource may apply a value indicated in a time domain resource assignment field of the DCI from among offset value(s) included in the slot offset set configured in the SRS resource set. In addition, a spatial domain transmission filter applied to the transmitted SRS resource may refer to spatial relation info configured in the SRS resource, or may refer to associated CSI-RS information configured in the SRS resource set including the SRS resource. The UE may transmit the SRS resource in an activated uplink BWP for the aperiodic SRS resource triggered through the DCI.

In case that the base station triggers aperiodic SRS transmission through DCI to the UE, in order to transmit an SRS by applying configuration information of an SRS resource, the UE may need a minimum time interval between a PDCCH including the DCI for triggering aperiodic SRS transmission and the transmitted SRS. A time interval for SRS transmission of the UE may be defined as the number of symbols between a last symbol of the PDCCH including the DCI for triggering aperiodic SRS transmission and a first symbol to which a first transmitted SRS resource from among transmitted SRS resource(s) is mapped. The minimum time interval may be determined by with reference to a PUSCH preparation procedure time required for the UE to prepare PUSCH transmission. In addition, the minimum time interval may vary according to a usage of a SRS resource set including the transmitted SRS resource. For example, the minimum time interval may be determined to be N2 symbols defined by considering UE processing capability according to UE capability by with reference to the PUSCH preparation procedure time of the UE. In addition, in case that the usage of the SRS resource set is configured to ‘codebook’ or ‘antennaSwitching’ by considering the usage of the SRS resource set including the transmitted SRS resource, the minimum time interval may be determined to be N2 symbols, and in case that the usage of the SRS resource set is configured to ‘nonCodebook’ or ‘beamManagement’, the minimum time interval may be determined to be N2+14 symbols. In case that the time interval for SRS transmission is equal to or greater than the minimum time interval, the UE may transmit the aperiodic SRS, and in case that the time interval for SRS transmission is less than the minimum time interval, the UE may ignore the DCI for triggering the aperiodic SRS.

TABLE 24

| | |
|---|---|
| SRS-Resource ::= | SEQUENCE { |
| srs-ResourceId | SRS-ResourceId, |
| nrofSRS-Ports | ENUMERATED {port1, ports2, ports4}, |
| ptrs-PortIndex | ENUMERATED {n0, n1 } |

OPTIONAL, -- Need R

| | |
|---|---|
| transmissionComb | CHOICE { |
| n2 | SEQUENCE { |
| combOffset-n2 | INTEGER (0..1), |
| cyclicShift-n2 | INTEGER (0..7) |

},

| | |
|---|---|
| n4 | SEQUENCE { |
| combOffset-n4 | INTEGER (0..3), |
| cyclicShift-n4 | INTEGER (0..11) |

```
    }
  },
```

| | |
|---|---|
| resourceMapping | SEQUENCE { |
| startPosition | INTEGER (0..5), |
| nrofSymbols | ENUMERATED {n1, n2, n4}, |
| repetitionFactor | ENUMERATED {n1, n2, n4} |

},

| | |
|---|---|
| freqDomainPosition | INTEGER (0..67), |
| freqDomainShift | INTEGER (0..268), |
| freqHopping | SEQUENCE { |
| c-SRS | INTEGER (0..63), |
| b-SRS | INTEGER (0..3), |
| b-hop | INTEGER (0..3) |

},

| | |
|---|---|
| groupOrSequenceHopping | ENUMERATED { neither, |

groupHopping, sequenceHopping },

| | |
|---|---|
| resourceType | CHOICE { |
| aperiodic | SEQUENCE { |

```
      ...
    },
```

| | |
|---|---|
| semi-persistent | SEQUENCE { |
| periodicityAndOffset-sp | SRS-PeriodicityAndOffset, |

```
      ...
    },
```

| | |
|---|---|
| periodic | SEQUENCE { |
| periodicityAndOffset-p | SRS-PeriodicityAndOffset, |

```
      ...
    }
  },
```

| | |
|---|---|
| sequenceId | INTEGER (0..1023), |
| spatialRelationInfo | SRS-SpatialRelationInfo |

OPTIONAL, -- Need R
...
}

The spatialRelationInfo configuration information of Table 27 above applies beam information of the corresponding reference signal to a beam used for the corresponding SRS transmission with reference to one reference signal. For example, the configuration of spatialRelationInfo may, include information of Table 28.

TABLE 25

| | |
|---|---|
| SRS-SpatialRelationInfo ::= | SEQUENCE |
| servingCellId | ServCellIndex OPTIONAL, -- Need |

S

| | |
|---|---|
| referenceSignal | CHOICE { |
| ssb-Index | SSB-Index, |
| csi-RS-Index | NZP-CSI-RS-ResourceId, |
| srs | SEQUENCE { |
| resourceId | SRS-ResourceId, |
| uplinkBWP | BWP-Id |

```
    }
  }
}
```

With reference to the spatialRelationInfo configuration, in order to use beam information of a specific reference signal, the base station may configure an SS/PBCH block index, CSI-RS index, or SRS index as an index of a reference signal to be referenced. The higher signaling referenceSignal is configuration information indicating which reference signal beam information is to be referenced for the corresponding SRS transmission, an ssb-Index refers to an index of the SS/PBCH block, a csi-RS-Index refers to an index of the CSI-RS, and srs refers to an index of the SRS, respectively. If a value of the higher signaling referenceSignal is configured to an ‘ssb-Index’, the UE may apply a reception beam used upon receiving the SS/PBCH block corresponding to the ssb-Index as a transmission beam of the corresponding SRS transmission. If a value of the higher signaling referenceSignal is configured to a ‘csi-RS-Index’, the UE may apply a reception beam used upon receiving the CSI-RS corresponding to the csi-RS-Index as a transmission beam of the corresponding SRS transmission. If a value of the higher signaling referenceSignal is configured to ‘srs’, the UE may apply a transmission beam used upon transmitting the SRS corresponding to srs as a transmission beam for transmission of the corresponding SRS.

### SRS: Antenna Switching

Hereinafter, an SRS for antenna switching will be described.

An SRS transmitted from a UE may be used by a base station to acquire DL channel state information (CSI) (for example, DL CSI acquisition). As a specific example, in a single cell or multi cell (for example, carrier aggregation (CA)) situation based on time division duplex (TDD), a base station (BS) may schedule transmission of an SRS to user equipment (UE) and then measure the SRS transmitted from the UE. In this case, by assuming reciprocity between the downlink (DL) and the uplink (UL) channels, the base station may consider that uplink channel information estimated based on the SRS transmitted from the UE is downlink channel information, and may perform scheduling of downlink signal/channel for the UE by using this. In this case, the usage of the SRS for downlink channel information acquisition may be configured for the UE as antenna switching by the base station.

As an example, according to specifications (for example, 3gpp TS38.214), the usage of an SRS may be configured for the base station and/or UE by using a higher layer parameter (for example, usage of RRC parameter SRS-ResourceSet). Here, the usage of an SRS may be configured as beam management usage, codebook transmission usage, non-codebook transmission usage, antenna switching usage, and the like.

As described, in case that parameter usage inside higher layer signaling SRS-ResourceSet is configured by the base station as ‘antennaSwitcing’ for the UE, the UE may receive at least one higher layer signaling configuration from the base station according to reported UE capability. In this case, the UE may report ‘supportedSRS-TxPortSwitch’ as UE capability, and its value may be as follows. In the following, ‘mTnR’ may mean UE capability supporting transmission through m antennas and reception through n antennas.
‘t1r2’: A UE capability report value meaning that the UE is capable of 1T2R operation.
‘t1r1-t1r2’: A UE capability report value meaning that the UE is capable of 1T1R or 1T2R operation.
‘t2r4’: A UE capability report value meaning that the UE is capable of 2T4R operation.
‘t1r4’: A UE capability report value meaning that the UE is capable of 1T4R operation.
‘t1r6’: A UE capability report value meaning that the UE is capable of 1T6R operation.
‘t1r8’: A UE capability report value meaning that the UE is capable of 1T8R operation.
‘t2r6’: A UE capability report value meaning that the UE is capable of 2T6R operation.
‘t2r8’: A UE capability report value meaning that the UE is capable of 2T8R operation.
‘t4r8’: A UE capability report value meaning that the UE is capable of 4T8R operation.
‘t1r1-t1r2-t1r4’: A UE capability report value meaning that the UE is capable of 1T1R, 1T2R, or 1T4R operation.
‘t1r4-t2r4’: A UE capability report value meaning that the UE is capable of 1T4R or 2T4R operation.
‘t1r1-t1r2-t2r2-t2r4’: A UE capability report value meaning that the UE is capable of 1T1R, 1T2R, 2T2R, or 2T4R operation.
‘t1r1-t1r2-t2r2-t1r4-t2r4’: A UE capability report value meaning that the UE is capable of 1T1R, 1T2R, 2T2R, 1T4R, or 2T4R operation.
‘t1r1’: A UE capability report value meaning that the UE is capable of 1T1R operation.
‘t2r2’: A UE capability report value meaning that the UE is capable of
2T2R operation.
‘t1r1-t2r2’: A UE capability report value meaning that the UE is capable
of 1T1R or 2T2R operation.
‘t4r4’: A UE capability report value meaning that the UE is capable of
4T4R operation.
‘t1r1-t2r2-t4r4’: A UE capability report value meaning that the UE is
capable of 1T1R, 2T2R, or 4T4R operation.

### [1T2R]

Regarding the UE's 1T2R operation, higher layer signaling from the base station regarding a combination of at least one of the following details may be configured, and an operation based thereon may be possible.

In case that the UE reported some or all of srs-AntennaSwitching2SP-1Periodic-r17 and srs-ExtensionAperiodicSRS-r17 which are UE capability reports

In case that the UE reported only srs-AntennaSwitching2SP-1Periodic-r17,

The base station may configure, for the UE, a maximum of two SRS resource sets having resourceType value of ‘semi-persistent’ in SRS-ResourceSet that is higher layer signaling, and the base station may configure, for the UE, a maximum of one SRS resource set having resource Type value of ‘periodic’ in SRS-ResourceSet that is higher layer signaling, or

The base station may configure, for the UE, a maximum of two SRS resource sets having different values of resourceType in SRS-ResourceSet that is higher layer signaling.

Regarding the above details, two SRS resource sets having resourceType value of ‘semi-persistent’ in SRS-ResourceSet that is higher layer signaling may not be activated simultaneously.

Regarding the above details, each SRS resource set may include two SRS resources transmitted in different OFDM symbols.

Regarding the above details, each SRS resource in each SRS resource set may be constituted with one SRS port, and the SRS ports of respective SRS resources in each SRS resource set may be connected to different UE antenna ports.

As an example, first and second SRS resources, each being constituted one SRS port, may be included in the corresponding SRS resource set, respective SRS ports of the first and second SRS resources may be connected to different UE antenna ports, the SRS port of the first SRS resource may be transmitted at a first OFDM symbol location, and the SRS port of the second SRS resource may be transmitted at a second OFDM symbol location. In this case, the first and second OFDM symbol locations are different from each other, but slot locations may be equal to or different from each other.

In case that the UE reported only srs-ExtensionAperiodicSRS-r17,

The base station may configure, for the UE, a maximum of two SRS resource sets having resource Type value of ‘aperiodic’ in SRS-ResourceSet that is higher layer signaling, and the base station may configure, for the UE, a maximum of one SRS resource set having resource Type value of ‘periodic’ or ‘semi-persistent’ in SRS-ResourceSet that is higher layer signaling, or

The base station may configure, for the UE, a maximum of two SRS resource sets having different values of resourceType in SRS-ResourceSet that is higher layer signaling.

Regarding the above details, in case that the base station configured, for the UE, two SRS resource sets having resourceType value of ‘aperiodic’ in SRS-ResourceSet that is higher layer signaling, respective SRS resources in the two SRS resource sets may be transmitted at identical or different OFDM symbol locations in two different slots, each SRS resource set may include one SRS resource, each SRS resource in the two SRS resource sets may be constituted with one SRS port, and the SRS ports of respective SRS resources in the two SRS resource sets may be connected to different UE antenna ports.

As an example, a first SRS resource constituted with one SRS port may be included in the first SRS resource set, a second SRS resource constituted with one SRS port may be included in the second SRS resource set, respective SRS ports of the first and second SRS resources may be connected to different UE antenna ports, the SRS port of the first SRS resource may be transmitted at a first OFDM symbol location of the first slot, and the SRS port of the second SRS resource may be transmitted at a second OFDM symbol location of the second slot. In this case, the first and second OFDM symbol locations may be identical to or different from each other in each slot, but slot locations may be different from each other.

Regarding the above details, in case that the base station configured, for the UE, one SRS resource set having resourceType value of ‘aperiodic’ in SRS-ResourceSet that is higher layer signaling, two SRS resources in the corresponding SRS resource set may be transmitted at different OFDM symbol locations in the same slot, each SRS resource in the corresponding SRS resource set may be constituted with one SRS port, and the SRS ports of respective SRS resources may be connected to different UE antenna ports.

As an example, first and second SRS resources, each being constituted with one SRS port, may be included in the corresponding SRS resource set, respective SRS ports of the first and second SRS resources may be connected to different UE antenna ports, the SRS port of the first SRS resource may be transmitted at a first OFDM symbol location in the first slot, and the SRS port of the second SRS resource may be transmitted at a second OFDM symbol location in the same slot.

Regarding the above details, in case that the base station configured, for the UE, one SRS resource set having resourceType value of ‘periodic or ‘semi-persistent’ in SRS-ResourceSet that is higher layer signaling, two SRS resources in the corresponding SRS resource set may be transmitted at different OFDM symbol location, each SRS resource in the corresponding SRS resource set may be constituted with one SRS port, and the SRS ports of respective SRS resources may be connected to different UE antenna ports.

As an example, first and second SRS resources, each being constituted with one SRS port, may be included in the corresponding SRS resource set, respective SRS ports of the first and second SRS resources may be connected to different UE antenna ports, the SRS port of the first SRS resource may be transmitted at a first OFDM symbol location in the first slot, and the SRS port of the second SRS resource may be transmitted at a second OFDM symbol location in the same slot.

In case that the UE did not report srs-AntennaSwitching2SP-1Periodic-r17, the base station may configure, for the UE, a maximum of two (for example, 0, 1, or 2) SRS resource sets having resourceType values which are ‘periodic’ or ‘semi-persistent,’ and which are different from each other, in SRS-ResourceSet that is higher layer signaling. As an example, the base station may configure one of the following details for the UE.

No configured SRS resource set having resourceType value of ‘periodic’ or ‘semi-persistent’ in SRS-ResourceSet that is higher layer signaling

One SRS resource set having resourceType value of ‘periodic’ in SRS-ResourceSet that is higher layer signaling

One SRS resource set having resourceType value of ‘semi-persistent’ in SRS-ResourceSet that is higher layer signaling

One SRS resource set having resourceType value of ‘periodic’ in SRS-ResourceSet that is higher layer signaling, and one SRS resource set having resourceType value of ‘semi-persistent’ therein

Regarding the above details, two SRS resource sets having resourceType value of ‘semi-persistent’ in SRS-ResourceSet that is higher layer signaling may not be activated simultaneously.

Regarding the above details, each SRS resource set may include two SRS resources, the two SRS resources may be transmitted at different OFDM symbol locations, each SRS resource in the corresponding SRS resource set may be constituted with one SRS port, and the SRS ports of respective SRS resources may be connected to different UE antenna ports.

As an example, first and second SRS resources, each being constituted with one SRS port, may be included in the corresponding SRS resource set, respective SRS ports of the first and second SRS resources may be connected to different UE antenna ports, the SRS port of the first SRS resource may be transmitted at a first OFDM symbol location in the first slot, and the SRS port of the second SRS resource may be transmitted at a second OFDM symbol location in the same slot.

In case that the UE reported srs-AntennaSwitching2SP-1Periodic-r17, the base station may configure, for the UE, a maximum of two SRS resource sets having resourceType value of ‘semi-persistent’ in SRS-ResourceSet that is higher layer signaling, and the base station may configure, for the UE, a maximum of one SRS resource set having resourceType value of ‘periodic’ in SRS-ResourceSet that is higher layer signaling.

Regarding the above details, two SRS resource sets having resourceType value of ‘semi-persistent’ in SRS-ResourceSet that is higher layer signaling may not be activated simultaneously.

Regarding the above details, each SRS resource set may include two SRS resources, the corresponding two SRS resources may be transmitted at different OFDM symbol locations, each SRS resource in the corresponding SRS resource set may be constituted with one SRS port, and the SRS ports of respective SRS resources may be connected to different UE antenna ports.

As an example, first and second SRS resources, each being constituted with one SRS port, may be included in the corresponding SRS resource set, respective SRS ports of the first and second SRS resources may be connected to different UE antenna ports, the SRS port of the first SRS resource may be transmitted at a first OFDM symbol location, and the SRS port of the second SRS resource may be transmitted at a second OFDM symbol location. In this case, the first and second OFDM symbol locations are different from each other, but slot locations may be equal to or different from each other.

In case that the UE did not report srs-ExtensionAperiodicSRS-r17 only, the base station may configure, for the UE, a maximum of one (for example, 0 or 1) SRS resource set having resourceType value of ‘aperiodic’ in SRS-ResourceSet that is higher layer signaling. As an example, the base station may configure one of the following details for the UE.

No configured SRS resource set having resource Type value of ‘aperiodic’ in SRS-ResourceSet that is higher layer signaling

One SRS resource set having resourceType value of ‘aperiodic’ in SRS-ResourceSet that is higher layer signaling

Regarding the above details, in case that one SRS resource set is configured, each SRS resource set may include two SRS resources, the corresponding two SRS resources may be transmitted at different OFDM symbol locations in the same slot, each SRS resource in the corresponding SRS resource set may be constituted with one SRS port, and the SRS ports of respective SRS resource may be connected to different UE antenna ports.

As an example, first and second SRS resources, each being constituted with one SRS port, may be included in the corresponding SRS resource set, respective SRS ports of the first and second SRS resources may be connected to different UE antenna ports, the SRS port of the first SRS resource may be transmitted at a first OFDM symbol location in the first slot, and the SRS port of the second SRS resource may be transmitted at a second OFDM symbol location in the same slot.

In case that the UE reported srs-ExtensionAperiodicSRS-r17 only, the base station may configure, for the UE, a maximum of two (for example, 0, 1, or 2) SRS resource set having resourceType value of ‘aperiodic’ in SRS-ResourceSet that is higher layer signaling. As an example, the base station may configure one of the following details for the UE.

No configured SRS resource set having resourceType value of ‘aperiodic’ in SRS-ResourceSet that is higher layer signaling

One SRS resource set having resourceType value of ‘aperiodic’ in SRS-ResourceSet that is higher layer signaling

Two SRS resource sets having resource Type value of ‘aperiodic’ in SRS-ResourceSet that is higher layer signaling

Regarding the above details, in case that one SRS resource set is configured, each SRS resource set may include two SRS resources, the corresponding two SRS resources may be transmitted at different OFDM symbol locations in the same slot, each SRS resource in the corresponding SRS resource set may include one SRS port, and the SRS ports of respective SRS resources may be connected to different UE antenna ports.

As an example, first and second SRS resources, each being constituted with one SRS port may be included in the corresponding SRS resource set, respective SRS ports of the first and second SRS resources may be connected to different UE antenna ports, the SRS port of the first SRS resource may be transmitted at a first OFDM symbol location in the first slot, and the SRS port of the second SRS resource may be transmitted at a second OFDM symbol location in the same slot.

Regarding the above details, in case that two SRS resource sets are configured, respective SRS resources in the two SRS resource sets may be transmitted at identical or different OFDM symbol locations in two different slots, each SRS resource set may include one SRS resource, each SRS resource in the two SRS resource sets may be constituted with one SRS port, and the SRS ports of respective SRS resources in the two SRS resource sets may be connected to different UE antenna ports.

As an example, a first SRS resource constituted with one SRS port may be included in the first SRS resource set, a second SRS resource constituted with one SRS port may be included in the second SRS resource set, respective ports of the first and second SRS resources may be connected to different UE antenna ports, the SRS port of the first SRS resource may be transmitted at a first OFDM symbol location of the first slot, and the SRS port of the second SRS resource may be transmitted at a second OFDM symbol location of the second slot. In this case, the first and second OFDM symbol locations may be identical to or different from each other in respective slots, but the slot locations may be different from each other.

In case that the UE did not report both srs-AntennaSwitching2SP-1Periodic-r17 and srs-ExtensionAperiodicSRS-r17 which are UE capability reports

The base station may configure, for the UE, a maximum of two SRS resource set having different resource Type values in SRS-ResourceSet that is higher layer signaling.

Regarding the above details, each SRS resource set may include two SRS resources, the corresponding two SRS resources may be transmitted at different OFDM symbol locations, each SRS resource in the corresponding SRS resource set may be constituted with one SRS port, and the SRS ports of the respective SRS resources may be connected to different UE antenna ports.

As an example, first and second SRS resources, each being constituted with one SRS port, may be included in the corresponding SRS resource set, respective SRS ports of the first and second SRS resources may be connected to different UE antenna ports, the SRS port of the first SRS resource may be transmitted at a first OFDM symbol location, and the SRS port of the second SRS resource may be transmitted at a second OFDM symbol location. In this case, the first and second OFDM symbol locations may be different from each other, but the slot locations may be identical to or different from each other.

### [2T4R]

Regarding the UE's 2T4R operation, higher layer signaling from the base station regarding a combination of at least one of the following details may be configured, and an operation based thereof may be possible.

In case that the UE reported some or all of srs-AntennaSwitching2SP-1Periodic-r17 and srs-ExtensionAperiodicSRS-r17 which are UE capability reports

In case that the UE reported only srs-AntennaSwitching2SP-1Periodic-r17

The base station may configure, for the UE, a maximum of two SRS resource sets having resourceType value of ‘semi-persistent’ in SRS-ResourceSet that is higher layer signaling, and the base station may configure, for the UE, a maximum of one SRS resource set having resourceType value of ‘periodic’ in SRS-ResourceSet that is higher layer signaling, or

The base station may configure, for the UE, a maximum of two SRS resource sets having different values of resourceType in SRS-ResourceSet that is higher layer signaling.

Regarding the above details, two SRS resource sets having resourceType value of ‘semi-persistent’ in SRS-ResourceSet that is higher layer signaling may not be activated simultaneously.

Regarding the above details, each SRS resource set may include two SRS resources transmitted in different OFDM symbols.

Regarding the above details, each SRS resource in each SRS resource set may be constituted with two SRS ports, and the two SRS ports of each SRS resource in each SRS resource set may be connected to different UE antenna ports.

As an example, first and second SRS resources, each being constituted with one SRS port, may be included in the corresponding SRS resource set, the two SRS ports of the first and second SRS resources may be connected to different UE antenna ports, the two SRS port of the first SRS resource may be transmitted at a first OFDM symbol location, and the two SRS ports of the second SRS resource may be transmitted at a second OFDM symbol location, the first and second OFDM symbol locations may be different from each other in each slot, but may have identical or different slot locations.

In case that the UE reported only srs-ExtensionAperiodicSRS-r17,

The base station may configure, for the UE, a maximum of two SRS resource sets having resourceType value of ‘aperiodic’ in SRS-ResourceSet that is higher layer signaling, and the base station may configure, for the UE, a maximum of one SRS resource set having resourceType value of ‘periodic’ or ‘semi-persistent’ in SRS-ResourceSet that is higher layer signaling, or

The base station may configure, for the UE, a maximum of two SRS resource sets having different values of resourceType in SRS-ResourceSet that is higher layer signaling.

Regarding the above details, in case that the base station configured, for the UE, two SRS resource sets having resourceType value of ‘aperiodic’ in SRS-ResourceSet that is higher layer signaling, respective SRS resources in the two SRS resource sets may be transmitted at identical or different OFDM symbol locations in two different slots, each SRS resource set may include one SRS resource, respective SRS resources in the two SRS resource sets may be constituted with two SRS ports, and the two SRS ports of respective SRS resources in the two SRS resource sets may be connected to different UE antenna ports.

As an example, a first SRS resource constituted with two SRS ports may be included in the first SRS resource set, a second SRS resource constituted with two SRS ports may be included in the second SRS resource set, the two SRS ports of the first and second SRS resources may be connected to different UE antenna ports, the two SRS ports of the first SRS resource may be transmitted at a first OFDM symbol location of the first slot, and the two SRS ports of the second SRS resource may be transmitted at a second OFDM symbol location of the second slot. In this case, the first and second OFDM symbol locations may be identical to or different from each other in each slot, but slot locations may be different from each other.

Regarding the above details, in case that the base station configured, for the UE, one SRS resource set having resourceType value of ‘aperiodic’ in SRS-ResourceSet that is higher layer signaling, two SRS resources in the corresponding SRS resource set may be transmitted at different OFDM symbol locations in the same slot, each SRS resource in the corresponding SRS resource set may be constituted with two SRS ports, and the SRS ports of respective SRS resources may be connected to different UE antenna ports.

Regarding the above details, in case that the base station configured, for the UE, one SRS resource set having resourceType value of ‘periodic’ or ‘semi-persistent’ in SRS-ResourceSet that is higher layer signaling, two SRS resources in the corresponding SRS resource set may be transmitted at different OFDM symbol locations, each SRS resource in the corresponding SRS resource set may be constituted with two SRS ports, and the two SRS ports of respective SRS resources may be connected to different UE antenna ports.

As an example, first and second SRS resources, each being constituted with two SRS ports, may be included in the corresponding SRS resource set, the two SRS ports of the first and second SRS resources may be connected to different UE antenna ports, the two SRS ports of the first SRS resource may be transmitted at a first OFDM symbol location, and the two SRS ports of the second SRS resource may be transmitted at a second OFDM symbol location. In this case, the first and second OFDM symbol locations may be different from each other, but the slot locations may be identical to or different from each other.

In case that the UE did not report srs-AntennaSwitching2SP-1Periodic-r17, the base station may configure, for the UE, a maximum of two (for example, 0, 1, or 2) SRS resource sets having resourceType values that are ‘periodic’ or ‘semi-persistent,’ and that are different from each other, in SRS-ResourceSet that is higher layer signaling. As an example, the base station may configure one of the following details for the UE.

No configured SRS resource set having resourceType value of ‘periodic’ or ‘semi-persistent’ in SRS-ResourceSet that is higher layer signaling

One SRS resource set having resourceType value of ‘periodic’ in SRS-ResourceSet that is higher layer signaling.

One SRS resource set having resourceType value of ‘semi-persistent’ in SRS-ResourceSet that is higher layer signaling.

One SRS resource set having resourceType value of ‘periodic’ in SRS-ResourceSet that is higher layer signaling, and one SRS resource set having resourceType value of ‘semi-persistent’ therein

Regarding the above details, two SRS resource sets having resourceType value of ‘semi-persistent’ in SRS-ResourceSet that is higher layer signaling may not be activated simultaneously.

Regarding the above details, each SRS resource set may include two SRS resources, the corresponding two SRS resources may be transmitted at different OFDM symbol locations, each SRS resource in the corresponding SRS resource set may be constituted with two SRS ports, and the two SRS ports of respective SRS resources may be connected to different UE antenna ports.

As an example, first and second SRS resources, each being constituted with two SRS ports, may be included in the corresponding SRS resource set, the two SRS ports of the first and second SRS resources may be connected to different UE antenna ports, the two SRS ports of the first SRS resource may be transmitted at a first OFDM symbol location, and the two SRS ports of the second SRS resource may be transmitted at a second OFDM symbol location. In this case, the first and second OFDM symbol locations may be different from each other, but the slot locations may be identical to or different from each other.

In the case that the UE reported srs-AntennaSwitching2SP-1Periodic-r17, the base station may configure, for the UE, a maximum of two SRS resource sets having resourceType value of ‘semi-persistent’ in SRS-ResourceSet that is higher layer signaling, and the base station may configure, for the UE, a maximum of one SRS resource set having resourceType value of ‘periodic’ in SRS-ResourceSet that is higher layer signaling.

Regarding the above details, two SRS resource sets having resourceType value of ‘semi-persistent’ in SRS-ResourceSet that is higher layer signaling may not be activated simultaneously.

Regarding the above details, each SRS resource set may include two SRS resources, the corresponding two SRS resources may be transmitted at different OFDM symbol locations, each SRS resource in the corresponding SRS resource set may be constituted with two SRS ports, and the two SRS ports of respective SRS resources may be connected to different UE antenna ports.

As an example, first and second SRS resources, each being constituted with two SRS ports, may be included in the corresponding SRS resource set, the two SRS ports of the first and second SRS resources may be connected to different UE antenna ports, the two SRS ports of the first SRS resource may be transmitted at a first OFDM symbol location, and the two SRS ports of the second SRS resource may be transmitted at a second OFDM symbol location. In this case, the first and second OFDM symbol locations may be different from each other, but slot locations may be identical to or different from each other.

In case that the UE did not report srs-ExtensionAperiodicSRS-r17, the base station may configure, for the UE, a maximum of one (for example, 0 or 1) SRS resource set having resourceType value of ‘aperiodic’ in SRS-ResourceSet that is higher layer signaling. As an example, the base station may configure one of the following details for the UE.

No configured SRS resource set having resourceType value of ‘aperiodic’ in SRS-ResourceSet that is higher layer signaling

One SRS resource set having resourceType value of ‘aperiodic’ in SRS-ResourceSet that is higher layer signaling

Regarding the above details, in case that one SRS resource set is configured, each SRS resource set may include two SRS resources, the corresponding two SRS resources may be transmitted at different OFDM symbol locations in the same slot, each SRS resource in the corresponding SRS resource set may be constituted with two SRS ports, and the two SRS ports of respective SRS resources may be connected to different UE antenna ports.

As an example, first and second SRS resources, each being constituted with two SRS ports, may be included in the corresponding SRS resource set, the two SRS ports of the first and second SRS resources may be connected to different UE antenna ports, the two SRS ports of the first SRS resource may be transmitted at a first OFDM symbol location in the first slot, and the two SRS ports of the second SRS resource may be transmitted at a second OFDM symbol location in the same slot.

In case that the UE reported srs-ExtensionAperiodicSRS-r17, the base station may configure, for the UE, a maximum of two (for example, 0, 1, or 2) SRS resource set having resourceType value of ‘aperiodic’ in SRS-ResourceSet that is higher layer signaling. As an example, the base station may configure one of the following details for the UE.

No configured SRS resource set having resourceType value of ‘aperiodic’ in SRS-ResourceSet that is higher layer signaling

One SRS resource set having resourceType value of ‘aperiodic’ in SRS-ResourceSet that is higher layer signaling

Two SRS resource sets having resource Type value of ‘aperiodic’ in SRS-ResourceSet that is higher layer signaling

Regarding the above details, in case that one SRS resource set is configured, each SRS resource set may include two SRS resources, the corresponding two SRS resources may be transmitted at different OFDM symbol locations in the same slot, each SRS resource in the corresponding SRS resource set may be constituted with two SRS ports, and the two SRS ports of respective SRS resources may be connected to different UE antenna ports.

As an example, first and second SRS resources, each being constituted with two SRS ports, may be included in the corresponding SRS resource set, the two SRS ports of the first and second SRS resources may be connected to different UE antenna ports, the two SRS ports of the first SRS resource may be transmitted at a first OFDM symbol location in the first slot, and the two SRS ports of the second SRS resource may be transmitted at a second OFDM symbol location in the same slot.

Regarding the above details, in case that two SRS resource sets are configured, respective SRS resources in the two SRS resource sets may be transmitted at identical or different OFDM symbol locations in two different slots, each SRS resource set may include one SRS resource, respective SRS resources in the two SRS resource sets may be constituted with two SRS ports, and the two SRS ports of respective SRS resources in the two SRS resource sets may be connected to different UE antenna ports.

As an example, a first SRS resource constituted with two SRS ports may be included in the first SRS resource set, a second SRS resource constituted with two SRS ports may be included in the second SRS resource set, the two SRS ports of the first and second SRS resources may be connected to different UE antenna ports, the two SRS ports of the first SRS resource may be transmitted at a first OFDM symbol location of the first slot, and the two SRS ports of the second SRS resource may be transmitted at a second OFDM symbol location of the second slot. In this case, the first and second OFDM symbol locations may be identical to or different from each other in respective slots, but the slot locations may be different from each other.

In case that the UE did not report both srs-AntennaSwitching2SP-1Periodic-r17 and srs-ExtensionAperiodicSRS-r17 which are UE capability reports

The base station may configure, for the UE, a maximum of two SRS resource set having different resourceType values in SRS-ResourceSet that is higher layer signaling.

Regarding the above details, each SRS resource set may include two SRS resources, the corresponding two SRS resources may be transmitted at different OFDM symbol locations, each SRS resource in the corresponding SRS resource set may be constituted with two SRS ports, and the two SRS ports of the respective SRS resources may be connected to different UE antenna ports.

As an example, first and second SRS resources, each being constituted with two SRS ports, may be included in the corresponding SRS resource set, the two SRS ports of the first and second SRS resources may be connected to different UE antenna ports, the two SRS ports of the first SRS resource may be transmitted at a first OFDM symbol location, and the two SRS ports of the second SRS resource may be transmitted at a second OFDM symbol location. In this case, the first and second OFDM symbol locations may be different from each other, but the slot locations may be identical to or different from each other.

### [1T4R]

Regarding the UE's 1T4R operation, higher layer signaling from the base station regarding a combination of at least one of the following details may be configured, and an operation based thereof may be possible.

In case that the UE reported some or all of srs-AntennaSwitching2SP-1Periodic-r17, srs-ExtensionAperiodicSRS-r17, and srs-OneAP-SRS-r17, which are UE capability reports

In case that the UE did not report srs-AntennaSwitching2SP-1Periodic-r17, the base station may configure, for the UE, a maximum of one (for example, 0 or 1) SRS resource set having resourceType value of ‘periodic’ or ‘semi-persistent’ in SRS-ResourceSet that is higher layer signaling. As an example, the base station may configure one of the following details for the UE.

No configured SRS resource set having resourceType value of ‘periodic’ or ‘semi-persistent’ in SRS-ResourceSet that is higher layer signaling.

One SRS resource set having resourceType value of ‘periodic’ in SRS-ResourceSet that is higher layer signaling.

One SRS resource set having resourceType value of ‘semi-persistent’ in SRS-ResourceSet that is higher layer signaling

Regarding the above details, each SRS resource set may include four SRS resources, the corresponding four SRS resources may be transmitted at different OFDM symbol locations, each SRS resource in the corresponding SRS resource set may be constituted with one SRS port, and the one SRS port of respective SRS resources may be connected to different UE antenna ports.

As an example, first to fourth SRS resources, each being constituted with one SRS port, may be included in the corresponding SRS resource set, the one SRS port of the first to fourth SRS resources may be connected to different UE antenna ports, the one SRS port of the first to fourth SRS resources may be transmitted at first to fourth OFDM symbol locations, and the first to fourth OFDM symbol locations may be different from each other, but the slot locations may be identical to or different from each other.

In case that the UE reported srs-AntennaSwitching2SP-1Periodic-r17, the base station may configure, for the UE, a maximum of two SRS resource sets having resourceType value of ‘semi-persistent’ in SRS-ResourceSet that is higher layer signaling, and the base station may configure, for the UE, a maximum of one SRS resource set having resourceType value of ‘periodic’ in SRS-ResourceSet that is higher layer signaling.

Regarding the above details, two SRS resource sets having resourceType value of ‘semi-persistent’ in SRS-ResourceSet that is higher layer signaling may not be activated simultaneously.

Regarding the above details, each SRS resource set may include four SRS resources, the corresponding four SRS resources may be transmitted at different OFDM symbol locations, each SRS resource in the corresponding SRS resource set may be constituted with one SRS port, and the one SRS port of respective SRS resources may be connected to different UE antenna ports.

As an example, first to fourth SRS resources, each being constituted with one SRS port, may be included in the corresponding SRS resource set, the one SRS port of the first to fourth SRS resources may be connected to different UE antenna ports, the one SRS port of the first to fourth SRS resources may be transmitted at first to fourth OFDM symbol locations, and first to fourth OFDM symbol locations may be different from each other, but slot locations may be identical to or different from each other.

According to which is reported by the UE between srs-ExtensionAperiodicSRS-r17 and srs-OneAP-SRS-r17 that are UE capability reports, the base station's higher layer signaling configuration and the UE's operation may be expected as follow.

In case that the UE did not report both srs-ExtensionAperiodicSRS-r17 and srs-OneAP-SRS-r17, the base station may configure, for the UE, 0 or 2 SRS resource sets having resourceType value of ‘aperiodic’ in SRS-ResourceSet that is higher layer signaling.

In case that the UE reported both srs-ExtensionAperiodicSRS-r17 and srs-OneAP-SRS-r17, the base station may configure, for the UE, 0, 1, 2, or 4 SRS resource sets having resourceType value of ‘aperiodic’ in SRS-ResourceSet that is higher layer signaling.

In case that the UE reported only srs-ExtensionAperiodicSRS-r17 among srs-ExtensionAperiodicSRS-r17 and srs-OneAP-SRS-r17, the base station may configure, for the UE, 0, 2, or 4 SRS resource sets having resourceType value of ‘aperiodic’ in SRS-ResourceSet that is higher layer signaling.

In case that the UE reported only srs-OneAP-SRS-r17 among srs-ExtensionAperiodicSRS-r17 and srs-OneAP-SRS-r17, the base station may configure, for the UE, 0, 1, or 2 SRS resource sets having resourceType value of ‘aperiodic’ in SRS-ResourceSet that is higher layer signaling

Regarding the above details, in case that one SRS resource set is configured, each SRS resource set may include four SRS resources, the corresponding four SRS resources may be transmitted at different OFDM symbol locations in the same slot, each SRS resource in the corresponding SRS resource set may be constituted with one SRS port, and the one SRS port of respective SRS resources may be connected to different UE antenna ports.

As an example, first to fourth SRS resources, each being constituted with one SRS port, may be included in the corresponding SRS resource set, the one SRS port of the first to fourth SRS resources may be connected to different UE antenna ports, the one SRS port of the first to fourth SRS resources may be transmitted at first to fourth OFDM symbol locations in the same slot, and the first to fourth OFDM symbol locations may be different from each other.

Regarding the above details, in case that two SRS resource sets are configured,

Each SRS resource set may include two SRS resources, or the first SRS resource set may include one SRS resource, and the second SRS resource set may include three SRS resources.

Respective SRS resources in each SRS resource set may be transmitted at different OFDM symbol locations in the same slot, and SRS transmission regarding respective SRS resource sets may be performed in different slots. During SRS transmission between different SRS resources of different SRS resource sets, the same may be transmitted at identical or different OFDM symbol locations, but the slot locations may differ.

Respective SRS resource may be constituted with one SRS port, and the one SRS port of respective SRS resources may be connected to different UE antenna ports.

As an example, first and second SRS resources, each being constituted with one SRS port, may be included in the first SRS resource set, and third and fourth SRS resources, each being constituted with one SRS port, may be included in the second SRS resource set. The one SRS port of the first to fourth SRS resources may be connected to different UE antenna ports. The one SRS port of each of the first and second SRS resources may be transmitted at first and second OFDM symbol locations in the same certain slot, and the first and second OFDM symbol locations may be different from each other. The one SRS port of each of the third and fourth SRS resources may be transmitted at third and fourth OFDM symbol locations in a slot different from the slot in which the first and second SRS resources are transmitted, and the third and fourth OFDM symbol locations may be different from each other. In this case, the first OFDM symbol location may be identical to or different from the third and fourth OFDM symbol locations, and the second OFDM symbol location may be similarly identical to or different from the third and fourth OFDM symbol locations.

As another example, a first SRS resource constituted with one SRS port may be included in the first SRS resource set, and second to fourth SRS resources, each being constituted with one SRS port, may be included in the second SRS resource set. The one SRS port of the first to fourth SRS resources may be connected to different UE antenna ports. The one SRS port of the first SRS resource may be transmitted at a first OFDM symbol location in a certain slot. The one SRS port of each of the second to fourth SRS resources may be transmitted at second to fourth OFDM symbol locations in a slot different from the slot in which the first SRS resource is transmitted, and the second and fourth OFDM symbol locations may be different from each other. In this case, the first OFDM symbol location may be identical to or different from the second to fourth OFDM symbol locations.

Regarding the above details, in case that four SRS resource sets are configured, each SRS resource set may include one SRS resource, the corresponding four SRS resources may be transmitted at identical or different OFDM symbol locations in each slot, and SRS transmission regarding respective SRS resource sets may be performed in different slots. Each SRS resource in the corresponding SRS resource set may be constituted with one SRS port, and the one SRS port of respective SRS resources may be connected to different UE antenna ports.

As an example, first to fourth SRS resources may be included in first to fourth SRS resource sets, respectively, (that is, one SRS resource is included in one SRS resource set), the one SRS port of the first to fourth SRS resources may be connected to different UE antenna ports, the one SRS port of the first to fourth SRS resources may be transmitted at first to fourth OFDM symbol locations in different slots, and the first to fourth OFDM symbol locations in each slot may be identical to or different from each other, but the slot locations may be different from each other.

In case that the UE did not report all of srs-AntennaSwitching2SP-1Periodic-r17, srs-ExtensionAperiodicSRS-r17, and srs-OneAP-SRS-r17 that are UE capability reports, that is, in case that all of the three UE capability are not reported,

The base station may configure, for the UE, a maximum of one (that is, 0 or 1) SRS resource set having resourceType value of ‘periodic’ or ‘semi-persistent’ in SRS-ResourceSet that is higher layer signaling.

Regarding the above details, each SRS resource set may include four SRS resources, the corresponding four SRS resources may be transmitted at different OFDM symbol locations, each SRS resource in the corresponding SRS resource set may be constituted with one SRS port, and the one SRS port of the respective SRS resources may be connected to different UE antenna ports.

As an example, first to fourth SRS resources, each being constituted with one SRS port, may be included in the corresponding SRS resource set, the one SRS port of the first to fourth SRS resources may be connected to different UE antenna ports, the one SRS port of the first to fourth SRS resources may be transmitted at first to fourth OFDM symbol locations, and the first to fourth second OFDM symbol locations may be different from each other, but the slot locations may be identical to or different from each other.

The base station may configure, for the UE, 0 or 2 SRS resource sets having resourceType value of ‘aperiodic’ in SRS-ResourceSet that is higher layer signaling. In case that two SRS resource sets are configured, some or all of the following details may be considered.

Each SRS resource set may include two SRS resources, or the first SRS resource set may have one SRS resource, and the second SRS resource set may have three SRS resources.

Respective SRS resources in each SRS resource set may be transmitted at different OFDM symbol locations in the same slot, and SRS transmission regarding respective SRS resource sets may be performed in different slots. SRS transmission between different SRS resources of different SRS resource sets may occur at identical or different OFDM symbol locations, but the slot locations may be different.

Each SRS resource may include one SRS port, and the one SRS port of respective SRS resources may be connected to different UE antenna ports.

As an example, first and second SRS resources, each being constituted with one SRS port, may be included in the first SRS resource set, and third and fourth SRS resources, each being constituted with one SRS port, may be included in the second SRS resource set. The one SRS port of the first to fourth SRS resources may be connected to different UE antenna ports. The one SRS port of the first and second SRS resources may be transmitted at first and second OFDM symbol locations in the same certain slot, and the first and second OFDM symbol locations may be different from each other. The one SRS port of the third and fourth SRS resources may be transmitted at third and fourth OFDM symbol locations in a slot different from the slot in which the first and second SRS resources are transmitted, and the third and fourth OFDM symbol locations may be different from each other. In this case, the first OFDM symbol location may be identical to or different from the third and fourth OFDM symbol locations, and the second OFDM symbol location may be similarly identical to or different from the third and fourth OFDM symbol locations.

As another example, a first SRS resource constituted with one SRS port may be included in the first SRS resource set, and second to fourth SRS resources, each being constituted with one SRS port, may be included in the second SRS resource set. The one SRS port of the first to fourth SRS resources may be connected to different UE antenna ports. The one SRS port of the first SRS resource may be transmitted at a first OFDM symbol location in a certain slot. The one SRS port of each of the second to fourth SRS resources may be transmitted at second to fourth OFDM symbol locations in a slot different from the slot in which the first SRS resource is transmitted, and the second and fourth OFDM symbol locations may be different from each other. In this case, the first OFDM symbol location may be identical to or different from the second to fourth OFDM symbol locations

Regarding the above details, in case that a plurality of SRS resource sets are configured (for example, in case that two or four SRS resource sets are configured))

The UE may expect that the base station may configure the same values of p0, alpha, pathlossReferenceRS, and srs-PowerControlAdjustmentStates, which are power control parameters that can be configured in each SRS resource set through higher layer signaling, in all SRS resource sets, respectively. For example, the UE may expect that the plurality of SRS resource sets may all have the same power control parameters. Such a restriction may be hereinafter referred to as a [power control parameter restriction].

The [power control parameter restriction] may be applied only to SRS resource sets having the value of resourceType configured as ‘aperiodic’ in SRS-ResourceSet that is higher layer signaling by the base station for the UE.

The [power control parameter restrictions] may be applied only to SRS resource sets having the value of resourceType configured as ‘periodic,’ ‘semi-persistent,’or ‘aperiodic’ in SRS-ResourceSet that is higher layer signaling by the base station for the UE.

The UE may expect that the base station may configure the value of aperiodicSRS-ResourceTrigger that is higher layer signaling or the value of one entry in AperiodicSRS-ResourceTriggerList that is higher layer signaling to be identical in all SRS resource sets. Such a restriction may be hereinafter referred to as a [aperiodic SRS trigger restriction].

In this case, aperiodicSRS-ResourceTrigger that is higher layer signaling configured in an SRS resource set by the base station refers to aperiodic SRS trigger state information. In case that the UE receives an aperiodic SRS trigger regarding a specific aperiodic SRS trigger state from the base station through DCI, and in case that the value configured in aperiodicSRS-ResourceTrigger that is higher layer signaling corresponds to the aperiodic SRS trigger state indicated by the corresponding DCI, the UE may perform aperiodic SRS transmission regarding the corresponding SRS resource set.

Similarly, AperiodicSRS-ResourceTriggerList that is higher layer signaling configured in an SRS resource set by the base station includes a plurality of pieces of aperiodic SRS trigger state information. In case that the UE receives an aperiodic SRS trigger regarding a specific aperiodic SRS trigger state from the base station through DCI, and in case that the aperiodic SRS trigger state indicated by the corresponding DCI is included in the plurality of values configured in AperiodicSRS-ResourceTriggerList that is higher layer signaling, the UE may perform aperiodic SRS transmission regarding the corresponding SRS resource set.

While aperiodicSRS-ResourceTrigger that is higher layer signaling provided a function such that the corresponding SRS resource set can be included in one aperiodic SRS trigger state, AperiodicSRS-ResourceTriggerList that is higher layer signaling provides a function such that the corresponding SRS resource set can be included in the plurality of aperiodic SRS trigger states, and the possibility that the corresponding SRS resource set can be triggered by the base station may increase.

The [aperiodic SRS trigger restriction] may be applied only to SRS resource sets having the value of resourceType configured as ‘aperiodic’ in SRS-ResourceSet that is higher layer signaling by the base station for the UE.

The UE may expect from the base station that slotOffset that is higher layer signaling inside respective SRS resource sets may have different values. Such a restriction may be hereinafter referred to as a [slot offset detail].

The [slot offset detail] may be applied only to SRS resource sets having the value of resource Type configured as ‘aperiodic’ in SRS-ResourceSet that is higher layer signaling by the base station for the UE.

### [1T1R, 2T2R, 4T4R]

Regarding the UE's 1T1R, 2T2R, and 4T4R operations, higher layer signaling from the base station regarding a combination of at least one of the following details may be configured, and an operation based thereof may be possible.

In case that the UE did not report srs-AntennaSwitching2SP-1Periodic-r17 that is a UE capability report, the base station may configure, for the UE, a maximum of two SRS resource sets

In case that the UE reported srs-AntennaSwitching2SP-1Periodic-r17 that is a UE capability report, the UE may receive a higher layer signaling configuration from the base station as follows

Two SRS resource sets having resourceType value of ‘semi-persistent’ in SRS-ResourceSet that is higher layer signaling, and one SRS resource set having resourceType value of ‘periodic’ in SRS-ResourceSet that is higher layer signaling

Regarding the above details, two SRS resource sets having resourceType value of ‘semi-persistent’ in SRS-ResourceSet that is higher layer signaling may not be activated simultaneously.

A maximum of two SRS resource sets

Each SRS resource sets includes one SRS resource, and in the case of 1T1R, 2T2R, and 4T4R, the number of SRS ports configured in respective SRS resources may be 1, 2, and 4, respectively

The UE may not expect that, in the case of 1T1R, 2T2R, and 4T4R, SRS transmission regarding two or more SRS resource sets having usage that is higher layer signaling configured as ‘antennaSwitching’ may be configured or triggered at the same OFDM symbol location.

### [1T6R]

Regarding the UE's 1T6R operation, higher layer signaling from the base station regarding a combination of at least one of the following details may be configured, and an operation based thereof may be possible.

The base station may configure, for the UE, a maximum of one (that is, 0 or 1) SRS resource set having resourceType value of ‘periodic’ in SRS-ResourceSet that is higher layer signaling, one SRS resource set may include six SRS resources, each SRS resource may be constituted with one SRS port, respective SRS resources may be transmitted at different OFDM symbol locations in identical or different slots, and the one SRS port of respective SRS resources may be connected to different UE antenna ports.

The UE may receive a configuration regarding an SRS resource set having resourceType value of ‘semi-persistent’ in SRS-ResourceSet that is higher layer signaling, as follows.

In case that the UE did not report srs-AntennaSwitching2SP-1Periodic-r17 that is a UE capability report, the base station may configure, for the UE, a maximum of one (that is, 0 or 1) SRS resource set having resourceType value of ‘semi-persistent’ in SRS-ResourceSet that is higher layer signaling.

In case that the UE reported srs-AntennaSwitching2SP-1Periodic-r17 that is a UE capability report, the base station may configure, for the UE, a maximum of two (that is, 0, 1, or 2) SRS resources set having resourceType value of ‘semi-persistent’ in SRS-ResourceSet that is higher layer signaling, and two SRS resource sets having resourceType value of ‘semi-persistent’ in SRS-ResourceSet that is higher layer signaling may not be activated simultaneously.

One SRS resource set may include six SRS resources, each SRS resource may be constituted with one SRS port, respective SRS resources may be transmitted at different OFDM symbol locations in identical or different slots, and the one SRS port of respective SRS resources may be connected to different UE antenna ports.

The base station may configure, for the UE, a maximum of three (that is, 0, 1, 2, or 3) SRS resource sets having resourceType value of ‘aperiodic’ in SRS-ResourceSet that is higher layer signaling

In case that one SRS resource set is configured, six SRS resources may be included therein, each SRS resource may be constituted with one SRS port, respective SRS resources may be transmitted at different OFDM symbol locations in the same slot, and the one SRS port of respective SRS resources may be connected to different UE antenna ports.

In case that two SRS resource sets are configured, a total of six SRS resources may be divided and included in the two SRS resource sets, each SRS resource may be constituted with one SRS port, all SRS resources in each SRS resource set may be transmitted at different OFDM symbol locations in the same slot, SRS transmission regarding different SRS resource sets may be performed in identical or different OFDM symbol locations of different slots, and the one SRS port of respective SRS resources may be connected to different UE antenna ports.

As an example, the UE may include first to third SRS resources in the first SRS resource set, and may include fourth to sixth SRS resources in the second SRS resource set. Transmission regarding the first to third SRS resources in the first SRS resource set may be performed at first to third OFDM symbol locations in the first slot, and the first to third OFDM symbol locations may be different from each other. Transmission regarding the fourth to sixth SRS resources in the second SRS resource set may be performed at fourth to sixth OFDM symbol locations in the second slot, and the fourth to sixth OFDM symbol locations may be different from each other. The first and second slot locations may be different from each other, and the first to third OFDM symbol locations may be identical to or different from the fourth to sixth OFDM symbol locations.

As another example, a case in which the first and second SRS resource sets include one (for example, a first SRS resource) and five (for example, second to sixth SRS resources) SRS resources, respectively, may also be possible, and other combinations may not be excluded.

In case that three SRS resource sets are configured, a total of six SRS resources may be divided and included in the three SRS resource sets, each SRS resource may be constituted with one SRS port, all SRS resources in each SRS resource set may be transmitted at different OFDM symbol locations in the same slot, SRS transmission regarding different SRS resource sets may be performed in identical or different OFDM symbol locations of different slots, and the one SRS port of respective SRS resources may be connected to different UE antenna ports.

As an example, the UE may include first and second SRS resources in the first SRS resource set, may include third and fourth SRS resources in the second SRS resource set, and may include fifth and sixth SRS resources in the third SRS resource set. Transmission regarding the first and second SRS resources in the first SRS resource set may be performed at first and second OFDM symbol locations in the first slot, and the first and second OFDM symbol locations may be different from each other. Transmission regarding the third and fourth SRS resources in the second SRS resource set may be performed at third and fourth OFDM symbol locations in the second slot, and the third and fourth OFDM symbol locations may be different from each other. Transmission regarding the fifth and sixth SRS resources in the third SRS resource set may be performed at fifth and sixth OFDM symbol locations in the third slot, and the fifth and sixth OFDM symbol locations may be different from each other. In this case, the first, second, and third slot locations may be different from each other, and the first and second OFDM symbol locations, the third and fourth OFDM symbol locations, and the fifth and sixth OFDM symbol locations may be identical to or different from each other.

As another example, a case in which the first, second, and third SRS resource sets include three (for example, first to third SRS resources), two (for example, fourth and fifth SRS resources), and one (for example, a sixth SRS resource) SRS resources, respectively, may also be possible, and other combinations may not be excluded.

### [1T8R]

Regarding the UE's 1T8R operation, higher layer signaling from the base station regarding a combination of at least one of the following details may be configured, and an operation based thereof may be possible

The base station may configure, for the UE, a maximum of one (that is, 0 or 1) SRS resource set having resourceType value of ‘periodic’ in SRS-ResourceSet that is higher layer signaling, one SRS resource set may include eight SRS resources, each SRS resource may be constituted with one SRS port, respective SRS resource may be transmitted at different OFDM symbol location in identical or different slots, and the one SRS port of respective SRS resources may be connected to different UE antenna ports.

The UE may receive a configuration regarding an SRS resource set having resourceType value of ‘semi-persistent’ in SRS-ResourceSet that is higher layer signaling, as follows

In case that the UE did not report srs-AntennaSwitching2SP-1Periodic-r17 that is a UE capability report, the base station may configure, for the UE, a maximum of one (that is, 0 or 1) SRS resource set having resourceType value of ‘semi-persistent’ in SRS-ResourceSet that is higher layer signaling.

In case that the UE reported srs-AntennaSwitching2SP-1Periodic-r17 that is a UE capability report, the base station may configure, for the UE, a maximum of two (that is, 0, 1, or 2) SRS resource sets having resourceType value of ‘semi-persistent’ in SRS-ResourceSet that is higher layer signaling, and two SRS resource sets having resourceType value of ‘semi-persistent’ in SRS-ResourceSet that is higher layer signaling may not be activated simultaneously.

One SRS resource set may include eight SRS resources, each SRS resource may be constituted with one SRS port, respective SRS resources may be transmitted at different OFDM symbol locations in identical or different slots, and the one SRS port of respective SRS resources may be connected to different UE antenna ports.

The base station may configure, for the UE, 0, 2, 3, or 4 SRS resource sets having resourceType value of ‘aperiodic’ in SRS-ResourceSet that is higher layer signaling.

In case that two SRS resource sets are configured, a total of eight SRS resources may be divided and included in the two SRS resource sets, each SRS resource may be constituted with one SRS port, all SRS resources in each SRS resource set may be transmitted at different OFDM symbol locations in the same slot, SRS transmission regarding different SRS resource sets may be performed in identical or different OFDM symbol locations of different slots, and the one SRS port of respective SRS resources may be connected to different UE antenna ports.

As an example, the UE may include first to fourth SRS resources in the first SRS resource set, and may include fifth to eighth SRS resources in the second SRS resource set. Transmission regarding the first to fourth SRS resources in the first SRS resource set may be performed at first to fourth OFDM symbol locations in the first slot, and the first to fourth OFDM symbol locations may be different from each other. Transmission regarding the fifth to eighth SRS resources in the second SRS resource set may be performed at fifth to eighth OFDM symbol locations in the second slot, and the fifth to eighth OFDM symbol locations may be different from each other. In this case, the first and second slot locations may be different from each other, and the first to fourth OFDM symbol locations may be identical to or different from the fifth to eighth OFDM symbol locations.

As another example, a case in which the first and second SRS resource sets include one (for example, a first SRS resource) and seven (for example, second to eighth SRS resources) SRS resources, respectively, may also be possible, and other combinations may not be excluded.

In case that three SRS resource sets are configured, a total of eight SRS resources may be divided and included in the three SRS resource sets, each SRS resource may be constituted with one SRS port, all SRS resources in each SRS resource set may be transmitted at different OFDM symbol locations in the same slot, SRS transmission regarding different SRS resource sets may be performed in identical or different OFDM symbol locations of different slots, and the one SRS port of respective SRS resources may be connected to different UE antenna ports.

As an example, the UE may include first to third SRS resources in the first SRS resource set, may include fourth to sixth SRS resources in the second SRS resource set, and may include seventh and eighth SRS resources in the third SRS resource set. Transmission regarding the first to third SRS resources in the first SRS resource set may be performed at first to third OFDM symbol locations in the first slot, and the first to third OFDM symbol locations may be different from each other. Transmission regarding the fourth to sixth SRS resources in the second SRS resource set may be performed at fourth to sixth OFDM symbol locations in the second slot, and the fourth to sixth OFDM symbol locations may be different from each other. Transmission regarding the seventh and eighth SRS resources in the third SRS resource set may be performed at seventh and eighth OFDM symbol locations in the third slot, and the seventh and eighth OFDM symbol locations may be different from each other. In this case, the first, second, and third slot locations may be different from each other, and the first to third OFDM symbol locations, the fourth to sixth OFDM symbol locations, and the seventh and eighth OFDM symbol locations may be identical to or different from each other.

As another example, a case in which the first, second, and third SRS resource sets include four (for example, first to fourth SRS resources), two (for example, fifth and sixth SRS resources), and two (for example, seventh and eighth SRS resource) SRS resources, respectively, may also be possible, and other combinations may not be excluded.

In case that four SRS resource sets are configured, a total of eight SRS resources may be divided and included in the four SRS resource sets, each SRS resource may be constituted with one SRS port, all SRS resources in each SRS resource set may be transmitted at different OFDM symbol locations in the same slot, SRS transmission regarding different SRS resource sets may be performed in identical or different OFDM symbol locations of different slots, and the one SRS port of respective SRS resources may be connected to different UE antenna ports.

As an example, the UE may include first and second SRS resources in the first SRS resource set, may include third and fourth SRS resources in the second SRS resource set, may include fifth and sixth SRS resources in the third SRS resource set, and may include seventh and eighth SRS resources in the fourth SRS resource set. Transmission regarding the first and second SRS resources in the first SRS resource set may be performed at first and second OFDM symbol locations in the first slot, and the first and second OFDM symbol locations may be different from each other. Transmission regarding the third and fourth SRS resources in the second SRS resource set may be performed at third and fourth OFDM symbol locations in the second slot, and the third and fourth OFDM symbol locations may be different from each other. Transmission regarding the fifth and sixth SRS resources in the third SRS resource set may be performed at fifth and sixth OFDM symbol locations in the third slot, and the fifth and sixth OFDM symbol locations may be different from each other. Transmission regarding the seventh and eighth SRS resource in the fourth SRS resource set may be performed at seventh and eighth OFDM symbol locations in the fourth slot, and the seventh and eight OFDM symbol locations may be different from each other. In this case, the first to fourth slot locations may be different from each other, and the first and second OFDM symbol locations, the third and fourth OFDM symbol locations, the fifth and sixth OFDM symbol locations, and the seventh and eighth OFDM symbol locations, may be identical to or different from each other.

As another example, a case in which the first, second, third, and fourth SRS resource sets include three (for example, first to third SRS resources), two (for example, fourth and fifth SRS resources), and two (for example, sixth and seventh SRS resource), and one (for example, eighth SRS resource) SRS resources, respectively, may also be possible, and other combinations may not be excluded.

### [2T6R]

Regarding the UE's 2T6R operation, higher layer signaling from the base station regarding a combination of at least one of the following details may be configured, and an operation based thereof may be possible.

The base station may configure, for the UE, a maximum of one (that is, 0 or 1) SRS resource set having resourceType value of ‘periodic’ in SRS-ResourceSet that is higher layer signaling, one SRS resource set may include three SRS resources, each SRS resource may be constituted with two SRS ports, respective SRS resource may be transmitted at different OFDM symbol locations in identical or different slots, and the two SRS ports of respective SRS resources may be connected to different UE antenna ports.

The UE may receive a configuration regarding an SRS resource set having resourceType value of ‘semi-persistent’ in SRS-ResourceSet that is higher layer signaling from the base station, as follows.

In case that the UE did not report srs-AntennaSwitching2SP-1Periodic-r17 that is a UE capability report, the base station may configure, for the UE, a maximum of one (that is, 0 or 1) SRS resource set having resourceType value of ‘semi-persistent’ in SRS-ResourceSet that is higher layer signaling.

In case that the UE reported srs-AntennaSwitching2SP-1Periodic-r17 that is a UE capability report, the base station may configure, for the UE, a maximum of two (that is, 0, 1, or 2) SRS resource sets having resourceType value of ‘semi-persistent’ in SRS-ResourceSet that is higher layer signaling, and two SRS resource sets having resourceType value of ‘semi-persistent’ in SRS-ResourceSet that is higher layer signaling may not be activated simultaneously.

One SRS resource set may include three SRS resources, each SRS resource may include two SRS ports, respective SRS resources may be transmitted at different OFDM symbol locations in identical or different slots, and the two SRS ports of respective SRS resources may be connected to different UE antenna ports.

The base station may configure, for the UE, a maximum of three (that is, 0, 1, 2, or 3) SRS resource sets having resourceType value of ‘aperiodic’ in SRS-ResourceSet that is higher layer signaling.

In case that one SRS resource set is configured, three SRS resources may be included therein, each SRS resource may be constituted with two SRS ports, respective SRS resources may be transmitted at different OFDM symbol locations in the same slot, and the two SRS ports of respective SRS resources may be connected to different UE antenna ports.

In case that two SRS resource sets are configured, a total of three SRS resources may be divided and included in the two SRS resource sets, each SRS resource may be constituted with two SRS ports, all SRS resources in each SRS resource set may be transmitted at different OFDM symbol locations in the same slot, SRS transmission regarding different SRS resource sets may be performed in identical or different OFDM symbol locations of different slots, and the two SRS ports of respective SRS resources may be connected to different UE antenna ports.

As an example, the UE may include first and second SRS resources in the first SRS resource set, and may include a third SRS resource in the second SRS resource set. Transmission regarding the first and second SRS resources in the first SRS resource set may be performed at first and second OFDM symbol locations in the first slot, and the first and second OFDM symbol locations may be different from each other. Transmission regarding the third SRS resource in the second SRS resource set may be performed at a third OFDM symbol location in the second slot. In this case, the first and second slot locations may be different from each other, and the first and second OFDM symbol locations may be identical to or different from the third OFDM symbol location.

As another example, a case in which the first and second SRS resource sets include one (for example, a first SRS resource) and two (for example, second and third SRS resources) SRS resources, respectively, may also be possible, and other combinations may not be excluded.

In case that three SRS resource sets are configured, a total of three SRS resources may be divided and included in the three SRS resource sets, each SRS resource may be constituted with two SRS ports, all SRS resources in each SRS resource set may be transmitted at different OFDM symbol locations in the same slot, SRS transmission regarding different SRS resource sets may be performed in identical or different OFDM symbol locations of different slots, and the two SRS ports of respective SRS resources may be connected to different UE antenna ports.

As an example, the UE may include a first SRS resource in the first SRS resource set, may include a second SRS resource in the second SRS resource set, and may include a third SRS resource in the third SRS resource set. Transmission regarding the first SRS resource in the first SRS resource set may be performed at a first OFDM symbol location in the first slot. Transmission regarding the second SRS resource in the second SRS resource set may be performed at a second OFDM symbol location in the second slot. Transmission regarding the third SRS resource in the third SRS resource set may be performed at a third OFDM symbol location in the third slot. In this case, the first, second, and third slot locations may be different from each other, and the first to third OFDM symbol locations may be identical to or different from each other.

### [2T8R]

Regarding the UE's 2T8R operation, higher layer signaling from the base station regarding a combination of at least one of the following details may be configured, and an operation based thereof may be possible.

The base station may configure, for the UE, a maximum of one (that is, 0 or 1) SRS resource set having resourceType value of ‘periodic’ in SRS-ResourceSet that is higher layer signaling, one SRS resource set may include four SRS resources, each SRS resource may be constituted with two SRS ports, respective SRS resource may be transmitted at different OFDM symbols in identical or different slots, and the two SRS ports of respective SRS resources may be connected to different UE antenna ports.

The UE may receive a configuration regarding an SRS resource set having resourceType value of ‘semi-persistent’ in SRS-ResourceSet that is higher layer signaling, as follows.

In case that the UE did not report srs-AntennaSwitching2SP-1Periodic-r17 that is a UE capability report, the base station may configure, for the UE, a maximum of one (that is, 0 or 1) SRS resource set having resourceType value of ‘semi-persistent’ in SRS-ResourceSet that is higher layer signaling.

In case that the UE reported srs-AntennaSwitching2SP-1Periodic-r17 that is a UE capability report, the base station may configure, for the UE, a maximum of two (that is, 0, 1, or 2) SRS resource sets having resourceType value of ‘semi-persistent’ in SRS-ResourceSet that is higher layer signaling, and two SRS resource sets having resourceType value of ‘semi-persistent’ in SRS-ResourceSet that is higher layer signaling may not be activated simultaneously.

One SRS resource set may include four SRS resources, each SRS resource may be constituted with two SRS ports, respective SRS resources may be transmitted at different OFDM symbol locations in identical or different slots, and the two SRS ports of respective SRS resources may be connected to different UE antenna ports.

The base station may configure, for the UE, 0, 2, 3, or 4 SRS resource sets having resourceType value of ‘aperiodic’ in SRS-ResourceSet that is higher layer signaling.

In case that one SRS resource set is configured, four SRS resources may be included therein, each SRS resource may be constituted with two SRS ports, respective SRS resources may be transmitted at different OFDM symbol locations in the same slot, and the two SRS ports of respective SRS resources may be connected to different UE antenna ports.

In case that two SRS resource sets are configured, a total of four SRS resources may be divided and included in the two SRS resource sets, each SRS resource may be constituted with two SRS ports, all SRS resources in each SRS resource set may be transmitted at different OFDM symbol locations in the same slot, SRS transmission regarding different SRS resource sets may be performed in identical or different OFDM symbol locations of different slots, and the two SRS ports of respective SRS resources may be connected to different UE antenna ports.

As an example, the UE may include first and second SRS resources in the first SRS resource set, and may include third and fourth SRS resources in the second SRS resource set. Transmission regarding the first and second SRS resources in the first SRS resource set may be performed at first and second OFDM symbol locations in the first slot, and the first and second OFDM symbol locations may be different from each other. Transmission regarding the third and fourth SRS resources in the second SRS resource set may be performed at third and fourth OFDMs symbol location in the second slot, and the third and fourth OFDM symbol locations may be different from each other. In this case, the first and second slot locations may be different from each other, and the first and second OFDM symbol locations may be identical to or different from the third and fourth OFDM symbol locations.

As another example, a case in which the first and second SRS resource sets include one (for example, a first SRS resource) and three (for example, second to fourth SRS resources) SRS resources, respectively, may also be possible, and other combinations may not be excluded.

In case that three SRS resource sets are configured, a total of four SRS resources may be divided and included in the three SRS resource sets, each SRS resource may include two SRS ports, all SRS resources in each SRS resource set may be transmitted at different OFDM symbol locations in the same slot, SRS transmission regarding different SRS resource sets may be performed in identical or different OFDM symbol locations of different slots, and the two SRS ports of respective SRS resources may be connected to different UE antenna ports.

As an example, the UE may include first and second SRS resources in the first SRS resource set, may include a third SRS resource in the second SRS resource set, and may include a fourth SRS resource in the third SRS resource set. Transmission regarding the first and second SRS resources in the first SRS resource set may be performed at first and second OFDM symbol locations in the first slot, and the first and second OFDM symbol locations may be different from each other. Transmission regarding the third SRS resource in the second SRS resource set may be performed at a third OFDM symbol location in the second slot. Transmission regarding the fourth SRS resource in the third SRS resource set may be performed at a fourth OFDM symbol location in the third slot. In this case, the first, second, and third slot locations may be different from each other, and the first to fourth OFDM symbol locations may be identical to or different from each other.

As an example, a case in which the first, second, and third SRS resource sets include one (for example, a first SRS resource), two (for example, second and third SRS resources), and one (for example, a fourth SRS resource) SRS resource, respectively, may also be possible, and other combinations may not be excluded.

In case that four SRS resource sets are configured, a total of four SRS resources may be divided and included in the four SRS resource sets, each SRS resource may be constituted with two SRS ports, all SRS resources in each SRS resource set may be transmitted at different OFDM symbol locations in the same slot, SRS transmission regarding different SRS resource sets may be performed in identical or different OFDM symbol locations of different slots, and the two SRS ports of respective SRS resources may be connected to different UE antenna ports.

As an example, the UE may include first, second, third, and fourth SRS resources in the first, second, third, and fourth SRS resource sets, respectively, transmission regarding the first, second, third, and fourth SRS resources in the first, second, third, and fourth SRS resource sets may be performed at first, second, third, and fourth OFDM symbol locations in first, second, third, and fourth slots, respectively, the first to fourth slot locations may be different from each other, and the first to fourth OFDM symbol locations may be identical to or different from each other.

### [4T8R]

Regarding the UE's 4T8R operation, higher layer signaling from the base station regarding a combination of at least one of the following details may be configured, and an operation based thereof may be possible.

In case that the UE did not report srs-AntennaSwitching2SP-1Periodic-r17 that is a UE capability report,

The base station may configure, for the UE, a maximum of two (for example, 0, 1, or 2) SRS resource set having resourceType value of ‘periodic’ or ‘semi-persistent’ in SRS-ResourceSet that is higher layer signaling. As an example, the base station may configure one of the following details for the UE.

No configured SRS resource set having resourceType value of ‘periodic’ or ‘semi-persistent’ in SRS-ResourceSet that is higher layer signaling

One SRS resource set having resourceType value of ‘periodic’ in SRS-ResourceSet that is higher layer signaling

One SRS resource set having resourceType value of ‘semi-persistent’ in SRS-ResourceSet that is higher layer signaling

One SRS resource set having resourceType value of ‘periodic’ in SRS-ResourceSet that is higher layer signaling, and one SRS resource set having resourceType value of ‘semi-persistent’ therein

Regarding the above details, each SRS resource set may include two SRS resources, each SRS resource may be constituted with four SRS ports, respective SRS resources may be transmitted at different OFDM symbol locations in identical or different slots, and the four SRS ports of respective SRS resources may be connected to different UE antenna ports.

In case that the UE reported srs-AntennaSwitching2SP-1Periodic-r17 that is a UE capability report, the base station may configure, for the UE, a maximum of two (that is, 0, 1, or 2) SRS resource sets having resourceType value of ‘semi-persistent’ in SRS-ResourceSet that is higher layer signaling, the base station may configure, for the UE, a maximum of one (that is, 0 or 1) SRS resource set having resourceType value of ‘periodic’ in SRS-ResourceSet that is higher layer signaling, and two SRS resource sets having resource Type value of ‘semi-persistent’ in SRS-ResourceSet that is higher layer signaling may not be activated simultaneously.

Each SRS resource set may include two SRS resources, each SRS resource may be constituted with four SRS ports, respective SRS resources may be transmitted at different OFDM symbol locations in identical or different slots, and the fourth SRS ports of respective SRS resources may be connected to different UE antenna ports.

The base station may configure, for the UE, 0, 1, or 2 SRS resource sets having resourceType value of ‘aperiodic’ in SRS-ResourceSet that is higher layer signaling.

In case that one SRS resource set is configured, two SRS resources may be included therein, each SRS resource may be constituted with four SRS ports, respective SRS resources may be transmitted at different OFDM symbol locations in the same slot, and the four SRS ports of respective SRS resources may be connected to different UE antenna ports.

In case that two SRS resource sets are configured, a total of two SRS resources may be divided and included in the two SRS resource sets, each SRS resource may be constituted with four SRS ports, all SRS resources in each SRS resource set may be transmitted at different OFDM symbol locations in the same slot, SRS transmission regarding different SRS resource sets may be performed in identical or different OFDM symbol locations of different slots, and the four SRS port of respective SRS resources may be connected to different UE antenna ports.

As an example, the UE may include first and second SRS resources in the first and second SRS resource sets, respectively, and transmission regarding the first and second SRS resources in the first and second SRS resource sets may be performed at first and second OFDM symbol locations in the first and second slots, respectively. In this case, the first and second slot locations may be different from each other, and the first and second OFDM symbol locations may be identical to or different from each other.

In case that the UE performs an antenna switching operation, that is, in case that the UE transmits different SRS resources associated with different antenna port(s), a time interval of about 15 μs may be generally necessary between two adjacent SRS resources among all transmitted SRS resources. In view of this, a (minimum) guard period may be defined as in Table 29 below:

TABLE 26

| μ | Δf = 2^{μ} · 15 [kHz] | Y [symbol] |
|---|---|---|
| 0 | 15 | 1 |
| 1 | 30 | 1 |
| 2 | 60 | 1 |
| 3 | 120 | 2 |

In Table 29, u refers to numerology, Δf refers to a subcarrier spacing, and Y may refer to the number of OFDM symbols expressing the guard period, that is, the time length of the guard period. With reference to Table 29, the guard period may be configured based on parameter u that determines the numerology. The UE is configured not to transmit any different signal in the guard period, and the guard period may be configured to be fully used for antenna switching.

As an example, the guard period may be configured between transmission timepoints of two adjacent SRS resources based on SRS resources transmitted at different OFDM symbol locations in the same slot.

As another example, in case that the UE had two SRS resource sets configured for antenna switching usage, in case that the corresponding two SRS resource sets were configured or triggered to be transmitted in two consecutive slots, and in case that the UE reported a UE capability indicating that the UE can transmit SRSs at all OFDM symbol locations inside slots, the UE may expect that there may be a guard period for antenna switching corresponding to at least Y OFDM symbols, based on Table 29 above, between the last OFDM symbol in which SRS transmission is performed in the first slot in which SRS transmission regarding the first SRS resource set is performed, and the first OFDM symbol in which SRS transmission is performed in the second slot in which SRS transmission regarding the second SRS resource set is performed. For example, the time difference between two SRS transmissions may be actually larger than or equal to the Y OFDM symbols.

With regard to such an inter-slot guard period, similarly to the above-described guard period between two SRS resources inside slots, in case that the actual time difference between the last SRS transmission of the first slot and the first SRS transmission of the next slot, in two consecutive slots, corresponds to Y OFDM symbols, the UE may not transmit any signal in the Y OFDM symbol intervals.

With regard to such an inter-slot guard period, in case that the actual time difference between the last SRS transmission of the first slot and the first SRS transmission of the next slot, in two consecutive slots, corresponds to Y OFDM symbols, and if all SRS transmissions before and after the guard period are dropped (canceled) due to overlapping with other signals, the UE may determine that the inter-slot guard period defined by Y OFDM symbols is also dropped (canceled) by applying the same priority as the SRS transmissions before and after the guard period, and may perform uplink transmission in this inter-slot guard period in case of determining the dropping.

With regard to all antenna switching schemes described above, the UE may expect that the same number of SRS ports may be configured for all SRS resources in all SRS resource sets having higher layer signaling usage in SRS resource sets configured as “antennaSwitching” by the base station.

With regard to antenna switching schemes based on 1T24, 1T4R, 2T4R, 1T6R, 1T8R, 2T6R, 2T8R, and 4T8R operations described above, the UE may not expect that two or more among SRS resource sets having higher layer signaling usage configured as ‘antennaSwitching’ by the base station may be configured or triggered in the same slot.

With regard to antenna switching schemes based on 1T1R, 2T2R, and 4T4R operations, the UE may not expect that two or more among SRS resource sets having higher layer signaling usage configured as ‘antennaSwitching’ by the base station may be configured or triggered in the same OFDM symbol.

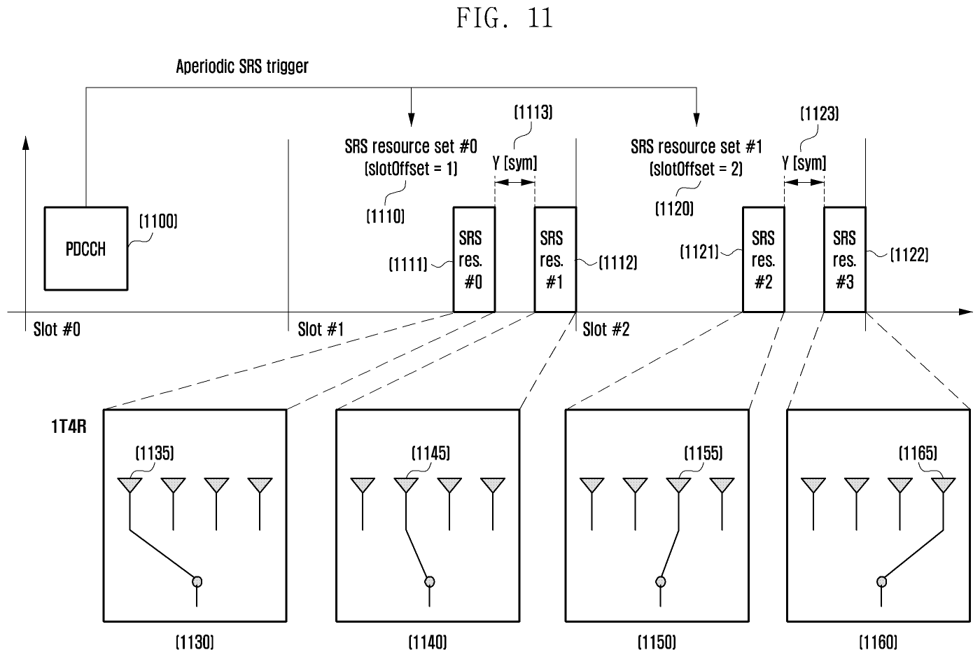

FIG. 11 is a diagram illustrating an SRS antenna switching operation according to an embodiment of the disclosure.

Referring to FIG. 11, it illustrates a situation in which a UE operates based on 1T4R, and in which the UE may have two aperiodic SRS resource sets (for example, SRS resource set #0 and #1) configured therefor. The UE may receive a PDCCH from the base station 1100, and an aperiodic SRS trigger regarding SRS resource set #0 1110 and SRS resource set #1 1120 may be indicated through the PDCCH. In this case, the slot offset value regarding SRS resource set #0 1110 may be configured by slotOffset that is higher layer signaling, the value thereof may be 1, and aperiodic SRS transmission regarding SRS resource set #0 may be performed at a location after one slot from the slot in which the PDCCH is received (that is, in slot #1). In addition, the slot offset value regarding SRS resource set #1 1120 may be configured by slotOffset that is higher layer signaling, the value thereof may be 2, and aperiodic SRS transmission regarding SRS resource set #1 may be performed at a location after two slots from the slot in which the PDCCH is received (that is, in slot #2).

SRS resource #0 1111 and SRS resource #1 1112 included in SRS resource set #0 1110 are transmitted at different OFDM symbol locations in slot #1, and here, Y OFDM symbols may exist as a guard period between SRS resource #0 and #1 1113. In addition, during transmission regarding SRS resource #0 1130, the UE may connect one SRS port to the first reception antenna port 1135 of the UE so as to perform SRS transmission, and during transmission regarding SRS resource #1 1140, the UE may connect one SRS port to the second reception antenna port 1145 of the UE so as to perform SRS transmission.

SRS resource #2 1121 and SRS resource #3 1122 included in SRS resource set #1 1120 are transmitted at different OFDM symbol locations in slot #1, and here, Y OFDM symbols may exist as a guard period between SRS resource #2 and #3 1123. In addition, during transmission regarding SRS resource #2 1150, the UE may connect one SRS port to the third reception antenna port 1155 of the UE so as to perform SRS transmission, and during transmission regarding SRS resource #3 1160, the UE may connect one SRS port to the fourth reception antenna port 1165 of the UE so as to perform SRS transmission.

By connecting the four SRS resources #0 to #3 described above to different reception antenna ports of the UE and then transmitting SRSs, the UE may transmit SRSs from all different reception antenna ports to be able to acquire information regarding channels connected to all reception antennas of the UE, and the base station may thereby acquire information regarding channels between the base station and the UE and utilize the same for uplink or downlink scheduling.

### [SRS: Carrier Switching]

Next, SRS carrier switching will be described. In the TDD system, SRS carrier switching is used to perform the SRS transmission for supporting downlink channel estimation of a base station with respect to a support cell in which PUSCH/PUCCH transmission is not configured, that is, a cell supporting only downlink transmission. Since channel reciprocity is established between a downlink channel and an uplink channel in the TDD system, the base station may estimate a downlink channel based on an uplink channel estimated through the SRS. In case that the base station performs a support using a very large number of antennas but the UE performs a support using a relatively small number of antennas, the method of estimating the downlink channel through the SRS-based channel reciprocity has the advantage of requiring a smaller overhead compared to the method of estimating the CSI-RS-based downlink channel.

In order to transmit the SRS to a cell supporting only downlink transmission through SRS carrier switching, the UE should use an RF transmitter for uplink transmission of one cell among other cells. A target cell for performing SRS carrier switching (hereinafter referred to as a target cell or target component carrier (CC)) is in a frequency band for supporting only downlink transmission in which PUCCH/PUSCH transmission is not configured, the UE does not use the RF transmitter except for the purpose of SRS carrier switching. Therefore, when considering the cost of the UE, and the like, there is no separate arrangement of an RF transmitter for uplink transmission to a target cell for performing SRS carrier switching, and when SRS carrier switching is scheduled (hereinafter, scheduling for performing SRS carrier switching may include all of downlink control information (DCI) format 2_3 based aperiodic (AP) triggering, higher layer configuration based semi-persistent (SP), and periodic (P) triggering based scheduling), the UE may transmit the SRS by retuning a RF transmitter for uplink transmission of another cell. A cell in which the RF transmitter is arranged before the UE retuning in order to perform the SRS carrier switching may be defined as a source cell (hereinafter, referred to as a source cell or source CC), which may be configured in the UE through higher layer parameter srs-SwitchFromServCellIndex and srs-SwitchFromCarrier. The higher layer parameter srs-SwitchFromServCellIndex indicates the cell index of the source CC, and the srs-SwitchFromCarrier indicates one of the NUL and SUL of the target CC to determine the RF transmitter that the UE needs to retune.

When performing SRS carrier switching, the UE requires a retuning time, which is a time taken the RF transmitter of the source CC to prepare to transmit the SRS to the target CC, and a time to retune the RF transmitter to the source CC again after transmitting all the SRSs to the target CC. This is a time additionally required in addition to the preparation time required to transmit an SRS for a purpose other than SRS carrier switching. As described above, with regard to a retuning time of the RF transmitter required before and after performing SRS carrier switching, the UE may report the UE capability to the base station and notify the base station of the required time. In this case, the UE may report the retuning time of the RF transmitter to the base station through switchingTime UL and switchingTimeDL.

Since the UE retunes the RF transmitter in the source CC to perform SRS carrier switching, the UE may not transmit an uplink signal (e.g., PUCCH, PUSCH, or SRS) to the source CC while transmitting the SRS to the target CC. Therefore, in order to perform SRS carrier switching, the UE identifies first whether the uplink transmission scheduled for the source CC overlaps with the SRS transmission including the RF retuning time. If the uplink transmission scheduled for the source CC and the SRS transmission scheduled for the target CC (including a retuning time) overlap, and the simultaneous transmission behind the UE's indicated UL CA capability is not possible, the UE may compare the priorities between the two signals and transmit only one uplink signal. Here, the priority for SRS carrier switching defined in NR release 15/16 is as follows:

If PUSCH or PUCCH including one or a plurality of pieces of information of HARQ-ACK/positive scheduling request (SR)/rank indicator (RI)/CSI-RS resource indicator (CRI)/SS/PBCH block resource indicator (SSBRI) and/or physical random access channel (PRACH) in the source CC overlap with the SRS transmission in the target CC, the UE may not transmit the SRS of the target CC. For example, the UE may transmit a scheduled uplink signal on the source CC without performing SRS carrier switching.

If the PUSCH including aperiodic CSI in the source CC overlaps the periodic or semi-persistent SRS transmission in the target CC, the UE may not transmit the periodic or semi-persistent SRS of the target CC. For example, the UE may transmit the scheduled uplink signal on the source CC without performing SRS carrier switching.

If PUCCH or PUSCH including periodic or semi-persistent CSI including one or a plurality of pieces of information of only channel quality indicator (CQI)/precoding matrix indicator (PMI)/layer 1 reference signal received power (L1-RSRP)/layer 1 signal to interference plus noise ratio (L1-SINR) and/or SRS in the source CC overlap with the SRS transmission in the target CC, the UE may not transmit the PUCCH or PUSCH and/or SRS of the source CC. For example, the UE may perform SRS carrier switching so as to transmit the SRS to the target CC.

If PUSCH including aperiodic CSI including one or a plurality of pieces of information of only CQI/PMI/L1-RSRP/L1-SINR in the source CC overlaps with aperiodic SRS transmission in the target CC, the UE may not transmit PUSCH of the source CC. For example, the UE may perform SRS carrier switching so as to transmit the aperiodic SRS to the target CC.

When comparing a priority between the uplink transmission of the source CC and the SRS transmission of the target CC, the UE should consider a time to receive and decode the DCI for scheduling each transmission, a time to determine uplink transmission according to the higher layer configuration, a preparation time required to perform uplink signal transmission, an SRS transmission preparation time to which the RF retuning time of the target CC is added, and the like. This is because if the UE prepares for one of the uplink transmission of the source CC and the SRS transmission of the target CC, cancellation is not possible. For example, while the UE is preparing for the SRS transmission to the already scheduled target CC (considering all the preparation times, such as DCI decoding and RF retuning time), even when the DCI for scheduling uplink signal transmission having a higher priority to the source CC is received, the UE may not cancel the SRS transmission to the target CC. This case is classified as a scheduling error case, and the base station should consider the following conditions when performing SRS carrier switching. In order to cancel one of specific transmissions (uplink signal transmission in a source CC or SRS transmission in a target CC), the UE starts SRS transmission in symbol N_{C1} of carrier c₁ (target CC), and the UE applies the above-mentioned priority rule (a priority rule between the uplink transmission of the source CC and the SRS transmission of the target CC) with regard to conflicting uplink transmission in symbol N_{C}_{₂} of carrier c₂ (source CC), by considering the following conditions:

DCI(s) should be received by the UE so that the interval between the last symbol of the PDCCH and N_{C}_{₁} is at least greater than the value acquired by adding N₂ symbol and T_{SRS}_{_{CS}}, and the interval between the last symbol of the PDCCH and N_{C}_{₂} is at least greater than N₂ symbol. In this case, the DCI may correspond to both DCI for scheduling uplink signal transmission in the source CC and DCI for scheduling SRS transmission in the target CC.

Semi-persistent CSI reporting or SRS transmission is activated before an interval at least greater than the value acquired by adding N₂ symbol and T_{SRS}_{_{CS}} based on N_{C}_{₁} and should be activated before an interval at least greater than N₂ symbol based on N_{C}_{₂}. In this case, the activated transmission may include both uplink transmission in the source CC and SRS transmission in the target CC.

Here, T_{SRS}_{_{CS}} corresponds to T_{SRS}_{_{CS}}=max {switchingTimeUL, switchingTimeDL}, and the time interval unit of the OFDM symbol is determined based on the smallest subcarrier spacing (SCS) among c₁, c₂ and the corresponding scheduling cell (if the overlapping uplink signal is not transmitted to the target CC or source CC). N₂ denotes processing capability according to the UE capability for the PUSCH preparation time to be described later.

When the UE receives the SRS request through the DCI (or grant) for the target CC c and transmits the n-th aperiodic SRS, the UE may start the SRS transmission to the configured symbol and slot satisfying the following conditions:

The configured symbol and slot correspond to a value later than the total sum of the detailed conditions below.

The maximum time interval among the time intervals as many as the number of N OFDM symbols for a cell including the target CC c and DCI (or grant), respectively.

Uplink or downlink RF retuning time defined by switchingTimeUL and switchingTimeDL of higher layer parameter SRS-SwitchingTimeNR.

There is no conflict with any previous SRS transmission (SRS transmission before the n-th aperiodic SRS), and there is no interruption due to uplink or downlink RF retuning time.

When the above condition is not satisfied, the UE does not perform transmission of the n-th SRS. Here, N refers to the minimum time interval in symbol units between an aperiodic SRS and the DCI for triggering the aperiodic SRS, and corresponds to a value reported as UE capability.

In a case of inter-band carrier aggregation (CA), the UE may simultaneously transmit SRS and PUCCH/PUSCH with respect to component carriers (CCs) of different bands based on the UE capability.

In a case of inter-band carrier aggregation (CA), the UE may simultaneously transmit PRACH and SRS with respect to component carriers (CCs) of different bands based on the UE capability.

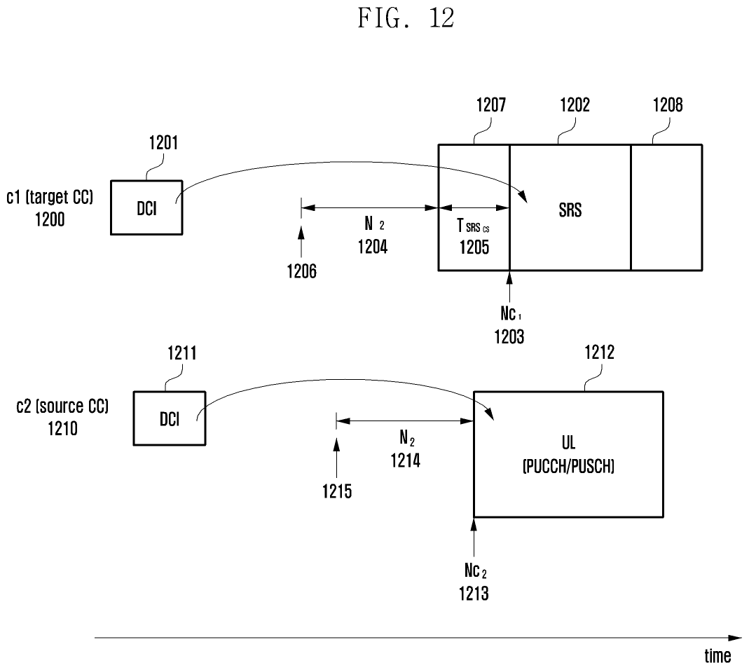

FIG. 12 illustrates SRS carrier switching according to an embodiment of the disclosure.

Referring to FIG. 12, a DCI 1201 received from a target CC 1200 may schedule SRS transmission 1202 through SRS carrier switching. The DCI 1211 received from a source CC 1210 may schedule uplink transmission 1212 which may overlap with the SRS transmission 1202. Here, based on a SRS transmission start symbol N_{C}_{₁} 1203, two DCIs should be received 1206 at least before the value acquired by adding an N₂ 1204 symbol and T_{SRS}_{_{CS}} 1205. Additionally, two DCIs should be received 1215 at least before an N₂ 1214 symbol based on the uplink transmission start symbol N_{C}_{₂} 1213 in the source CC. FIG. 11 is a diagram illustrating an SRS antenna switching operation according to an embodiment of the disclosure.

In FIG. 12, reference numeral 1207 denotes a time required for RF retuning from downlink to uplink in order to perform SRS carrier switching, and reference numeral 1208 denotes a time required for RF retuning from uplink to downlink after SRS carrier switching is performed.

### [Related to UE Capability Report]

In an LTE and NR, the UE may perform a procedure of reporting a capability supported by a UE to a corresponding base station in a state in which the UE is connected to a serving base station. In the following description, this is referred to as a UE capability report.

The base station may transmit a UE capability enquiry message that makes a request for a capability report to the UE in the connected state. The message may include a UE capability request for each radio access technology (RAT) type of the base station. The request for each RAT type may include supported frequency band combination information. In addition, in the case of the UE capability enquiry message, UE capability for each of a plurality of RAT types may be requested through one RRC message container transmitted by the base station or the base station may include the UE capability enquiry message including the UE capability request for each RAT type multiple times and transmit the same to the UE. For example, the UE capability enquiry is repeated multiple times within one message and the UE may constitute a UE capability information message corresponding thereto and report the same multiple times. In the next-generation mobile communication system, a UE capability request for NR, LTE, E-UTRA-NR dual connectivity (EN-DC), and multi-RAT dual connectivity (MR-DC) may be made. In addition, the UE capability enquiry message is generally transmitted initially after the UE is connected to the base station, but may be requested at any time when the base station needs the same.

The UE that has received the UE capability report request from the base station in the above operation constitutes UE capability according to RAT type and band information requested by the base station. Hereinafter, a method by which the UE constitutes the UE capability in the NR system is summarized.

1. When the UE receives a list of LTE and/or NR bands from the base station through a UE capability request, the UE constitutes a band combination (BC) for EN-DC and NR stand alone (SA). For example, the UE constitutes a candidate list of BCs for EN-DC and NR SA based on bands in FreqBandList requested to the base station. In addition, the bands sequentially have priorities as stated in FreqBandList.

2. When the base station sets a “eutra-nr-only” flag or a “eutra” flag and makes a request for the UE capability report, the UE completely removes NR SA BCs from the constituted candidate list of BCs. Such an operation may occur only in case that the LTE base station (eNB) makes a request for a “eutra” capability.

3. Thereafter, the UE removes fallback BCs from the candidate list of BCs constituted in the above operation. The fallback BC refers to a BC which can be acquired by removing a band corresponding to at least one SCell from a predetermined BC, and a BC before the removal of the band corresponding at least one SCell can already cover the fallback BC and thus the fallback BC can be omitted. This operation is applied to MR-DC, that is, LTE bands. BCs left after the operation correspond to a final “candidate BC list”.

4. The UE selects BCs suitable for a requested RAT type in the final “candidate BC list” and selects BCs to be reported. In this operation, the UE constitutes supportedBandCombinationList according to a determined order. For example, the UE constitutes BCs and UE capability to be reported according to an order of a preconfigured rat-Type (nr->eutra-nr->eutra). the UE constitutes featureSetCombination for the constituted supportedBandCombinationList and constitutes a list of “candidate feature set combination” in a candidate BC list from which a list for fallback BCs (including capability at the same or lower stage) is removed. The “candidate feature set combination” may include all feature set combinations for NR and EUTRA-NR BCs, and may be acquired from a feature set combination of UE-NR-Capabilities and UE-MRDC-Capabilities containers.

5. In addition, when the requested rat Type is eutra-nr and influences, featureSetCombinations are included in all of the two containers of UE-MRDC-Capabilities and UE-NR-Capabilities. However, the NR feature set includes only UE-NR-Capabilities.

After the UE capability is constituted, the UE transmits a UE capability information message including the UE capability to the base station. Thereafter, the base station performs scheduling and transmission/reception management suitable for the corresponding UE based on the UE capability received from the UE.

Hereafter, embodiments of the disclosure will be described with reference to accompanying drawings. The content of the disclosure may be applied to frequency division duplex (FDD) and TDD systems. Hereafter, higher signaling (or higher layer signaling) in the disclosure is a method for delivering a signal from a base station to a UE by using a downlink data channel of a physical layer or from a UE to a base station by using an uplink data channel of the physical layer, and may be referred to as RRC signaling, PDCP signaling, or medium access control (MAC) control element (CE).

Hereafter, in the disclosure, when the UE determines whether to apply the cooperative communication, the UE may use various methods, such as applying a specific format to PDCCH(s) for allocating a PDSCH to which the cooperative communication is applied, including a specific indicator indicating whether the PDCCH(s) for allocating the PDSCH to which the cooperative communication is applied applies the cooperative communication, scrambling the PDCCH(s) for allocating the PDSCH to which the cooperative communication is applied with a specific RNTI, or assuming the cooperative communication applied in a specific interval indicated by a higher layer. For convenience of description below, receiving at the UE the PDSCH to which the cooperative communication is applied based on the above similar conditions may be referred to as an NC-JT case.

Hereafter, determining the priority between A and B in the disclosure may be variously mentioned, such as selecting one having a higher priority according to a predefined priority rule and performing a corresponding operation or omitting or dropping an operation on one having a lower priority.

Hereafter, the examples are described through a plurality of embodiments in the disclosure but are not independent, and one or more embodiments may be applied simultaneously or in combination.

Hereinafter, for convenience of description, a cell, a transmission point, a panel, a beam, and/or a transmission direction which can be distinguished through a higher layer/L1 parameter, such as a TCI state or spatial relation information, a cell ID, a TRP ID, or a panel ID may be described as a transmission reception point (TRP), a beam, or a TCI state as a whole. Therefore, during actual application, a TRP, a beam, or a TCI state may be appropriately replaced with one of the above terms.

Hereinafter, in the disclosure, the UE may use various methods to determine whether or not to apply cooperative communication, for example, PDCCH(s) that allocates a PDSCH to which cooperative communication is applied have a specific format, or PDCCH(s) that allocates a PDSCH to which cooperative communication is applied include a specific indicator indicating whether or not to apply cooperative communication, or PDCCH(s) that allocates a PDSCH to which cooperative communication is applied are scrambled by a specific RNTI, or cooperative communication application is assumed in a specific interval indicated by a higher layer. Hereinafter, for convenience of description, a case in which the UE receives a PDSCH to which cooperative communication is applied, based on conditions similar to those described above is referred to as NC-JT case.

Hereinafter, embodiments of the disclosure will be described with reference to the accompanying drawings. Hereinafter, a base station refers to an entity that allocates resources to a terminal, and may be at least one of a gNode B, a gNB, an eNode B, a node B, a base station (BS), a radio access unit, a base station controller, and a node on a network. A terminal may include user equipment (UE), a mobile station (MS), a cellular phone, a smart phone, a computer, or a multimedia system capable of performing a communication function. Hereinafter, although embodiments of the disclosure will be described with reference to a 5G system as an example, embodiments of the disclosure are also applicable to other communication systems having similar technical backgrounds or channel types. For example, LTE or LTE-A mobile communications and mobile communication technologies developed after 5G may be included therein. Therefore, embodiments of the disclosure are also applicable to other communication systems through a partial modification without substantially deviating from the scope of the disclosure as deemed by those skilled in the art. The content in the disclosure is applicable in FDD and TDD systems.

In addition, in the following description of the disclosure, detailed descriptions of related functions or constitutions will be omitted in case that such descriptions are deemed to unnecessarily obscure the gist of the disclosure. The terminology used herein is defined in view of functions in the disclosure, and may be varied depending on the intent of the user/operator, practices, and the like. Therefore, the definition thereof is to be made based on the overall context of the disclosure.

In the following description of the disclosure, higher layer signaling may refer to signaling corresponding to at least one among the following signaling, or a combination of one or more thereof.
Master information block (MIB)
System information block (SIB) or SIB X (X=1, 2, . . . )
Radio resource control (RRC)
Medium access control (MAC) control element (CE).

In addition, L1 signaling may refer to signaling corresponding to at least one among signaling methods using the following physical layer channel or signaling, or a combination of one or more thereof.
Physical Downlink Control Channel (PDCCH)
Downlink Control Information (DCI)
UE-specific DCI;
Group common DCI;
Common DCI;
Scheduling DCI (for example, DCI used for the purpose of scheduling downlink or uplink data)
Non-scheduling DCI (for example, DCI not used for the purpose of scheduling downlink or uplink data)
Physical Uplink Control Channel (PUCCH)
Uplink Control Information (UCI).

Hereafter, determining the priority between A and B in the disclosure may be variously mentioned, such as selecting one having a higher priority according to a predefined priority rule and performing a corresponding operation or omitting or dropping an operation on one having a lower priority.

As used herein, the term “slot” may generally refer to a specific time unit corresponding to a transmit time interval (TTI), may specifically refer to a slot used in a 5G NR system, or may refer to a slot or a subframe used in a 4G LTE system.

Hereinafter, the above examples may be described through multiple embodiments of the disclosure, but they are not independent of each other, and one or more embodiments may be applied simultaneously or in combination.

As described above, SRS carrier switching is used to estimate a downlink channel by transmitting an SRS with respect to a supporting cell (or carrier) in which PUSCH/PUCCH transmission is not configured in a TDD system, that is, a carrier that supports only downlink reception. In the following description of various embodiments of the disclosure, performing or transmitting SRS carrier switching may be interpreted as having the same meaning as transmitting an SRS in a carrier that supports only downlink reception through SRS carrier switching. Since channel reciprocity is established between an uplink channel and a downlink channel, the base station may acquire downlink channel information between the base station and the UE based on the uplink channel estimated through the received SRS. In a carrier that supports only downlink reception, the UE may only have a component for reception and may not have an RF chain for transmission or the like. Therefore, in order to transmit an SRS in the corresponding downlink-dedicated carrier, the UE may temporarily borrow an RF chain of another carrier that may transmit an uplink channel and use the same to transmit an SRS of the downlink-dedicated carrier. For the convenience of explanation, a carrier capable of uplink transmission where an RF chain exists is defined as c2 (or a source cell or a source CC or a victim cell or a victim CC), and a downlink-dedicated carrier on which SRS carrier switching is performed is defined as c1 (or a target cell or a target CC). In this case, a temporary restriction is occurred on uplink channel transmission for c2 (all carriers affected by the RF chain as well as carrier c2 may be considered, and may be expressed as a set S (c2)) associated with an RF chain used to transmit SRS to c1. If the corresponding RF chain does not support the function of simultaneously transmitting uplink channels to a plurality of carriers, the transmission of uplink channel to c2 (or all carriers of the set S (c2) including c2) may not be performed during a time interval in which the RF chain is used for SRS transmission of c1 (the corresponding time interval may include not only the time for transmitting the SRS but also the time for tuning the RF chain to suit the carrier). If SRS transmitted from c1 and uplink channel transmitted from c2 (e.g., PUCCH or PUSCH or SRS, or the like,) are scheduled for the same time resource, the UE may select and transmit either SRS transmitted from c1 or uplink channel transmitted from c2 according to the defined priority and drop the other.

If the UE performs SRS carrier switching on c1, the UE may transmit SRS resource(s) of the SRS resource set having usage configured to ‘antennaSwitching’ on c1 using the RF chain borrowed from c2. The SRS for the purpose of antenna switching may be transmitted through respective reception antennas of the UE as described above and may be used by the base station to acquire downlink channel information through channel reciprocity. Similarly, the base station may perform SRS carrier switching on c1 that does not support PUSCH/PUCCH transmission by using the SRS resource set having usage configured to ‘antennaSwitching’. This is because in terms of using SRS to acquire downlink channel information, an SRS resource set having usage that may support the same function must be used. The difference between SRS antenna switching and SRS carrier switching is that performing SRS carrier switching requires an additional process of tuning the RF chain to be suitable for SRS transmission of the corresponding carrier. Except the difference, SRS antenna switching and SRS carrier switching may operate similarly in terms of using SRS to acquire downlink channel information.

In order to acquire downlink channel information using SRS carrier switching in c1 where PUSCH/PUCCH transmission is not configured in a TDD system, SRS may be scheduled using various time-domain behaviors, and more particularly, in order to support DCI-based aperiodic SRS triggering, DCI format 1_1 or DCI format 1_2 may be used as well as DCI format 2_3. If the base station triggers SRS carrier switching using DCI format 2_3, the UE may simultaneously schedule SRS carrier switching for a plurality of CCs configured as higher layer parameters, and sequentially tune RF chains according to defined rules to transmit SRS on respective CCs. In this case, the defined rule may be defined to sequentially perform SRS carrier switching according to the order of CCs configured as higher layer parameters. For example, if the UE performs SRS carrier switching for c1_1 and c1_2 and c1_1 is configured earlier than c1_2 in the configuration structure of higher layer parameters (for example, it may be configured earlier in the order of the configuration sequence or may be configured to a lower index value), the UE may perform SRS carrier switching on c1_1 first and then perform SRS carrier switching on c1_2. If the base station may trigger SRS carrier switching using DCI format 1_1 or 1_2, the base station may schedule SRS carrier switching to be performed with one supporting cell (or carrier) indicated by DCI format 1_1 or 1_2, unlike SRS carrier switching triggered by DCI format 2_3. For example, the base station may schedule a plurality of SRS carrier switchings for a plurality of carriers with DCI format 2_3 and schedule a single SRS carrier switching for a single carrier with DCI format 1_1 or 1_2.

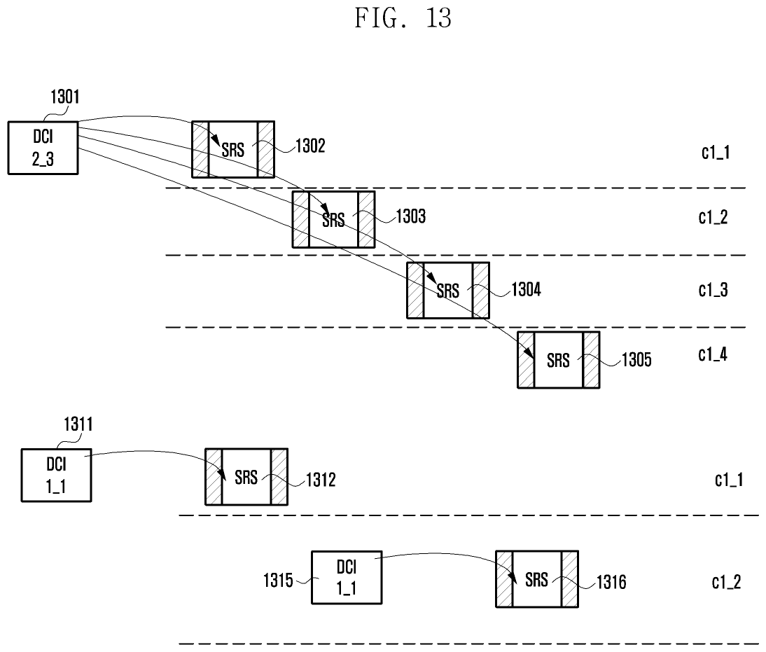

FIG. 13 illustrates aperiodic SRS carrier switching scheduling according to an embodiment of the disclosure.

Referring FIG. 13, a base station may transmit DCI format 2_3 1301 to a UE. One DCI format 2_3 1301 may schedule the UE to sequentially perform a plurality of SRS carrier switching 1302, 1303, 1304, 1305 on a plurality of carriers (e.g., c1_1 and c1_2 and c1_3 and c1_4). As another example, the base station may transmit DCI format 1_1 1311, 1315 to the UE. The first DCI format 1_1 1311 may schedule the UE to perform single SRS carrier switching 1312 on a single carrier c1_1. Another second DCI format 1_1 1315 may schedule the UE to perform single SRS carrier switching 1316 on another single carrier c1_2.

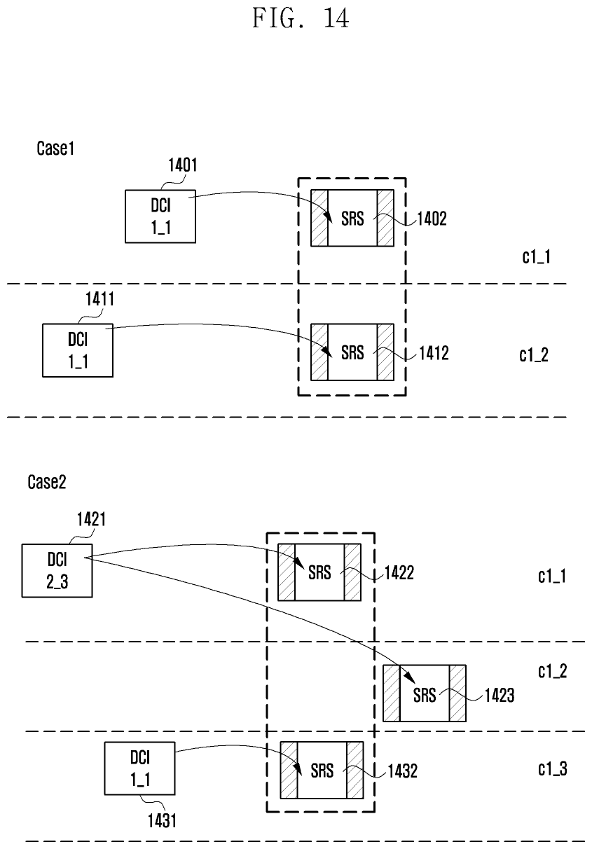

FIG. 14 is a diagram illustrating aperiodic SRS switching scheduled on the same time resource according to an embodiment of the disclosure.

Referring FIG. 14, a first example shows a case where a base station schedules a UE to perform SRS carrier switchings 1402 and 1412 with two carriers in the same time resource by transmitting two DCI format 1_1 1401 and 1411 on two different carriers c1_1 and c1_2. If respective RF chains are required to perform the SRS carrier switchings 1402 and 1412 (i.e., two different RF chains are required in the corresponding example), the UE may borrow RF chains from at least two different carriers and perform tuning them to c1_1 and c1_2, respectively, to transmit SRS. If the UE is implemented with only two or fewer RF chains for uplink transmission, the UE may not be able to perform two different SRS carrier switchings scheduled on the same time resource simultaneously, as in the first case. On the other hand, if the UE is implemented with two or more RF chains for uplink transmission and may perform turning them to transmit SRS (all SRS resources in the SRS resource set having usage configured to ‘antennaSwitching’) simultaneously for c1_1 and c1_2, then two different SRS carrier switchings scheduled for the same time resource may be performed simultaneously, as in the first case. In this case, additional UE capability may be required for the UE to perform tuning two RF chains simultaneously, and some additional capability may be required for performing SRS carrier switchings simultaneously.

In a second example, the base station schedules the UE to sequentially perform two SRS carrier switchings 1422 and 1423 on two different carriers c1_1 and c1_2 with DCI format 2_3 1421. Further, the base station may transmit, to the UE, DCI format 1_1 1431 so that SRS carrier switching 1432 is performed on another carrier c1_3 in the same time resource as one SRS carrier switching 1422 of the two SRS carrier switchings scheduled with DCI format 2_3 1421. For example, the UE may receive DCI format 2_3 1421 and DCI format 1_1 1431 from the base station and be scheduled to perform two different SRS carrier switchings 1422 and 1432 on different carriers c1_1 and c1_3 in the same time resource.

As in the two examples illustrated in FIG. 14, the base station may transmit to the UE a DCI for scheduling the UE to perform different SRS carrier switchings on the plurality of different carriers in the same time resource. In this case, the UE may or may not perform a plurality of SRS carrier switchings simultaneously depending on the UE implementation. If the UE may perform a plurality of SRS carrier switchings simultaneously and reports the UE capability for simultaneous SRS carrier switchings to the base station, the base station will be able to schedule as many SRS carrier switchings as the UE can perform in the same time resource so as to acquire downlink channel information more quickly. Alternatively, if the UE may not perform a plurality of SRS carrier switchings simultaneously or does not report the UE capability for simultaneous SRS carrier switching to the base station, the base station may determine that the UE cannot perform simultaneous SRS carrier switchings and may avoid scheduling a plurality of SRS carrier switchings in the same time resource through scheduling constraints or should support the UE to select the SRS carrier switching to be performed without ambiguity by introducing a new priority rule in case of overlap.

In a first embodiment of the disclosure, a UE capability for simultaneously supporting a plurality of SRS carrier switchings for a plurality of carriers according to a UE capability is defined, and a transmission/reception operation between the base station and the UE according to whether or not the corresponding UE capability is reported will be specifically described. In a second embodiment of the disclosure, a method for determining SRS carrier switching to be performed by a UE according to an overlapping rule (such as an overlapping rule or a dropping rule) according to priority in case that a plurality of SRS carrier switchings for a plurality of carriers are scheduled for the same time resource will be specifically described. In a third embodiment of the disclosure, a method for a base station to restrict specific scheduling in order to avoid a scheduling situation in which a plurality of SRS carrier switchings are simultaneously performed in the same time resource will be specifically described.

### First Embodiment: Method for Supporting Simultaneous SRS Carrier Switchings on a Plurality of CA Carriers Based on UE Capability Report

In a first embodiment of the disclosure, in case that a base station schedules a UE such that carrier aggregation (CA) where a plurality of carriers are aggregated is supported and SRS carrier switchings are simultaneously performed on a plurality of downlink-dedicated carriers in the same time resource, UE capability for simultaneously performing a plurality of SRS carrier switchings is specifically presented. In addition, when the UE reports UE capability for performing a plurality of SRS carrier switchings simultaneously to the base station, a method for scheduling higher layer parameters and SRS carrier switching configured by the base station to the UE will be specifically described.

In order for the UE to perform a plurality of different SRS carrier switchings on a plurality of carriers simultaneously, the UE must first transmit a plurality of SRSs simultaneously. As described above, when the UE performs SRS carrier switching, after tuning an RF chain to a downlink-dedicated carrier, the UE transmits an SRS resource set having usage of ‘antennaSwitching’ to the base station through a downlink-dedicated carrier. After receiving the SRS for the purpose of antenna switching, the base station estimates the uplink channel for the downlink-dedicated carrier of the corresponding UE and acquires downlink channel information using the reciprocity of the estimated uplink channel. Therefore, at least the UE must have the UE capability to simultaneously transmit the SRSs for the purpose of antenna switching for the plurality of CA carriers.

Depending on the CA technique supported by the UE, the UE capability to support simultaneous performance of a plurality of SRS carrier switching on a plurality of CA carriers may be specifically defined. The specific UE capability may be defined by distinguishing between a case where the UE supports intra-band CA and a case where the UE supports inter-band CA.

### Embodiment 1-1: In Case that a UE Supports Intra-Band CA, a Method for Defining UE Capability to Support Simultaneous SRS Carrier Switchings on a Plurality of CA Carriers and Operations of a UE and Base Station According to UE Capability Report

In an embodiment 1-1, in case that a UE supports intra-band CA, UE capability required to perform (or transmit) a plurality of SRS carrier switching on a plurality of CA carriers simultaneously is proposed. In addition, it is described the operations of the base station and UE according to whether the UE supports a technique for performing a plurality of SRS carrier switchings on a plurality of CA carriers simultaneously.

Before defining the UE capability for performing a plurality of SRS carrier switching on a plurality of CA carriers simultaneously for a UE supporting intra-band CA, the UE capability that allows the UE to perform SRS antenna switching on different carriers simultaneously in an intra-band CA environment is required. First, the UE must be implemented to operate with intra-band CA, and the corresponding UE may notify the base station that the UE may support intra-band CA through a UE capability report. In this way, the UE may report the UE capability related to CA to the base station through a higher layer parameter supportedBandCombinationList, and the like. If the UE may independently transmit SRS for antenna switching on different CCs according to the UE's implementation method, the UE may report the UE capability to the base station that the UE may perform SRS antenna switchings for intra-band CA simultaneously. For example, if the UE may operate separate RF chains for a plurality of carriers within the same band supporting intra-band CA, and even if the antenna is switched to perform SRS antenna switching for any one carrier, the UE may report the UE capability to the base station that it may perform a plurality of SRS antenna switchings for the corresponding band if it does not affect the operation of RF chains of other carriers or only causes an acceptable level of interference. In case that the UE can simultaneously transmit a plurality of SRS antenna switchings in the intra-band CA situation, the following UE capability can be configured to {supported} and reported to the base station:

For simulTX-SRS-AntSwitchingIntraBandUL-CA, the following items among the detailed parameters in SimulSRS-ForAntennaSwitching are configured to {supported} and reported to the base station. The detailed parameters are as follows:

supportSRS-AntennaSwitching: If the UE supports intra-band CA and may perform a plurality of antenna switchings on a plurality of different carriers simultaneously according to the UE capability report, the corresponding UE capability may be configured to {supported} and reported to the base station. In this case, the UE may expect that switching combinations between the transmission and reception antennas for the plurality of SRS antenna switchings performed simultaneously across the plurality of CCs (configured as xTyR, where x means the number of transmission antennas and y means the number of reception antennas) are configured identically. In addition, the UE may transmit SRS resources transmitted across the plurality of CCs that overlap in the time domain through the same UE antenna port. Alternatively, according to a more advanced UE implementation, the switching combination xTyR between the transmission and reception antennas for the plurality of SRS antenna switchings performed simultaneously across the plurality of CCs may be configured to different values. In addition, the UE may constitute the SRS resources transmitted across the plurality of CCs overlapping in the time domain with different UE antenna ports, depending on the UE implementation, and transmit the same.

The UE may report the above UE capability to the base station as a prerequisite for one of the UE capability reports performed to inform the base station that the UE may support the simultaneous transmission method of the plurality of SRS carrier switching in the intra-band CA situation. The UE that does not support the above UE capability to perform the SRS antenna switchings simultaneously may not perform the plurality of SRS carrier switchings on the plurality of CA carriers simultaneously in the intra-band CA situation. Alternatively, depending on the UE implementation, in the intra-band CA situation, the UE may not perform SRS antenna switchings simultaneously, but may perform SRS carrier switchings simultaneously. However, in this embodiment of the disclosure, it is assumed that the UE capability to perform the plurality of SRS antenna switchings simultaneously should be supported as a prerequisite for the method for performing the plurality of SRS carrier switchings simultaneously.

In order for the UE to perform the plurality of SRS carrier switchings on the plurality of CA carriers simultaneously in the intra-band CA situation, additional UE capability may be required in addition to the UE capability related to CA and the UE capability related to performing SRS antenna switchings simultaneously as described above. First, the UE must have the UE capability to support SRS carrier switching in advance. In order to prepare for the plurality of SRS carrier switchings to be transmitted in the same time resource, the UE capability for RF tuning within a time interval and the UE capability for re-tuning an RF to the originally supported carrier within a time interval after performing the plurality of SRS carrier switchings may be required. The RF tuning time performed by the UE before and after performing the plurality of SRS carrier switchings simultaneously may be reported as a value that is equal to or greater than the RF tuning time performed before and after performing a single SRS carrier switching (e.g., switchingTimeUL and switchingTimeDL included in SRS-SwitchingTimeNR). In this way, the RF tuning time required to perform the plurality of SRS carrier switchings simultaneously may be constituted as a component of a higher layer parameter for reporting new UE capability for performing the SRS carrier switchings simultaneously:

Higher layer parameter for reporting new UE capability to perform a plurality of SRS carrier switchings simultaneously (for example, it may be determined as any name to indicate that the plurality of SRS carrier switchings may be transmitted simultaneously in an intra-band CA environment, such as, simulTx-SRS-CarrierSwitchingIntraBandUL-CA or simulTx-SRS-CarrierSwitchingIntraBand, and the like.)

Higher layer parameter for reporting RF tuning time required to perform a plurality of SRS carrier switchings simultaneously (for example, it may be determined as any name to indicate the time (that may be in the unit of us) required to perform RF tuning for a plurality of (or single depending on the UE implementation) RF chains of the UE, such as, switching TimeUL and switching TimeDL or additionalSwitchingTimeUL and additionalSwitchinTimeDL, and the like)

The UE capability for supporting only the case of fully overlapping or only partially overlapping or both fully/partially overlapping cases of a plurality of overlapping SRS carrier switchings in time domain resources may be reported as a separate UE capability or as components of a higher layer parameter for reporting new UE capability for simultaneous transmission of the corresponding plurality of SRS carrier switchings. Here, the overlapping may be considered not only for the time of transmitting SRS for antenna switching purposes, but also for the RF tuning time performed before and after SRS transmission.

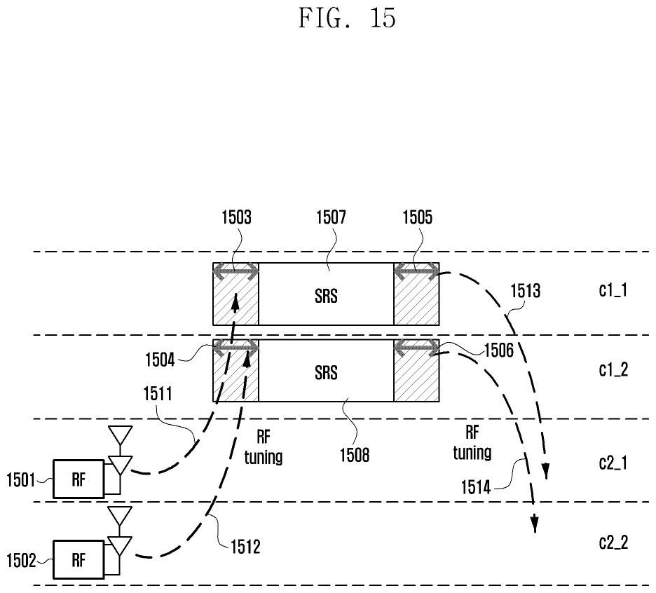

FIG. 15 is a diagram illustrating a process for tuning an RF chain and a process for transmitting an SRS in case of transmitting a plurality of SRS carrier switchings simultaneously in intra-band CA according to an embodiment of the disclosure.

Referring to FIG. 15, it is assumed that a UE may support intra-band CA, and that the UE supports both uplink transmission and downlink reception for a plurality of carriers c2_1 and c2_2 and only downlink reception for the remaining plurality of carriers c1_1 and c1_2. In this case, it is assumed that respective RF chains 1501 and 1502 may be operated for the carriers c2_1 and c2_2 that support both uplink transmission and downlink reception. This is only an example, and depending on the UE implementation scheme, one RF chain may be used to support two carriers c2_1 and c2_2. A base station may schedule with respect to the plurality of carriers c1_1 and c1_2 such that a plurality of SRS carrier switchings 1507 and 1508 are performed in the same time resource, with, such as a plurality of DCI formats 1_1 or a combination of DCI formats 2_3 and 1_1. The UE may prepare to transmit an SRS by tuning 1511 an RF from one operable carrier (e.g., c2_1) of the RF chain (e.g., 1501) to a carrier (e.g., c1_1) on which SRS carrier switching (e.g., 1507) is to be performed. Similarly, another RF chain (e.g., 1502) may prepare to transmit an SRS by tuning 1512 an RF from one operable carrier (e.g., c2_2) to a carrier (e.g., c1_2) on which SRS carrier switching (e.g., 1508) is to be performed. In this case, in order to simultaneously perform the plurality of SRS carrier switchings 1507 and 1508 on the plurality of carriers c1_1 and c1_2, the UE may perform RF tuning before transmitting the SRS. The RF tuning 1511 or 1512 for simultaneously performing two SRS carrier switchings may be performed simultaneously or sequentially as illustrated in FIG. 15. In a certain case (simultaneous RF tuning performance or sequential RF tuning performance), a UE capability report must be performed in advance to ensure that the SRS carrier switchings may be performed simultaneously in the same time resource. Whether the RF tuning 1511 or 1512 is supported simultaneously or sequentially may be reported to the base station as UE capability through the higher layer parameters (e.g., switchingTimeUL and switching TimeDL or additionalSwitchingTimeUL and additionalSwitchinTimeDL) for reporting the RF tuning time 1503 or 1504 required to simultaneously perform the aforementioned plurality of SRS carrier switchings. Alternatively, instead of introducing the higher layer parameters for reporting separate RF tuning times, the existing switchingTimeUL and switchingTimeDL may be reported as the RF tuning time and the UE may be defined to support the capability of performing RF tunings simultaneously. If the UE completes the RF tuning for performing SRS carrier switchings simultaneously within a given time, the UE may transmit SRS resource sets 1507 and 1508 for a plurality of antenna switching purposes to the plurality of carriers c1_1 and c1_2 simultaneously. After the UE performs all of the SRS carrier switchings 1507 and 1508 scheduled to the plurality of carriers c1_1 and c1_2 according to the UE capability, the UE may tune 1513, 1514 the RF chains 1501 and 1502 to be available for uplink transmission on the carriers c2_1 and c2_2. In this case, the RF tuning may be performed simultaneously or sequentially as illustrated in FIG. 15. In a certain case (simultaneous RF tuning performance or sequential RF tuning performance), the UE capability report must be performed first to ensure that SRS carrier switchings may be performed simultaneously in the same time resource. Similarly, in order to report the UE capability for the RF tuning time 1505 or 1506 of each case, higher upper layer parameters (e.g., switching TimeUL or and switchingTimeDL additionalSwitchingTimeUL and additionalSwitchinTimeDL) may be defined and the UE may configure values for these and report the same to the base station. Alternatively, instead of introducing the higher layer parameters for reporting a separate RF tuning time, the existing switchingTimeUL and switchingTimeDL may be reported as the RF tuning time and the UE may be defined to support the capability of performing RF tunings simultaneously.

In the case of intra-band carrier aggregation (CA), SRS (or SRS resource) for more than one SRS carrier switching may be transmitted simultaneously on different CCs (component carriers or carriers or bands) depending on the UE's capability.

The above operation of the UE describes a case where the UE simultaneously performs the SRS carrier switchings without configuring additional RRC parameters in case that the UE supports the UE capability to perform the corresponding plurality of SRS carrier switchings simultaneously and the base station schedules the plurality of SRS carrier switchings to be performed simultaneously in the same time resource. In contrast to this method, the base station may configure new RRC parameters to the UE in order to support performing a plurality of SRS carrier switchings on a plurality of carriers. If the UE reports to the base station that the UE may support UE capability to support simultaneous performance of a plurality of SRS carrier switchings on a plurality of carriers in case of intra-band CA, the base station may configure, for the UE, an RRC parameter (which may be defined as a parameter with a name to express the corresponding operation, such as enableSimulTx_SRSCarrierSwitching or enable_multipleCarrierSwitching) with a value, such as {supported} or {enabled}. If the base station does not configure, for the UE, the RRC parameter to support simultaneous performance of the plurality of SRS carrier switchings even though the base station has received the UE capability to support simultaneous performance of the plurality of SRS carrier switchings from the UE, the UE may not expect the base station to schedule simultaneous performance of the plurality of SRS carrier switchings on the plurality of carriers in the same time resource. If the UE does not report the UE capability to the base station to support simultaneous performance of the plurality of SRS carrier switchings, the base station does not configure, for the UE, the RRC parameter to support simultaneous performance of the plurality of SRS carrier switchings.

In the example described in Embodiment 1-1, it is assumed that the DCI for scheduling to perform the plurality of SRS carrier switchings simultaneously satisfies all timeline conditions for determining whether the UE is going to perform SRS carrier switching. Here, the timeline condition means to guarantee a time greater than or equal to a sum of the time N₂ required to decode the DCI and complete SRS transmission preparation before transmitting the first SRS transmitted during SRS carrier switching based on the last received symbol of the PDCCH including the DCI, and the time T_{SRS}_{_{CS}} required to tune the RF to perform SRS carrier switching (here, T_{SRS}_{_{CS}} may be defined as the largest value among the values considering max {switchingTimeUL, switchingTimeDL} or all of the additional tuning times defined above).

### Embodiment 1-2: In Case that a UE Supports Intra-Band CA, a Method for Defining UE Capability to Support Simultaneous SRS Carrier Switchings on a Plurality of CA Carriers and Operations of a UE and Base Station According to UE Capability Report

In an embodiment 1-2, in case that a UE supports intra-band CA, UE capability required to perform a plurality of SRS carrier switching on a plurality of CA carriers simultaneously is proposed. In addition, it is described the operations of the base station and UE according to whether the UE supports a technique for performing a plurality of SRS carrier switchings on a plurality of CA carriers simultaneously.

Before defining UE capability to perform (or transmit) a plurality of SRS carrier switching on a plurality of CA carriers simultaneously for the UE supporting inter-band CA, UE capability that allows the UE to perform SRS antenna switchings on different carriers simultaneously in an inter-band CA environment is required. First, the UE must be implemented to operate as inter-band CA, and the corresponding UE may notify the base station that the UE may support inter-band CA through a UE capability report. In this way, the UE may report the UE capability related to CA to the base station through a higher layer parameter supportedBandCombinationList, and the like. If the UE may independently transmit SRS for antenna switching in different bands and CCs within respective bands according to the UE implementation method, the UE may report the UE capability to the base station that the UE may perform SRS antenna switchings for inter-band CA simultaneously. For example, if the UE may operate separate RF chains for the plurality of carriers of a band combination that supports inter-band CA, and if switching antennas to perform SRS antenna switching on one carrier does not affect the operation of RF chains of other carriers or causes only an acceptable level of interference, the UE may report the UE capability to the base station that the UE may perform the plurality of SRS antenna switchings on the plurality of CA carriers within the band combination. In case that the UE may simultaneously transmit the plurality of SRS antenna switchings in an inter-band CA situation, the following UE capability may be configured to {supported] and reported to the base station:

For simulTX-SRS-AntSwitchingInterBandUL-CA, the following items among the detailed parameters in SimulSRS-ForAntennaSwitching are configured to {supported} and reported to the base station. The detailed parameters are as follows:

supportSRS-AntennaSwitching: If the UE supports inter-band CA and may perform a plurality of antenna switchings on carriers of different bands simultaneously according to the corresponding UE capability report, the corresponding UE capability may be configured to {supported} and reported to the base station. In this case, the UE may expect that switching combinations between the transmission and reception antennas for the plurality of SRS antenna switchings transmitted simultaneously across the plurality of CCs of the combined bands (configured as xTyR, where x means the number of transmission antennas and y means the number of reception antennas) are configured identically. In addition, the UE may transmit, to the same UE antenna port, the SRS resources transmitted across the plurality of CCs of the combined bands that overlap in the time domain. Alternatively, according to a more advanced UE implementation, the switching combination xTyR between the transmission and reception antennas for the plurality of SRS antenna switchings transmitted simultaneously across the plurality of CCs of the combined bands may be configured to different values. In addition, the UE may constitute the SRS resources transmitted across the plurality of CCs of the combined band overlapping in the time domain with different UE antenna ports depending on the UE implementation and transmit the same.

The UE may report the above UE capability to the base station as a prerequisite for one of the UE capability reports performed to inform the base station that the UE may support the simultaneous transmission method of the plurality of SRS carrier switching in the inter-band CA situation. The UE that does not support the above UE capability to perform the SRS antenna switchings simultaneously may not perform the plurality of SRS carrier switchings on the plurality of CA carriers for a combination of a plurality of bands simultaneously in the inter-band CA situation. Alternatively, depending on the UE implementation, in the inter-band CA situation, the UE may not perform SRS antenna switchings simultaneously, but may perform SRS carrier switchings simultaneously. However, in this embodiment of the disclosure, it is assumed that the UE capability to perform the plurality of SRS antenna switchings simultaneously should be supported as a prerequisite for the method for performing the plurality of SRS carrier switchings simultaneously.

In order for the UE to perform the plurality of SRS carrier switchings on the plurality of CA carriers of a combination of a plurality of bands simultaneously in the inter-band CA situation, additional UE capability may be required in addition to the UE capability related to CA and the UE capability related to performing SRS antenna switchings simultaneously as described above. First, the UE must have the UE capability to support SRS carrier switching in advance.

In the case of inter-band CA, unlike the case where intra-band CA is supported, when the UE performs SRS carrier switching in one of the bands combined by inter-band CA, the UE may report to the base station the bands that may be affected in uplink channel transmission due to SRS carrier switching. If SRS carrier switching performed in one of the bands combined by inter-band CA affects another band, a restriction occurs that the UE cannot transmit uplink channels through the other bands while performing SRS carrier switching in one band. In order for the UE to support inter-band CA and simultaneously perform the plurality of SRS carrier switchings on the plurality of CA carriers of the combined bands, the UE should be able to transmit uplink channels in the other bands while performing SRS carrier switching in one band. Therefore, in case of supporting inter-band CA, performing SRS carrier switching in one of the combined bands should not affect the other bands. Furthermore, the UE may perform UE capability report so that the base station may determine that the UE may transmit an uplink channel through another band even if the UE performs SRS carrier switching on one band for a band combination supporting inter-band CA. For example, as a prerequisite for the UE supporting inter-band CA to support a method for simultaneously performing the plurality of SRS carrier switching through carriers in the plurality of combined bands, the UE should be able to operate without being affected by each other even if it performs SRS carrier switching on any one of the bands in the band combination, and the UE may report the UE capability related to this to the base station. Whether or not other bands in the band combination are affected by performing SRS carrier switching may be reported to the base station through the higher layer parameter srs-SwitchingAffectedBandsListNR. srs-SwitchingAffectedBandsListNR may be reported to the base station by being included in the higher layer parameter (i.e., BandParameters in BandCombination) for reporting the UE capability for a band in a band combination, and may express other bands in the band combination that are affected when performing SRS carrier switching with the corresponding band in the form of a bit string. If the bit for another band combined with the corresponding band is configured to 1 and reported to the base station, it means that the SRS carrier switching performed with the corresponding band affects the other band. If the bit for another band combined with the corresponding band is configured to 0 and reported to the base station, it means that the SRS carrier switching performed with the corresponding band does not affect the other band. Therefore, in order for the UE supporting inter-band CA to support the method for simultaneously performing the plurality of SRS carrier switchings on the plurality of carriers in combined bands, the UE may configure all srs-SwitchingAffectedBandsListNR to 0 for band combinations of the corresponding inter-band CA and report the same to the base station. Alternatively, two or more bits in the bit string of srs-SwitchingAffectedBandsListNR may be configured to 0, and the UE may perform the plurality of SRS carrier switching on the carriers of a plurality of bands that do not affect each other even when SRS carrier switching is performed. In case that two or more bits in the bit string of srs-SwitchingAffectedBandsListNR are configured to 0 and the remaining bits are configured to 1, the UE may not perform the plurality of SRS carrier switchings simultaneously between bands that affect each other when SRS carrier switching is performed. In summary, in order for the UE to perform the plurality of SRS carrier switching on the plurality of carriers of a band combination in an inter-band CA environment, two or more bits in srs-SwitchingAffectedBandsListNR must be reported as 0, and the plurality of SRS carrier switching may be performed simultaneously only through carriers in a band combination that do not affect each other during SRS carrier switching by reporting the bits in srs-SwitchingAffectedBandsListNR as 0. If all band combinations affect each other when performing SRS carrier switching in an inter-band CA environment, i.e., all bits of srs-SwitchingAffectedBandsListNR are reported as 1, the UE may not be able to support simultaneous performance of the plurality of SRS carrier switching for inter-band CA.

In order to prepare for a plurality of SRS carrier switchings that should be performed in the same time resource, the UE capability for RF tuning within a certain time interval and the UE capability for re-tuning an RF chain to suit the originally supported carrier within a certain time interval after performing the plurality of SRS carrier switchings may be required. The RF tuning time performed by the UE before and after performing the plurality of SRS carrier switchings simultaneously may be reported as a value that is equal to or greater than the RF tuning time performed before and after performing a single SRS carrier switching (e.g., switchingTimeUL and switchingTimeDL included in SRS-SwitchingTimeNR). In this way, the RF tuning time required to perform the plurality of SRS carrier switchings simultaneously may be constituted as a component of a higher layer parameter for reporting new UE capability for performing the SRS carrier switchings simultaneously:

Higher layer parameter for reporting new UE capability to perform a plurality of SRS carrier switchings simultaneously (for example, it may be determined as any name to indicate that the plurality of SRS carrier switchings may be transmitted simultaneously in an inter-band CA environment, such as, simulTx-SRS-CarrierSwitchingInterBandUL-CA or simulTx-SRS-CarrierSwitchingInterBand, and the like).

Higher layer parameter for reporting RF tuning time required to perform a plurality of SRS carrier switchings simultaneously (for example, it may be determined as any name to indicate the time (that may be in the unit of us) required to perform RF tuning for a plurality of (or single depending on the UE implementation) RF chains of the UE, such as, switchingTimeUL and switching TimeDL or additionalSwitchingTimeUL and additionalSwitchinTimeDL, and the like).

The UE capability for supporting only the case of fully overlapping or only partially overlapping or both fully/partially overlapping cases of a plurality of overlapping SRS carrier switchings in time domain resources may be reported as a separate UE capability or as components of a higher layer parameter for reporting new UE capability for simultaneous transmission of the corresponding plurality of SRS carrier switchings. Here, the overlapping may be considered not only for the time of transmitting SRS for antenna switching purposes, but also for the RF tuning time performed before and after SRS transmission.

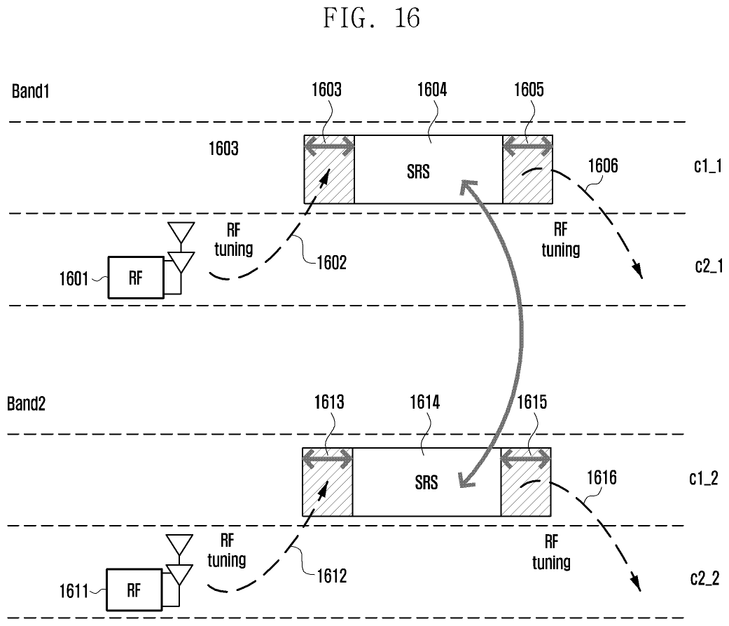

FIG. 16 is a diagram illustrating a process for tuning an RF chain and a process for transmitting an SRS in case of transmitting a plurality of SRS carrier switchings simultaneously in inter-band CA according to an embodiment of the disclosure.

Referring to FIG. 16, it is assumed that a UE may support inter-band CA, and that the UE supports both uplink transmission and downlink reception for carriers c2_1 and c2_2 of a plurality of bands Band 1 and Band 2 and only downlink reception for the remaining carriers c1_1 and c1_2 of the respective band. In this case, it is assumed that respective RF chains 1601 and 1611 may be operated for the carriers c2_1 and c2_2 of two bands that support both uplink transmission and downlink reception. This is only an example, and depending on the UE implementation scheme, one RF chain may be used to support two carriers c2_1 and c2_2. A base station may schedule with respect to the plurality of carriers c1_1 and c1_2 such that a plurality of SRS carrier switchings 1604 and 1614 are transmitted in the same time resource, with, such as a plurality of DCI formats 1_1 or a combination of DCI formats 2_3 and 1_1. The UE may prepare to transmit an SRS by tuning 1602 an RF from one operable carrier (e.g., c2_1 of Band 1) of the RF chain (e.g., 1601) to a carrier (e.g., c1_1) on which SRS carrier switching (e.g., 1604) is to be performed. Similarly, another RF chain (e.g., 1611) may prepare to transmit an SRS by tuning 1612 an RF from one operable carrier (e.g., c2_2) to a carrier (e.g., c1_2) on which SRS carrier switching (e.g., 1614) is to be performed. In this case, in order to simultaneously perform the plurality of SRS carrier switchings 1604 and 1614 on the plurality of carriers c1_1 and c1_2, the UE may perform RF tuning before transmitting the SRS. The RF tuning (1602 or 1612) for simultaneously performing two SRS carrier switchings may be performed simultaneously or sequentially as illustrated in FIG. 16. In a certain case (simultaneous RF tuning performance or sequential RF tuning performance), a UE capability report must be performed in advance to ensure that the SRS carrier switchings may be performed simultaneously in the same time resource. Whether the RF tuning (1602 or 1612) is supported simultaneously or sequentially may be reported to the base station as UE capability through the higher layer parameters (e.g., switchingTimeUL and switchingTimeDL or additionalSwitchingTimeUL and additionalSwitchinTimeDL) for reporting the RF tuning time 1603 or 1613 required to simultaneously perform the aforementioned plurality of SRS carrier switchings. Alternatively, instead of introducing the higher layer parameters for reporting separate RF tuning times, the existing switchingTimeUL and switchingTimeDL may be reported as the RF tuning time and the capability for performing RF tuning simultaneously may be defined so that the UE must support this capability. If the UE completes the RF tuning for performing SRS carrier switchings simultaneously within a given time, the UE may transmit SRS resource sets 1604 and 1614 for a plurality of antenna switching purposes to the plurality of carriers c1_1 and c1_2 simultaneously. After the UE performs all of the SRS carrier switchings 1604 and 1614 scheduled to the plurality of carriers c1_1 and c1_2 according to the UE capability, the UE may tune (1606, 1616) the RF chains 1601 and 1611 to be available for uplink transmission on the carriers c2_1 and c2_2. In this case, the RF tuning may be performed simultaneously or sequentially as illustrated in FIG. 16. In a certain case (simultaneous RF tuning performance or sequential RF tuning performance), the UE capability report must be performed first to ensure that SRS carrier switchings may be performed simultaneously in the same time resource. Similarly, in order to report the UE capability for the RF tuning time 1605 or 1615 of each case, higher layer parameters (e.g., switchingTimeUL and switchingTimeDL or additionalSwitchingTimeUL and additionalSwitchinTimeDL) may be defined and the UE may configure values for these and report the same to the base station. Alternatively, instead of introducing the higher layer parameters for reporting a separate RF tuning time, the existing switchingTimeUL and switchingTimeDL may be reported as the RF tuning time and the UE may be defined to support the capability of performing RF tunings simultaneously.

In the case of intra-band carrier aggregation (CA), SRS (or SRS resource) for more than one SRS carrier switching may be transmitted simultaneously on component carrier (CC) in different bands depending on the UE's capability.

The above operation of the UE describes a case where the UE simultaneously performs the SRS carrier switchings without configuring additional RRC parameters in case that the UE supports the UE capability to perform the corresponding plurality of SRS carrier switchings simultaneously and the base station schedules the plurality of SRS carrier switchings to be performed simultaneously in the same time resource. In contrast to this method, the base station may configure new RRC parameters to the UE in order to support performing a plurality of SRS carrier switchings on a plurality of carriers. If the UE reports to the base station that the UE may support UE capability to support simultaneous performance of a plurality of SRS carrier switchings on the carriers within different bands in case of inter-band CA, the base station may configure, for the UE, an RRC parameter (which may be defined as a parameter with a name to express the corresponding operation, such as enableSimulTx_SRSCarrierSwitching_InterbandCA or enable_multipleCarrierSwitching_InterbandCA) with a value, such as {supported} or {enabled}. If the base station does not configure, for the UE, the RRC parameter to support simultaneous performance of the plurality of SRS carrier switchings even though the base station has received the UE capability to support simultaneous performance of the plurality of SRS carrier switchings from the UE in the inter-band CA environment, the UE may not expect the base station to schedule simultaneous performance of the plurality of SRS carrier switchings on the plurality of carriers in the same time resource. If the UE does not report the UE capability to the base station to support simultaneous performance of the plurality of SRS carrier switchings in the inter-band CA environment, the base station does not configure, for the UE, the RRC parameter to support simultaneous performance of the plurality of SRS carrier switchings.

In the example described in Embodiment 1-2, it is assumed that the DCI for scheduling to perform the plurality of SRS carrier switchings simultaneously satisfies all timeline conditions for determining whether the UE is going to perform SRS carrier switching. Here, the timeline condition means to guarantee a time greater than or equal to a sum of the time N₂ required to decode the DCI and complete SRS transmission preparation before transmitting the first SRS transmitted during SRS carrier switching overlapped based on the last received symbol of the PDCCH including the DCI, and the time T_{SRS}_{_{CS}} required to tune the RF to perform SRS carrier switching (here, T_{SRS}_{_{CS}} may be defined as the largest value among the values considering max {switchingTimeUL, switchingTimeDL} or all of the additional tuning times defined above).

### Second Embodiment: Method for Determining a Carrier Performing SRS Carrier Switching Based on Additional Overlapping Rule

In a second embodiment of the disclosure, in case that a base station schedules a UE such that carrier aggregation (CA) where a plurality of carriers are aggregated is supported and SRS carrier switchings are simultaneously performed on a plurality of downlink-dedicated carriers in the same time resource, a rule for determining which SRS carrier switching to perform by a UE, among a plurality of scheduled SRS carrier switchings will be specifically described.

In case that a plurality of SRS carrier switchings are scheduled to be performed on a plurality of carriers simultaneously in the same time resource according to the second embodiment of the disclosure, before specifically describing a method for determining which SRS carrier switching to perform according to priority, it is assumed that the DCI for scheduling the plurality of SRS carrier switchings to be performed simultaneously satisfies all timeline conditions for determining whether the UE will perform SRS carrier switching. Here, the timeline condition means to guarantee a time greater than or equal to a sum of the time N₂ required to decode the DCI and complete SRS transmission preparation before the SRS carrier switching transmitted first among the overlapping uplink channels or other uplink channel (e.g., PUCCH/PUSCH/SRS) is transmitted, based on the last received symbol of the PDCCH including the DCI, and the time T_{SRS}_{_{CS}} required to tune the RF to perform SRS carrier switching (here, T_{SRS}_{_{CS}} may be defined as the largest value among the values considering max {switchingTimeUL, switchingTimeDL} or all of the additional tuning times defined above).

As in the example illustrated in FIG. 14 specifically described in the first embodiment of the disclosure, the base station may transmit a plurality of DCIs to the UE to schedule SRS carrier switching, and may schedule overlapping SRS carrier switching in which the plurality of DCIs are transmitted in the same time resource. Unlike the first embodiment in which a method for simultaneously performing a plurality of overlapping SRS carrier switchings in the time domain according to UE capability is described, the second embodiment describes a method for determining an SRS carrier switching to be transmitted by the UE among a plurality of overlapping SRS carrier switchings according to a newly defined overlapping rule.

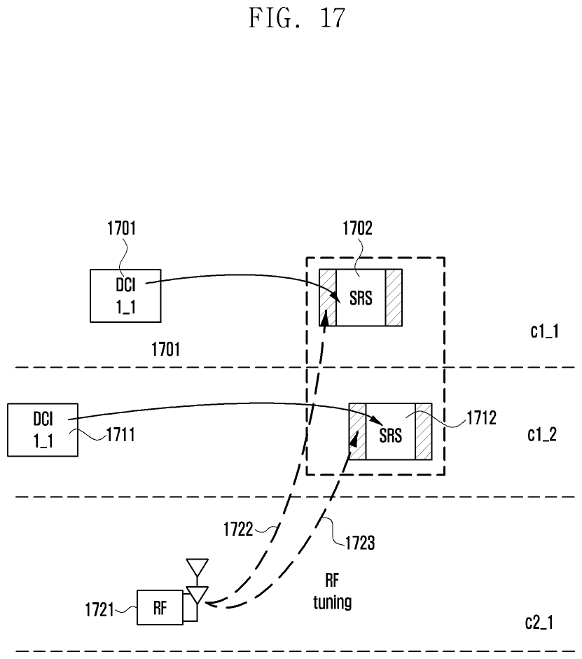

FIG. 17 illustrates a plurality of scheduled SRS carrier switchings according to an embodiment of the disclosure.

Referring to FIG. 17, it is assumed that CA is supported between a plurality of carriers c1_1 and c1_2 that support only downlink reception and a carrier c2_1 that supports both uplink transmission and downlink reception, and the CA may be intra-band CA or inter-band CA. Alternatively, similar to FIG. 16, SRS is scheduled to overlap in the same time resource for each band, and the RF chain may transmit an SRS by borrowing from a carrier that supports both uplink and downlink in the same band as the carrier. Here, it is assumed that a start symbol or last symbol of DCIs 1701 and 1711 received on the two carriers c1_1 and c1_2 are different from each other, and the UE transmits an SRS 1702 scheduled by a DCI 1701 that is to be received later and complete its reception later, earlier than an SRS 1712 scheduled by a DCI 1711 that is to be received earlier and complete its reception earlier. Since the UE illustrated in FIG. 17 may operate only one RF chain 1721 for the corresponding situation, the UE may not be able to simultaneously transmit the two SRSs 1702 and 1712 that overlap in the time domain on the two carriers c1_1 and c1_2. For example, after selectively performing one of the two RF tunings 1722 and 1723, only one of the two SRSs 1702 and 1712 is transmitted. In a situation like FIG. 17, the UE may consider one or a combination of the following additional overlapping rules to select one SRS to be transmitted among the two SRSs 1702 and 1712:

Additional Overlapping Rule 1) The UE may determine SRS carrier switching to be performed based on the reception completion time of the DCI scheduling the SRS carrier switching. In case that a plurality of SRS transmissions (meaning SRS carrier switchings) scheduled for different carriers (or different bands or serving cells) overlap in the same symbol, the UE may perform the SRS carrier switching scheduled by the DCI in the PDCCH that is earlier than the last symbol of the PDCCH reception that detects the DCI scheduling the SRS carrier switching among the plurality of SRS transmissions (meaning SRS carrier switchings). In addition, other overlapping SRS carrier switchings may be dropped. In this case, the UE may determine that the SRS transmissions are overlapped even if the RF tuning time overlaps based on the SRS transmission time that includes all time for RF tuning before and after performing the SRS carrier switching. In FIG. 17, if SRS1 1702 and SRS2 1712 are scheduled to overlap, the UE may transmit SRS2 1712 scheduled by the second DCI format 1_1 1711 with an earlier reception completion time according to the additional overlapping rule 1 and drop SRS1 1702 scheduled by the first DCI format 1_1 1701 with a later reception completion time.

If SRS carrier switchings do not overlap in the time domain, the UE may perform non-overlapping SRS carrier switchings. In this case, the UE may determine that the SRS transmissions are not overlapped if the RF tuning time also does not overlap, considering the SRS transmission time that includes all time for RF tuning before and after performing SRS carrier switching. For example, assuming that three SRS carrier switchings overlap each other, SRS1 may overlap with SRS2, SRS2 may overlap with SRS3, and SRS3 may not overlap with SRS1. In this case, if SRS1 is transmitted and SRS2 is dropped according to the additional overlapping rule 1, the UE may transmit SRS1 and also transmit SRS3.

In case that the plurality of SRS transmissions (meaning SRS carrier switchings) scheduled for different carriers (or different bands or serving cells) overlap in the same symbol by applying another additional overlapping rule 1, the UE may perform the SRS carrier switching scheduled by the DCI in the PDCCH later based on the last symbol of the PDCCH reception that detects the DCI scheduling the SRS carrier switching among the plurality of SRS transmissions (meaning SRS carrier switchings). In addition, other overlapping SRS carrier switchings may be dropped. In this case, the UE may determine that the SRS transmissions are overlapped even if the RF tuning time overlaps based on the SRS transmission time including all time for RF tuning before and after performing the SRS carrier switching. In FIG. 17, if SRS1 1702 and SRS2 1712 are scheduled to overlap, the UE may transmit SRS1 1702 scheduled by the first DCI format 1_1 1701 having a later reception completion time according to additional overlapping rule 1 and drop SRS2 1712 scheduled by the second DCI format 1_1 1711 having an earlier reception completion time. Similarly, if SRS carrier switchings do not overlap in the time domain, the UE may transmit non-overlapping SRS carrier switchings. In this case, the UE may determine that the SRS transmissions are not overlapped if the RF tuning time also does not overlap based on the SRS transmission time including all time for RF tuning before and after performing SRS carrier switching.

Additional Overlapping Rule 2) The UE may determine SRS carrier switching to be transmitted based on the reception start time of the DCI scheduling the SRS carrier switching. In case that a plurality of SRS transmissions (meaning SRS carrier switchings) scheduled for different carriers (or different bands or serving cells) overlap in the same symbol, the UE may perform the SRS carrier switching scheduled by the DCI in the PDCCH that is earlier based on the first symbol of PDCCH reception that detects the DCI scheduling SRS carrier switching among the plurality of SRS transmissions (meaning SRS carrier switching). In addition, other overlapping SRS carrier switchings may be dropped. In this case, the UE may determine that the SRS transmissions are overlapped even if the RF tuning time overlaps based on the SRS transmission time that includes all time for RF tuning before and after performing the SRS carrier switching. In FIG. 17, if SRS1 1702 and SRS2 1712 are scheduled to overlap, the UE may transmit SRS2 1712 scheduled by the second DCI format 1_1 1711 with an earlier reception start time according to the additional overlapping rule 2 and drop SRS1 1702 scheduled by the first DCI format 1_1 1701 with a later reception start time.

If SRS carrier switchings do not overlap in the time domain, the UE may perform non-overlapping SRS carrier switchings. In this case, the UE may determine that the SRS transmissions are not overlapped if the RF tuning time also does not overlap, considering the SRS transmission time that includes all time for RF tuning before and after performing SRS carrier switching. For example, assuming that three SRS carrier switchings overlap each other, SRS1 may overlap with SRS2, SRS2 may overlap with SRS3, and SRS3 may not overlap with SRS1. In this case, if SRS1 is transmitted and SRS2 is dropped according to the additional overlapping rule 2, the UE may transmit SRS1 and also transmit SRS3.

In case that the plurality of SRS transmissions (meaning SRS carrier switchings) scheduled for different carriers (or different bands or serving cells) overlap in the same symbol by applying another additional overlapping rule 2, the UE may perform the SRS carrier switching scheduled by the DCI in the PDCCH later based on the first symbol of the PDCCH reception that detects the DCI scheduling the SRS carrier switching among the plurality of SRS transmissions (meaning SRS carrier switchings). In addition, other overlapping SRS carrier switchings may be dropped. In this case, the UE may determine that the SRS transmissions are overlapped even if the RF tuning time overlaps based on the SRS transmission time including all time for RF tuning before and after performing the SRS carrier switching. In FIG. 17, if SRS1 1702 and SRS2 1712 are scheduled to overlap, the UE may transmit SRS1 1702 scheduled by the first DCI format 1_1 1701 having a later reception start time according to additional overlapping rule 2 and drop SRS2 1712 scheduled by the second DCI format 1_1 1711 having an earlier reception start time. Similarly, if SRS carrier switchings do not overlap in the time domain, the UE may perform non-overlapping SRS carrier switchings. In this case, the UE may determine that the SRS transmissions are not overlapped if the RF tuning time also does not overlap based on the SRS transmission time including all time for RF tuning before and after performing SRS carrier switching.

Additional Overlapping Rule 3) The UE may perform the SRS carrier switching that starts SRS transmission first among the scheduled SRS carrier switchings, and drop other SRS carrier switchings. When a plurality of SRS transmissions (meaning SRS carrier switchings) scheduled for different carriers (or different bands or serving cells) overlap in the same symbol, the UE performs SRS carrier switching, which starts the SRS transmission earliest among the plurality of SRS transmissions (meaning SRS carrier switchings). In addition, other overlapping SRS carrier switchings may be dropped. The UE may determine that the SRS transmissions are overlapped even if the RF tuning time overlaps based on the SRS transmission time including all time for RF tuning before and after performing the SRS carrier switching.

Additional Overlapping Rule 4) The UE may perform the SRS carrier switching that starts SRS transmission latest among the scheduled SRS carrier switchings, and drop other SRS carrier switchings. When a plurality of SRS transmissions (meaning SRS carrier switchings) scheduled for different carriers (or different bands or serving cells) overlap in the same symbol, the UE performs SRS carrier switching, which starts the SRS transmission latest among the plurality of SRS transmissions (meaning SRS carrier switchings). In addition, other overlapping SRS carrier switchings may be dropped. The UE may determine that the SRS transmissions are overlapped even if the RF tuning time overlaps based on the SRS transmission time including all time for RF tuning before and after performing the SRS carrier switching.

Additional Overlapping Rule 5) The UE may perform the SRS carrier switching that completes SRS transmission first among the scheduled SRS carrier switchings, and drop other SRS carrier switchings. When a plurality of SRS transmissions (meaning SRS carrier switchings) scheduled for different carriers (or different bands or serving cells) overlap in the same symbol, the UE performs SRS carrier switching in which the SRS transmission is completed first among the plurality of SRS transmissions (meaning SRS carrier switchings). In addition, other overlapping SRS carrier switchings may be dropped. The UE may determine that the SRS transmissions are overlapped even if the RF tuning time overlaps based on the SRS transmission time including all time for RF tuning before and after performing the SRS carrier switching.

Additional Overlapping Rule 6) The UE may perform the SRS carrier switching that completes SRS transmission latest among the scheduled SRS carrier switchings, and drop other SRS carrier switchings. When a plurality of SRS transmissions (meaning SRS carrier switchings) scheduled for different carriers (or different bands or serving cells) overlap in the same symbol, the UE performs SRS carrier switching in which the SRS transmission is completed latest among the plurality of SRS transmissions (meaning SRS carrier switchings). In addition, other overlapping SRS carrier switchings may be dropped. The UE may determine that the SRS transmissions are overlapped even if the RF tuning time overlaps based on the SRS transmission time including all time for RF tuning before and after performing the SRS carrier switching.

Additional Overlapping Rule 7) The UE may determine the SRS carrier switching to be transmitted based on the serving cell index of the serving cell where the SRS carrier switching is scheduled, the carrier index of the carrier, and the like. When a plurality of SRS transmissions (meaning SRS carrier switchings) scheduled for different carriers (or different bands or serving cells) overlap in the same symbol, the UE may perform the SRS carrier switching scheduled for the serving cell with the smallest index value (or the carrier with the smallest carrier index) among the plurality of SRS transmissions (meaning SRS carrier switchings). In addition, other overlapping SRS carrier switchings may be dropped. The UE may determine that the SRS transmissions are overlapped even if the RF tuning time overlaps based on the SRS transmission time including all time for RF tuning before and after performing the SRS carrier switching.

Additional Overlapping Rule 8) The UE may not expect to perform a plurality of SRS carrier switchings in the same serving cell or on the same carrier. In this case, the base station must schedule, for the UE, SRS carrier switching so that the plurality of SRS carrier switching (including all time for RF tuning before and after performing SRS carrier switching) that overlap in time in one serving cell or on one carrier do not overlap.

When determining the SRS carrier switching to be performed by the UE according to the above additional overlapping rules, if the SRS carrier switching to be performed cannot be determined by one additional overlapping rule, the UE may determine the SRS carrier switching to be performed by additionally considering other additional overlapping rule(s).

In order to describe the above additional overlapping rules, a case where the UE selects and performs only one SRS carrier switching has been described, but depending on UE capability, more than one SRS carrier switching may be selected and performed simultaneously. In this case, one or a plurality of the additional overlapping rules may be applied to determine the n SRS carrier switchings that the UE may be able to perform.

If the plurality of SRS carrier switchings scheduled with carriers supporting only downlink and other uplink channels (e.g., SRS carrier switching not for PUCCH/PUSCH/SRS carrier switching purpose) scheduled with carriers supporting both uplink and downlink where RF chains are operated (in this case, the carrier supporting both uplink and downlink means the carrier affected by uplink channel transmission due to the SRS carrier switching) overlap, the UE may determine the uplink channel to be transmitted by the UE according to a priority between SRS carrier switching and other uplink channels as described in the [SRS: Carrier switching] section above. Thereafter, the UE finally determines the SRS carrier switching to be performed among the plurality of SRS carrier switching according to the above additional overlapping rule.

Additional UE capability of the UE may be required to support the additional overlapping rule described in the second embodiment. For example, if the UE supports the additional overlapping rule described in the second embodiment of the disclosure, the UE may report the UE capability for the corresponding capability to the base station. Thereafter, the base station may schedule a plurality of overlapping SRS carrier switching according to the reported UE capability, and the UE may determine the SRS carrier switching to be performed according to the additional overlapping rule described above. In addition, if the base station has received, from the UE, a report for additional UE capability to support the additional overlapping rule, the base station may configure a new RRC parameter for supporting the additional overlapping rule to the UE. If a new RRC parameter is defined, the base station may configure a new RRC parameter for the UE that may support the additional overlapping rule, and schedule the plurality of SRS carrier switchings overlapping in time for the UE for which the RRC parameter is configured. If the UE does not report the UE capability to the base station that can support additional overlapping rules except for additional overlapping rule 8, the base station cannot schedule the plurality of SRS carrier switching overlapping in time for the UE. If a new RRC parameter to support an additional overlapping rule is defined, the base station does not configure the corresponding RRC parameter for the UE that cannot support additional overlapping rules except for additional overlapping rule 8.

### Third Embodiment: A Method for Supporting SRS Carrier Switching Based on Scheduling Constraints of a Base Station

A third embodiment describes a method for supporting SRS carrier switching by restricting specific scheduling by a base station so that a plurality of SRS carrier switchings are not scheduled in the same time resource.

A base station may schedule SRS carrier switching for a UE so that the UE does not perform a plurality of SRS carrier switchings in the same time resource (considering the time for RF tuning before and after SRS carrier switching). As an example of FIG. 17, if the base station has transmitted, to the UE, DCI 1711 for scheduling SRS carrier switching on one carrier (e.g., c1_2), the base station does not transmit, to the UE, DCI 1701 for scheduling switching on another SRS carrier (e.g., c1_1). FIG. 17 describes an example of aperiodic SRS carrier switching triggered based on DCI format 1_1. However, not only for aperiodic SRS carrier switching triggered based on DCI format 2_3, but also for semi-statically activated semi-persistent SRS carrier switching or RRC parameter-based statically configured periodic SRS carrier switching, the base station may restrict scheduling so that the plurality of SRS carrier switchings do not overlap in the same time resource.

The operations specifically described in the first to third embodiments are described based on aperiodic SRS carrier switching triggered (scheduled) through DCI. However, even a case where aperiodic SRS carrier switching triggered through DCI, as well as semi-persistent SRS carrier switching and periodic SRS carrier switching overlap in the same time resource, the UE may perform the plurality of SRS carrier switchings simultaneously according to the first embodiment or determine the SRS carrier switching to be performed according to the second embodiment. Alternatively, the base station may schedule the aperiodic SRS carrier switching and/or semi-persistent SRS carrier switching and/or periodic SRS carrier switching without overlapping in the time domain according to the third embodiment of the disclosure, based on all configurations and DCIs.

### Fourth Embodiment: Method for Supporting Available Slot-Based SRS Triggering in a CA Environment

A fourth embodiment describes a method for a UE to determine an available slot when triggering an aperiodic SRS based on an available slot and transmitting an SRS in case that the UE supports intra-band CA or inter-band CA.

When a UE transmits an aperiodic SRS triggered based on DCI, the UE may determine an SRS transmission timing based on a configured higher layer parameter (e.g., slotOffset configured in SRS-ResourceSet) and a DCI field indicating one of the candidates of available slots configured as the higher layer parameter (e.g., a DCI field SRS offset indicator for indicating one of up to four AvailableSlotOffsets configured in availableSlotOffsetList configured in SRS-ResourceSet). In order to support this, the UE may report to the base station UE capability (e.g., srs-TriggeringOffset) that the UE may support a method for determining flexible slot offset based on available slot. The base station may configure higher layer parameters to determine available slot-based triggering offset based on the UE capability reported by the UE.

In this way, based on the UE capability report and higher layer configuration, the base station may support a method for determining available slot-based triggering offset for the UE. At the same time, if the UE may support CA, intra-band CA or inter-band CA may be supported simultaneously. When an aperiodic SRS is triggered for the UE in a situation where CA is supported, the UE may determine whether an aperiodic SRS is a transmittable available slot by considering one or a combination of the following methods.

Method 1) For a CC where an aperiodic SRS is triggered, it may determine whether it is an available slot by determining whether all SRS resources in a SRS resource set are transmittable.

Method 2) For CCs supporting all UL CAs including the CC where an aperiodic SRS is triggered, it may determine whether it is available slot by determining whether all SRS resources in a SRS resource set are transmittable.

Method 3) For CCs supporting all UL CAs and DL CAs including the CC where an aperiodic SRS is triggered, it may determine whether it is an available slot by determining whether all SRS resources in a SRS resource set are transmittable.

Method 4) For CCs supporting all UL CAs including the CC where an aperiodic SRS is triggered and DL CA to which SRS carrier switching is configured, it may determine whether it is an available slot by determining whether all SRS resources in a SRS resource set are transmittable.

According to one or a combination of the above methods, the UE may determine an available slot for transmitting the triggered aperiodic SRS. If the triggered aperiodic SRS based on the available slot is an SRS for SRS carrier switching purpose that is transmitted on a carrier that supports only downlink channels, the UE may determine whether to transmit the SRS carrier switching or transmit another uplink channel scheduled on another carrier (e.g., PUSCH or PUCCH or SRS other than SRS carrier switching purposes) according to the following methods.

Decision Method 1) After the UE has determined a slot to be transmitted according to the available slot for SRS carrier switching, the UE determines whether to drop according to another uplink channel that overlaps another carrier. In this case, an overlapping rule for determining whether to drop may be considered the method described in Section [SRS: Carrier switching] or the method described in the second embodiment. For example, after determining whether it is an available slot only for a CC on which SRS carrier switching is scheduled according to the aforementioned Method 1, in case that there is overlap with another uplink channel scheduled for another CA carrier in the time domain (considering whether there is overlap, including the RF tuning time for performing SRS carrier switching), an overlapping rule may be applied to determine whether to drop.

Decision Method 2) The UE may determine an available slot by considering not only the CC on which SRS carrier switching is scheduled but also all uplink channels scheduled for other CA CCs. For example, if not only the CC scheduled for SRS carrier switching according to Method 4 described above, but also other CCs are considered, SRS carrier switching may be transmitted with an available slot after determining whether it is an available slot by considering the presence or absence of other uplink channels scheduled for other CCs as well. In this case, in order to determine an available slot by considering other uplink channels scheduled for other CCs, an overlapping rule may be applied to determine whether to drop. Similarly, it may determine whether it is an available slot by considering other Method 2 or Method 3 and apply an overlapping rule.

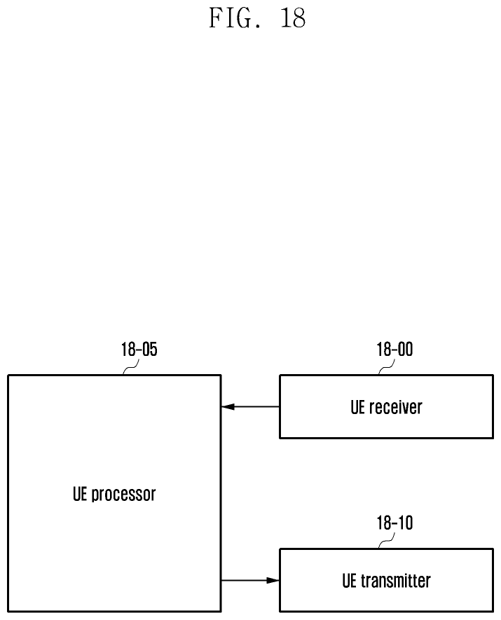

FIG. 18 is a diagram illustrating a structure of a UE in a wireless communication system according to an embodiment of the disclosure.

Referring to FIG. 18, the UE may include a transceiver, which refers to a UE receiver 18-00 and a UE transmitter 18-10 as a whole, memory (not illustrated), and a UE processor 18-05 (or UE controller or processor). According to the above-described communication methods of the UE, the UE receiver 18-00 and the UE transmitter 18-10, memory, and the UE processor 18-05 may operate. However, components of the UE are not limited to the above-described example. For example, the UE may include a larger or smaller number of components than the above-described components. Furthermore, the transceiver, memory, and processor may be implemented as a single chip.

The transceiver may transmit/receive signals with the base station. Here, the signals may include control information and data. To this end, the transceiver may be constituted with an RF transmitter to up-convert and amplify the frequency of transmitted signals, an RF receiver to low-noise-amplify received signals and down-convert the frequency thereof, and the like. However, this is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for the UE's operations. In addition, the memory may store control information or data included in signals transmitted/received by the UE. The memory may include storage media, such as read only memory (ROM), random access memory (RAM), a hard disk, compact disc read only memory (CD-ROM), and a digital versatile disc (DVD), or a combination of storage media. In addition, the UE may include a plurality of memories.

In addition, the processor may control a series of processes such that the UE can operate according to the above-described embodiments. For example, the processor may control components of the UE so as to receive DCI constituted in two layers such that multiple PDSCHs are received simultaneously. The UE may include a plurality of processors, and the processors may perform the UE's component control operations by executing programs stored in the memory.

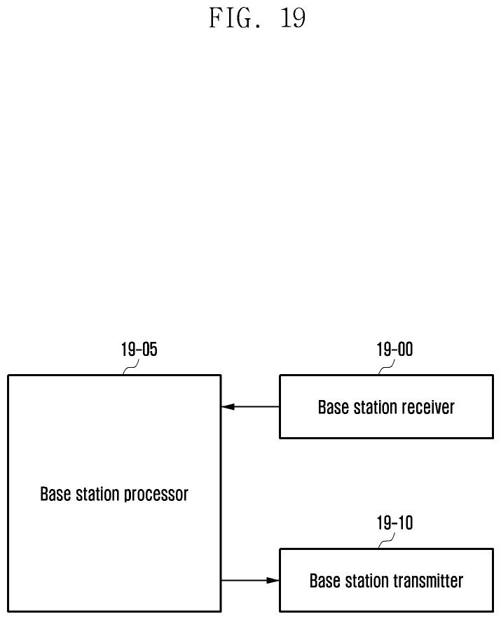

FIG. 19 illustrates a structure of a base station in a wireless communication system according to an embodiment of the disclosure.

Referring to FIG. 19, the base station may include a transceiver, which refers to a base station receiver 19-00 and a base station transmitter 19-10 as a whole, memory (not illustrated), and a base station processor 19-05 (or base station controller or processor). According to the above-described communication methods of the base station, the base station receiver 19-00 and the base station transmitter 19-10, memory, and the base station processor 19-05 may operate. However, components of the base station are not limited to the above-described example. For example, the base station may include a larger or smaller number of components than the above-described components. Furthermore, the transceiver, memory, and processor may be implemented as a single chip.

The transceiver may transmit/receive signals with the UE. Here, the signals may include control information and data. To this end, the transceiver may be constituted with an RF transmitter to up-convert and amplify the frequency of transmitted signals, an RF receiver to low-noise-amplify received signals and down-convert the frequency thereof, and the like. However, this is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for the base station's operations. In addition, the memory may store control information or data included in signals transmitted/received by the base station. The memory may include storage media, such as ROM, RAM, hard disk, CD-ROM, and DVD, or a combination of storage media. In addition, the base station may include a plurality of memories.

The processor may control a series of processes such that the base station can operate according to the above-described embodiments of the disclosure. For example, the processor may control components of the base station so as to constitute DCI of two layers including allocation information regarding multiple PDSCHs and to transmit the same. The base station may include a plurality of processors, and the processors may perform the base station's component control operations by executing programs stored in the memory.

The methods according to embodiments described in the claims or the specification of the disclosure may be implemented by hardware, software, or a combination of hardware and software.

In case that the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to embodiments of the disclosure as defined by the appended claims and/or disclosed herein.

The programs (software modules or software) may be stored in non-volatile memories including random access memory and flash memory, read only memory (ROM), electrically erasable programmable read only memory (EEPROM), magnetic disc storage device, compact disc-ROM (CD-ROM), digital versatile discs (DVDs), or other type optical storage devices, or a magnetic cassette. Alternatively, any combination of some or all of them may form memory in which the program is stored. Further, a plurality of such memories may be included in the electronic device.

In addition, the programs may be stored in an attachable storage device which may access the electronic device through communication networks, such as the Internet, Intranet, local area network (LAN), wide LAN (WLAN), and storage area network (SAN) or a combination thereof. Such a storage device may access the electronic device that performs the embodiments of the disclosure through an external port. Further, a separate storage device on the communication network may access a device performing the embodiment of the disclosure.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Meanwhile, the embodiments of the disclosure described and shown in the specification and the drawings are merely specific examples that have been presented to easily explain the technical contents of the disclosure and help understanding of the disclosure, and are not intended to limit the scope of the disclosure. For example, it will be apparent to those skilled in the art that other variants based on the technical idea of the disclosure may be implemented. Furthermore, the above respective embodiments may be employed in combination, as necessary. For example, a part of one embodiment of the disclosure may be combined with a part of another embodiment to operate a base station and a UE. As an example, a part of embodiment 1 of the disclosure may be combined with a part of embodiment 2 to operate a base station and a UE. Moreover, although the above embodiments have been described based on the FDD LTE system, other variants based on the technical idea of the embodiments may also be implemented in other systems, such as TDD LTE, 5G, or NR systems.

Meanwhile, in the drawings in which methods of the disclosure are described, the order of the description does not always correspond to the order in which steps of each method are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

Furthermore, in methods of the disclosure, some or all of the contents of each embodiment may be implemented in combination without departing from the essential spirit and scope of the disclosure.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a communication system, the method comprising:
transmitting, to a base station, capability information associated with simultaneous sounding reference signal (SRS) carrier switching;
receiving, from the base station, downlink control information (DCI) formats, wherein the DCI formats schedule SRSs for SRS carrier switching in component carrier (CCs), wherein the SRSs are overlap in time based on the capability information indicating a support of the simultaneous SRS carrier switching; and
transmitting, to the base station, at least one SRS among the scheduled SRSs for SRS carrier switching.

2. The method of claim 1,
wherein, based on the capability information including first information indicating a support of simultaneous SRS carrier switching for intra-band carrier aggregation (CA) and the CCs being based on the intra-band CA, the scheduled SRSs for SRS carrier switching are transmitted simultaneously in the CCs based on the intra-band CA, and
wherein the first information indicates at least one of:
radio frequency (RF) tuning time required for SRS carrier switching, or
whether the simultaneous SRS carrier switching for intra-band CA is supported for partially overlapping SRSs or fully overlapping SRSs.

3. The method of claim 1,
wherein, based on the capability information including second information indicating a support of simultaneous SRS carrier switching for inter-band carrier aggregation (CA) and the CCs being based on the inter-band CA, the scheduled SRSs for SRS carrier switching are transmitted simultaneously in the CCs based on the inter-band CA, and
wherein the second information indicates at least one of:
frequency bands affected by SRS carrier switching,
radio frequency (RF) tuning time required for SRS carrier switching, or
whether the simultaneous SRS carrier switching for inter-band CA is supported for partially overlapping SRSs or fully overlapping SRSs.

4. The method of claim 1, further comprising receiving, from the base station, a radio resource control (RRC) parameter enabling the simultaneous SRS carrier switching.

5. The method of claim 1, wherein the SRSs for SRS carrier switching do not overlap in time, based on the capability information not indicating a support of the simultaneous SRS carrier switching.

6. A method performed by a base station in a communication system, the method comprising:
receiving, from a user equipment (UE), capability information associated with simultaneous sounding reference signal (SRS) carrier switching;
transmitting, to the UE, downlink control information (DCI) formats, wherein the DCI formats schedule SRSs for SRS carrier switching in component carrier (CCs), wherein the SRSs are overlap in time based on the capability information indicating a support of the simultaneous SRS carrier switching; and
receiving, from the UE, at least one SRS among the scheduled SRSs for SRS carrier switching.

7. The method of claim 6,
wherein, based on the capability information including first information indicating a support of simultaneous SRS carrier switching for intra-band carrier aggregation (CA) and the CCs being based on the intra-band CA, the scheduled SRSs for SRS carrier switching are received simultaneously in the CCs based on the intra-band CA, and
wherein the first information indicates at least one of:
radio frequency (RF) tuning time required for SRS carrier switching, or
whether the simultaneous SRS carrier switching for intra-band CA is supported for partially overlapping SRSs or fully overlapping SRSs.

8. The method of claim 6,
wherein, based on the capability information including second information indicating a support of simultaneous SRS carrier switching for inter-band carrier aggregation (CA) and the CCs being based on the inter-band CA, the scheduled SRSs for SRS carrier switching are received simultaneously in the CCs based on the inter-band CA, and
wherein the second information indicates at least one of:
frequency bands affected by SRS carrier switching,
radio frequency (RF) tuning time required for SRS carrier switching, or
whether the simultaneous SRS carrier switching for inter-band CA is supported for partially overlapping SRSs or fully overlapping SRSs.

9. The method of claim 6, further comprising transmitting, to the UE, a radio resource control (RRC) parameter enabling the simultaneous SRS carrier switching

10. The method of claim 6, wherein the SRSs for SRS carrier switching do not overlap in time, based on the capability information not indicating a support of the simultaneous SRS carrier switching.

11. A user equipment (UE) in a communication system, the UE comprising:
a transceiver; and
at least one processor configured to:
transmit, to a base station, capability information associated with simultaneous sounding reference signal (SRS) carrier switching,
receive, from the base station, downlink control information (DCI) formats, wherein the DCI formats schedule SRSs for SRS carrier switching in component carrier (CCs), wherein the SRSs are overlap in time based on the capability information indicating a support of the simultaneous SRS carrier switching, and
transmit, to the base station, at least one SRS among the scheduled SRSs for SRS carrier switching.

12. The UE of claim 11,
wherein, based on the capability information including first information indicating a support of simultaneous SRS carrier switching for intra-band carrier aggregation (CA) and the CCs being based on the intra-band CA, the scheduled SRSs for SRS carrier switching are transmitted simultaneously in the CCs based on the intra-band CA, and
wherein the first information indicates at least one of:
radio frequency (RF) tuning time required for SRS carrier switching, or
whether the simultaneous SRS carrier switching for intra-band CA is supported for partially overlapping SRSs or fully overlapping SRSs.

13. The UE of claim 11,
wherein, based on the capability information including second information indicating a support of simultaneous SRS carrier switching for inter-band carrier aggregation (CA) and the CCs being based on the inter-band CA, the scheduled SRSs for SRS carrier switching are transmitted simultaneously in the CCs based on the inter-band CA, and
wherein the second information indicates at least one of:
frequency bands affected by SRS carrier switching,
radio frequency (RF) tuning time required for SRS carrier switching, or
whether the simultaneous SRS carrier switching for inter-band CA is supported for partially overlapping SRSs or fully overlapping SRSs.

14. The UE of claim 11, wherein the at least one processor is further configured to receive, from the base station, a radio resource control (RRC) parameter enabling the simultaneous SRS carrier switching.

15. The UE of claim 11, wherein the SRSs for SRS carrier switching do not overlap in time, based on the capability information not indicating a support of the simultaneous SRS carrier switching.

16. A base station in a communication system, the base station comprising:
a transceiver; and
at least one processor configured to:
receive, from a user equipment (UE), capability information associated with simultaneous sounding reference signal (SRS) carrier switching,
transmit, to the UE, downlink control information (DCI) formats, wherein the DCI formats schedule SRSs for SRS carrier switching in component carrier (CCs), wherein the SRSs are overlap in time based on the capability information indicating a support of the simultaneous SRS carrier switching, and
receive, from the UE, at least one SRS among the scheduled SRSs for SRS carrier switching.

17. The base station of claim 16,
wherein, based on the capability information including first information indicating a support of simultaneous SRS carrier switching for intra-band carrier aggregation (CA) and the CCs being based on the intra-band CA, the scheduled SRSs for SRS carrier switching are received simultaneously in the CCs based on the intra-band CA, and
wherein the first information indicates at least one of:
radio frequency (RF) tuning time required for SRS carrier switching, or
whether the simultaneous SRS carrier switching for intra-band CA is supported for partially overlapping SRSs or fully overlapping SRSs.

18. The base station of claim 16,
wherein, based on the capability information including second information indicating a support of simultaneous SRS carrier switching for inter-band carrier aggregation (CA) and the CCs being based on the inter-band CA, the scheduled SRSs for SRS carrier switching are received simultaneously in the CCs based on the inter-band CA, and
wherein the second information indicates at least one of:
frequency bands affected by SRS carrier switching,
radio frequency (RF) tuning time required for SRS carrier switching, or
whether the simultaneous SRS carrier switching for inter-band CA is supported for partially overlapping SRSs or fully overlapping SRSs.

19. The base station of claim 16, wherein the at least one processor is further configured to transmit, to the UE, a radio resource control (RRC) parameter enabling the simultaneous SRS carrier switching.

20. The base station of claim 16, wherein the SRSs for SRS carrier switching do not overlap in time, based on the capability information not indicating a support of the simultaneous SRS carrier switching.
